(19) United States
(12) Patent Application Publication
(10) Pub. No.: US 2006/0254619 A1
(43) Pub. Date: Nov. 16, 2006

(54) Commerical kitchenware washers and related methods

(76) Inventor: James W. Bigott, Fenton, MO (US)

Correspondence Address: Anthony G. Fussner, Suite 400, 7700 Bonhomme, St. Louis, MO, 63105, US

(21) Appl. No.: 11/492,136

(22) Filed: Jul. 24, 2006

Related U.S. Application Data
(63) Continuation-in-part of application No. 11/113,403, filed on Apr. 22, 2005.
(63) Continuation-in-part of application No. 11/113,405, filed on Apr. 22, 2005.
(63) Continuation-in-part of application No. 11/113,406, filed on Apr. 22, 2005.
(60) Provisional application No. 60/702,154, filed on Jul. 25, 2005.
(60) Provisional application No. 60/718,910, filed on Sep. 20, 2005.

(51) Int. Cl. B08B 7/04; B08B 3/00; B08B 9/20; B08B 3/12

(52) U.S. Cl. 134/18; 134/184; 134/56 D; 134/186; 134/10; 134/25.2

(57) ABSTRACT

An exemplary kitchenware washing assembly generally includes a tank for holding fluid for washing kitchenware. The assembly also includes at least one pump for agitating the fluid in the tank. The at least one pump is configured with at least one drain to allow at least some fluid to drain from the at least one pump.

### CROSS-REFERENCE TO RELATED APPLICATIONS

This application is a continuation-in-part of U.S. patent application Ser. Nos. 11/113,403, 11/113,405, and 11/113,406 filed Apr. 22, 2005. This application claims the benefit of U.S. Provisional Application No. 60/702,154 filed Jul. 25, 2005. This application claims the benefit of U.S. Provisional Application No. No. 60/718,910 filed Sep. 20, 2005. The disclosures of the above applications are incorporated herein by reference.

### FIELD

The present invention relates to commercial kitchenware washers for washing large quantities of commercial kitchenware.

### BACKGROUND

The statements in this section merely provide background information related to the present disclosure and may not constitute prior art.

Commercial washers have been in the marketplace for decades. Many of the commercial washers that are currently on the market include multiple tanks for various cleaning stages (e.g., a scraping tank, washing tank, rinsing tank, and sanitizing tank). The washing tank, at a basic level, typically includes features such as a rectangular tank with a drain, a valve for closing the tank's drain, nozzles attached to walls of the tank for directing water down into the tank, and a pump to circulate water from within the tank into a manifold that feeds the water through the nozzles.

### SUMMARY

According to various aspects of the present disclosure, exemplary embodiments include kitchenware washing assemblies. Other aspects relate to components of kitchenware washing assemblies. Further aspects include methods relating to assembling and using kitchenware washing assemblies.

In one exemplary embodiment, a kitchenware washing assembly generally includes a tank for holding fluid for washing kitchenware. The assembly also includes at least one pump for agitating the fluid in the tank. The at least one pump is configured with at least one drain at about a low point of the at least one pump to allow drainage of the fluid from the at least one pump.

In another exemplary embodiment, a kitchenware washing assembly generally includes a tank for holding fluid for washing kitchenware. The assembly also includes at least one pump for agitating the fluid in the tank. The at least one pump is configured with at least one drain to allow at least some fluid to drain from the at least one pump.

In another exemplary embodiment, a kitchenware washing assembly generally includes a tank for holding fluid for washing kitchenware. The assembly also includes at least one pump for agitating the fluid in the tank. The at least one pump and the tank are connected by at least one fluid passage. The at least one fluid passage is configured with at least one drain at about a low point of the at least one fluid passage to allow drainage of the fluid from the at least one pump and the at least one fluid passage.

Other aspects relate to methods of draining fluid from at least one pump of a kitchenware washing assembly. In one exemplary embodiment, a method generally includes opening at least one drain at about a low point of the at least one pump such that the fluid drains from the at least one pump through the open drain.

In another exemplary method, the kitchenware washing assembly includes at least one fluid passage connecting the at least one pump and the tank. In this embodiment, the method generally includes opening at least one drain at about a low point of the at least one fluid passage such that the fluid drains from the at least one pump and the at least one fluid passage through the open drain.

Other aspects relate to methods of assembling kitchenware washing assemblies, where the kitchenware washing assembly includes a tank for holding fluid for washing kitchenware, at least one outlet for dispensing fluid into the tank, at least one inlet for receiving fluid from the tank, and at least one pump for pumping fluid from the at least one inlet to the at least one outlet. In one exemplary embodiment, a method generally includes positioning the at least one pump such that at least one drain thereof is at about a low point of the at least one pump, to thereby allow drainage of fluid for washing kitchenware from the at least one pump.

Further aspects and features of the present invention will become apparent from the detailed description provided hereinafter. In addition, any one or more aspects of the invention may be implemented individually or in any combination with any one or more of the other aspects of the invention. It should be understood that the detailed description and specific examples, while indicating exemplary embodiments of the invention, are intended for purposes of illustration only and are not intended to limit the scope of the invention.

### DRAWINGS

The drawings described herein are for illustration purposes only and are not intended to limit the scope of the present disclosure in any way.

FIG. 1 is an upper perspective view of a kitchenware washing assembly according to one embodiment of the invention;

FIG. 2 is another upper perspective view of the kitchenware washing assembly shown in FIG. 1;

FIG. 3 is a lower perspective view of the kitchenware washing assembly shown in FIG. 1;

FIG. 4 is a front elevation view of the kitchenware washing assembly shown in FIG. 1;

FIG. 5 is a right side elevation view of the kitchenware washing assembly shown in FIG. 1;

FIG. 6 is a rear elevation view of the kitchenware washing assembly shown in FIG. 1;

FIG. 7 is a left side elevation view of the kitchenware washing assembly shown in FIG. 1;

FIG. 8 is a top plan view of the kitchenware washing assembly shown in FIG. 1;

FIG. 9 is a bottom plan view of the kitchenware washing assembly shown in FIG. 1;

FIG. 10 is a perspective view of the kitchenware washing assembly shown in FIG. 1 with a portion broken away to reveal the crisscross fluid flow in the tank when fluid is circulated through the discharge openings;

FIG. 11 is a cross-sectional view of the kitchenware washing assembly of FIG. 10 showing the crisscross pattern of fluid flow from the discharge openings;

FIG. 12 is a perspective view of the kitchenware washing assembly shown in FIG. 1 with a portion broken away to reveal the fluid flow when only one pump is operating;

FIG. 13 is a cross-sectional view of the kitchenware washing assembly of FIG. 12 showing the fluid flow from the discharge openings when only one pump is operating;

FIGS. 14A through 14E are exploded perspective views of a kitchenware washing assembly according to one embodiment in which portions of the tank are unitarily formed;

FIGS. 15A and 15B are perspective views of the kitchenware washing assembly shown in FIG. 1 and a control system that can be used for controlling one or more operations of the kitchenware washing assembly, and also illustrating the kitchenware washing assembly incorporated into a compete commercial kitchenware washing system according to one embodiment of the invention;

FIG. 16 is a partial exploded perspective view of a kitchenware washing assembly with a front portion of the tank broken away and illustrating an intake cover that can be used for separating an intake chamber from the tank according to one embodiment of the invention;

FIG. 17 is a partial perspective view of the tank and intake cover shown in FIG. 16 after the intake cover has been positioned over the intake chamber;

FIG. 18 is a partial side cross-sectional view of the intake cover shown in FIG. 16 after the intake cover has been positioned over the intake chamber;

FIG. 19 is an outer perspective view of the intake cover shown in FIG. 16;

FIG. 20 is an inner perspective view of the intake cover shown in FIG. 16;

FIG. 21 is a front elevation view of the intake cover shown in FIG. 16;

FIG. 22 is a side elevation view of the intake cover shown in FIG. 16;

FIG. 23 is a rear elevation view of the intake cover shown in FIG. 16;

FIG. 24 is a partial exploded perspective view of a kitchenware washing assembly with a portion of the tank broken away and illustrating an outlet cover that can be removably attached to the tank to cover an outlet chamber according to one embodiment of the invention;

FIG. 25 is a partial perspective view of the tank and outlet cover shown in FIG. 24 after the outlet cover has been removably attached to the tank;

FIG. 26 is an outer perspective view of the outlet cover shown in FIG. 24;

FIG. 27 is an inner perspective view of the outlet cover shown in FIG. 24;

FIG. 28 is a front elevation view of the outlet cover shown in FIG. 24;

FIG. 29 is a side elevation view of the outlet cover shown in FIG. 24;

FIG. 30 is a rear elevation view of the outlet cover shown in FIG. 24;

FIG. 31 is a front elevation view of another embodiment of an outlet cover with a different outlet pattern than the outlet cover shown in FIG. 24;

FIG. 32 is a front elevation view of another embodiment of an outlet cover with a different outlet pattern than the outlet covers shown in FIGS. 24 and 31;

FIG. 33 is a partial cross-sectional side view of an outlet chamber of a kitchenware washing assembly having positive drainage according to one embodiment of the invention;

FIG. 34 is a perspective schematic view of a control system that can be used for controlling one or more operations of a kitchenware washing assembly according to one embodiment of the invention;

FIG. 35 is an exploded perspective schematic view of the control system in FIG. 34;

FIG. 36 is a front elevation view of the control system shown in FIG. 34;

FIG. 37 is a perspective view of a heater that can be used with a kitchenware washing assembly according to one embodiment of the invention;

FIG. 38 is a side elevation view of the heater shown in FIG. 37;

FIG. 39 is a front elevation view of the heater shown in FIG. 37;

FIG. 40 is an exploded perspective view showing the heater of FIG. 37 being positioned within an intake chamber of a kitchenware washing assembly according to one embodiment of the invention;

FIG. 41 is a perspective view of a pump having a drain according to one embodiment of the invention;

FIG. 42 is a partial side cross-sectional view of a kitchenware washing assembly with a portion of the tank broken away and illustrating an intake chamber having a downwardly sloping bottom portion according to one embodiment of the invention;

FIG. 43 is an outer perspective view of an intake cover that includes a plurality of projections extending into the tank according to one embodiment of the invention;

FIG. 44 is a flow diagram showing various operations of a method for monitoring tank water replacement according to one embodiment of the invention;

FIG. 45 is an exploded perspective view showing an exemplary heater and temperature sensor and also illustrating an exemplary manner by which the heater and temperature sensor can be releasably secured to a tank of a kitchenware washing assembly according to one embodiment of the invention;

FIG. 46 is another exploded perspective view of the heater, temperature sensor, and securing device shown in FIG. 45;

FIG. 47 is a side elevation view of the heater, temperature sensor, and securing device shown in FIG. 45;

FIG. 48 is an exploded perspective view showing the heater and temperature sensor of FIG. 45 being positioned within an intake chamber of a kitchenware washing assembly according to one embodiment of the invention;

FIG. 49 is another exploded perspective view showing the heater and temperature sensor of FIG. 45 being positioned within an intake chamber of a kitchenware washing assembly according to one embodiment of the invention;

FIG. 50 is a perspective view showing the heater and temperature sensor releasably secured by the securing device within the intake chamber shown in FIG. 48 and also illustrating an intake cover that can be used for separating the intake chamber from the tank according to one embodiment of the invention;

FIG. 51 is a perspective view of the kitchenware washing assembly shown in FIG. 50 after the intake cover has been positioned over the intake chamber with a portion of the intake cover broken away to reveal the heater and temperature sensor releasably secured by the securing device within the intake chamber; and

FIG. 52 is an exploded perspective view showing an exemplary heater and temperature sensor and an exemplary electrical connection by which the heater and temperature sensor can be electrically connected to a control system according to one embodiment of the invention;

FIG. 53 is an exploded perspective view showing the heater and temperature sensor of FIG. 52 being positioned within an intake chamber of a kitchenware washing assembly according to one embodiment of the invention.

FIG. 54 is an exploded perspective view showing an exemplary heater and temperature sensor and also illustrating an exemplary manner by which the heater and temperature sensor can be releasably secured to a tank of a kitchenware washing assembly according to one embodiment of the invention;

FIG. 55 is another exploded perspective view of the heater, temperature sensor, and securing device shown in FIG. 54;

FIG. 56 is a front elevation view of a commercial kitchenware washing system according to one embodiment of the invention;

FIG. 57 is a perspective view of a commercial kitchenware washing system including first and second kitchenware washing assemblies according to one embodiment of the invention and generally illustrating the first kitchenware washing assembly's tank, the second kitchenware washing assembly's enclosure and closable openings with the sliding doors opened, and a rack positioned within the enclosure;

FIG. 58 is a perspective view of the commercial kitchenware washing system shown in FIG. 57 from the opposite end portion;

FIG. 59 is a partial perspective view of the commercial kitchenware washing system shown in FIGS. 57 and 58 and illustrating the lower rotary sprayer arm of the second kitchenware washing assembly beneath the rack;

FIG. 60 is a perspective view of the lower rotary sprayer arm beneath the rack shown in FIG. 59;

FIG. 61 is a partial perspective view illustrating the upper rotary sprayer arm of the second kitchenware washing assembly shown in FIGS. 57 through 59;

FIG. 62 is a partial perspective view of the second kitchenware washing assembly shown in FIGS. 57 through 59 and illustrating the sliding doors closed;

FIG. 63 is a perspective view of an exemplary pump that can be used for pumping fluid from an inlet or drain of the second kitchenware washing assembly shown in FIGS. 57 through 59 to the upper and/or lower rotary spray arms shown respectively in FIGS. 60 and 61;

FIG. 64 is a partial front elevation view of the second kitchenware washing assembly shown in FIGS. 57 through 59 and illustrating exemplary lights for indicating when the second kitchenware washing assembly is performing a washing cycle or a rinsing cycle, exemplary gauges for indicating temperature of the fluid being sprayed within the enclosure, and an exemplary sliding door positioned to close a front opening of the enclosure;

FIG. 65 is a perspective view of the commercial kitchenware washing system shown in FIG. 57 through 59 and illustrating the second kitchenware washing assembly's front and side sliding doors opened and the rack positioned outside of the enclosure, for example, after completion of a cleaning cycle;

FIG. 66 is a partial back perspective view of the second kitchenware washing assembly shown in FIGS. 57 through 59 and FIG. 65;

FIG. 67 is an upper perspective view of a kitchenware washing assembly according to one embodiment of the invention;

FIG. 68 is a front elevation view of the kitchenware washing assembly shown in FIG. 67;

FIG. 69 is a bottom plan view of the kitchenware washing assembly shown in FIG. 67;

FIG. 70 is an upper perspective view of the pumps, valve system, and actuator shown in FIGS. 67 through 69;

FIG. 71 is a front elevation view of the pumps, valve system, and actuator shown in FIG. 70; and

FIG. 72 is a bottom plan view of the pumps, valve system, and actuator shown in FIG. 70.

### DETAILED DESCRIPTION

The following description is merely exemplary in nature and is not intended to limit the present disclosure, application, or uses.

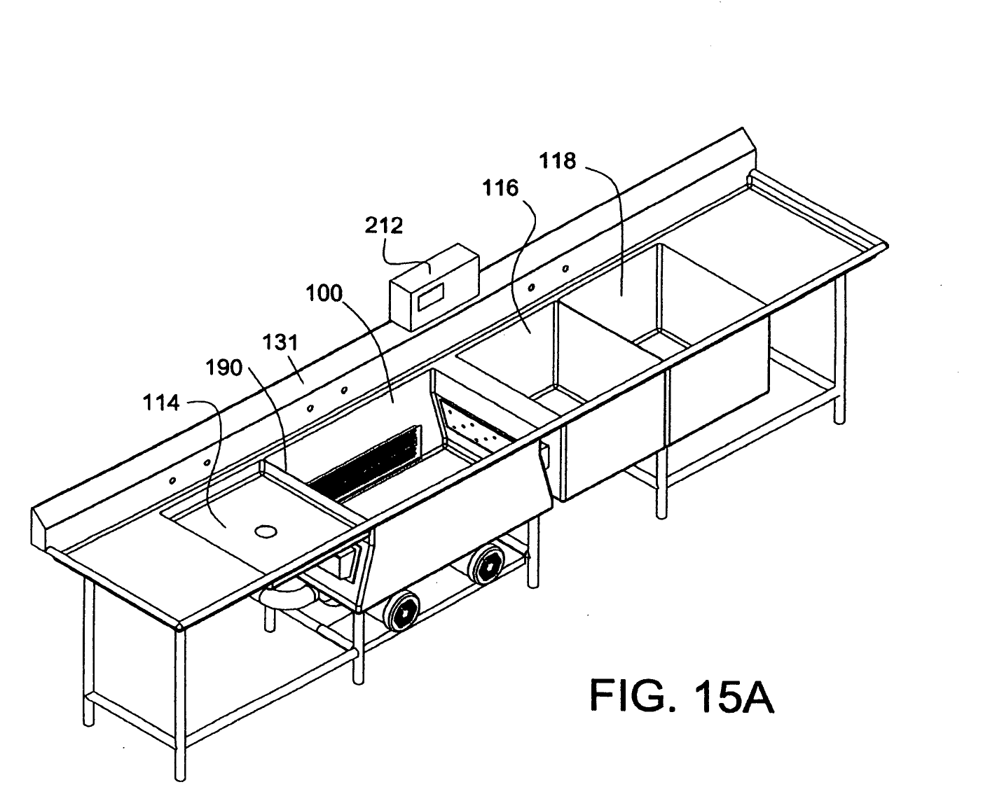

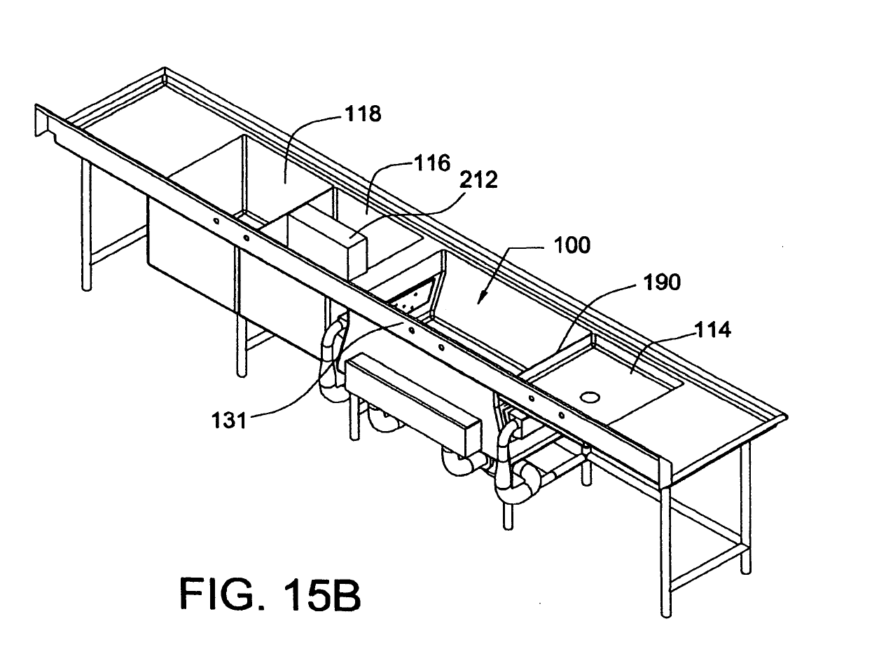

Various aspects of the present disclosure can be adapted to be included in a commercial washer system for commercial or large-scale kitchens, as shown in FIGS. 15A and 15B. Commercial washer systems typically include several contiguous stations such as an initial scraping station to remove bulk food items that have stuck to the dishware, a washing station to wash the remaining food items or food residues from the dishware, a rinsing tank to rinse the soap or cleaning fluids from the dishware, and a sanitizing station to sanitize the cleaned dishware. Various embodiments provide washers that are capable of washing a variety of kitchenware, including dishware, food service ware and equipment, pots, pans, food trays, grease filters, gratings, or any other items found in commercial or large-scale kitchens that require cleaning.

In various exemplary embodiments, a kitchenware washing assembly generally includes a tank for holding fluid for washing kitchenware. The assembly also includes at least one pump for agitating the fluid in the tank. The at least one pump is configured with at least one drain to allow at least some fluid to drain from the at least one pump. In some embodiments, the at least one drain is at about a low point of the at least one pump to thereby allow drainage of the fluid from the at least one pump. In addition, locating the at least one drain at about a low point of the at least one pump can advantageously allow drainage of at least some of the fluid from the at least one pump solely via gravity. In some preferred embodiments, substantially all of the fluid can be drained from the at least one pump solely via gravity.

In addition to the at least one drain, the at least one pump can also include at least one outlet coupled in fluid communication with at least one outlet of the assembly, such as one or more discharge openings, holes, perforations, pipes, etc. for directing fluid into the tank.

In some embodiments, the at least one pump comprises two or more pumps. In such embodiments, at least one valve is coupled to the at least one drain of the two pumps such that the at least one valve is operable for opening and closing the at least one drain of the two pumps.

The tank can also include at least one drain. Some embodiments include an actuator configured for opening and closing both the at least one drain of the tank and the at least one drain of one or more pumps.

In another exemplary embodiment, a kitchenware washing assembly generally includes a tank for holding fluid for washing kitchenware. The assembly also includes at least one pump for agitating the fluid in the tank. The at least one pump and the tank are connected by at least one fluid passage. The at least one fluid passage is configured with at least one drain at about a low point of the at least one fluid passage to allow drainage of the fluid from the at least one pump and the at least one fluid passage.

Other aspects relate to methods of draining fluid from at least one pump of a kitchenware washing assembly. In one exemplary embodiment, a method generally includes opening (e.g., manually, automatically, combinations thereof, etc.) at least one drain at about a low point of the at least one pump such that the fluid drains from the at least one pump through the open drain. The method can also include closing the at least one drain.

The process of opening the at least one drain can include opening at least one valve coupled to the at least one drain. For example, an operator may manually open the at least one valve. Or, for example, the at least one valve may be automatically opened without manual intervention, such as by activating at least one solenoid coupled to the at least one valve.

In some embodiments, the tank includes at least one drain. In such embodiments, the method can include substantially simultaneously opening the tank drain and the at least one drain of the at least one pump. Additionally, the method can include opening the at least one drain of the tank and the at least one drain of the at least one pump with a single actuator. The method may also include closing the at least one drain of the tank and the at least one drain of the at least one pump with a single reverse actuation of the actuator.

Various exemplary methods can also include monitoring washing cycles to detect an indicator that the fluid for washing kitchenware should be replaced; after detecting the indicator that the fluid for washing kitchenware should be replaced, deactivating the at least one pump; and opening the at least one drain.

Various exemplary methods can also include counting a number of washing cycles since a replacement of the fluid for washing kitchenware; comparing the counted number of washing cycles to a preset value; if the counted number of washing cycles is equal to or exceeds the preset value, deactivating the at least one pump; and opening the at least one drain. In some embodiments, the operator is allowed to input the preset value.

Other exemplary methods relate to a kitchenware washing assembly that includes at least one fluid passage connecting the at least one pump and the tank. In one such embodiment, a method generally includes opening at least one drain at about a low point of the at least one fluid passage such that the fluid drains from the at least one pump and the at least one fluid passage through the open drain.

Other aspects relate to methods of assembling kitchenware washing assemblies, where the kitchenware washing assembly includes a tank for holding fluid for washing kitchenware, at least one outlet for dispensing fluid into the tank, at least one inlet for receiving fluid from the tank, and at least one pump for pumping fluid from the at least one inlet to the at least one outlet. In one exemplary embodiment, the method generally includes positioning the at least one pump such that at least one drain thereof is at about a low point of the at least one pump, to thereby allow drainage of fluid for washing kitchenware from the at least one pump.

The method of assembling can also include coupling the at least one drain to at least one valve such that the at least one valve is operable for opening and closing the at least one drain. In some embodiments, the method may include coupling at least one drain of the tank and the at least one drain of the at least one pump to the same actuator for opening and closing the drains.

Accordingly, various embodiments are provided of kitchenware washing assemblies. Other aspects relate to components of kitchenware washing assemblies. Further aspects include methods relating to assembling and using kitchenware washing assemblies. Any one or more aspects disclosed herein can be used individually or in combination with any one or more of the other aspects disclosed herein.

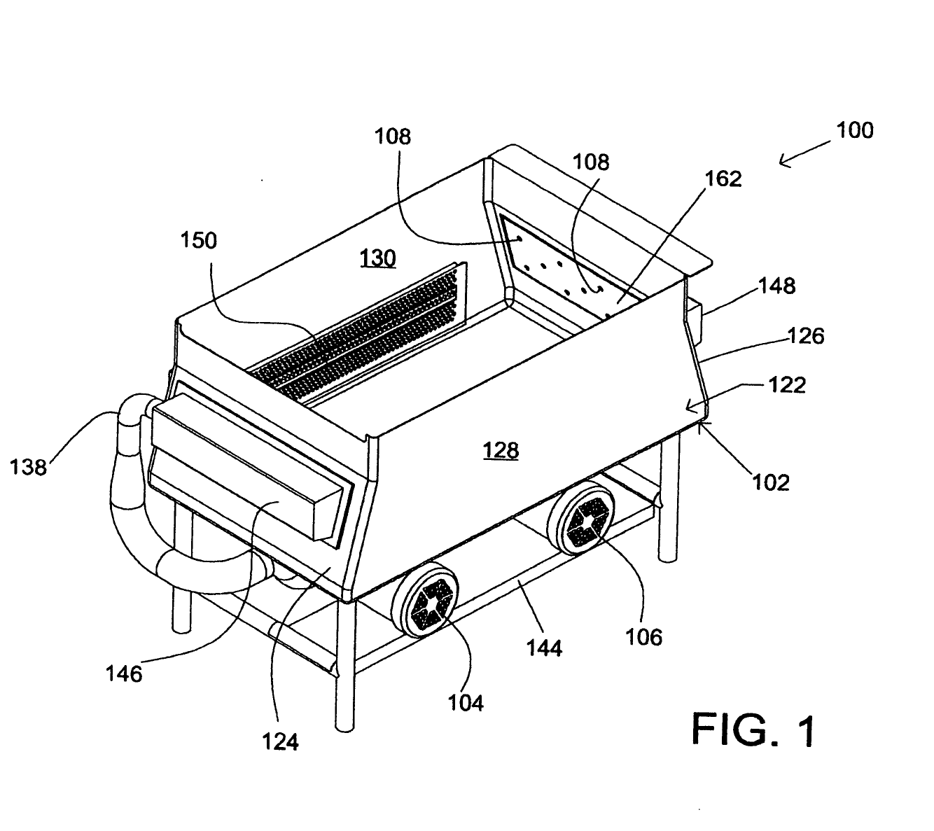

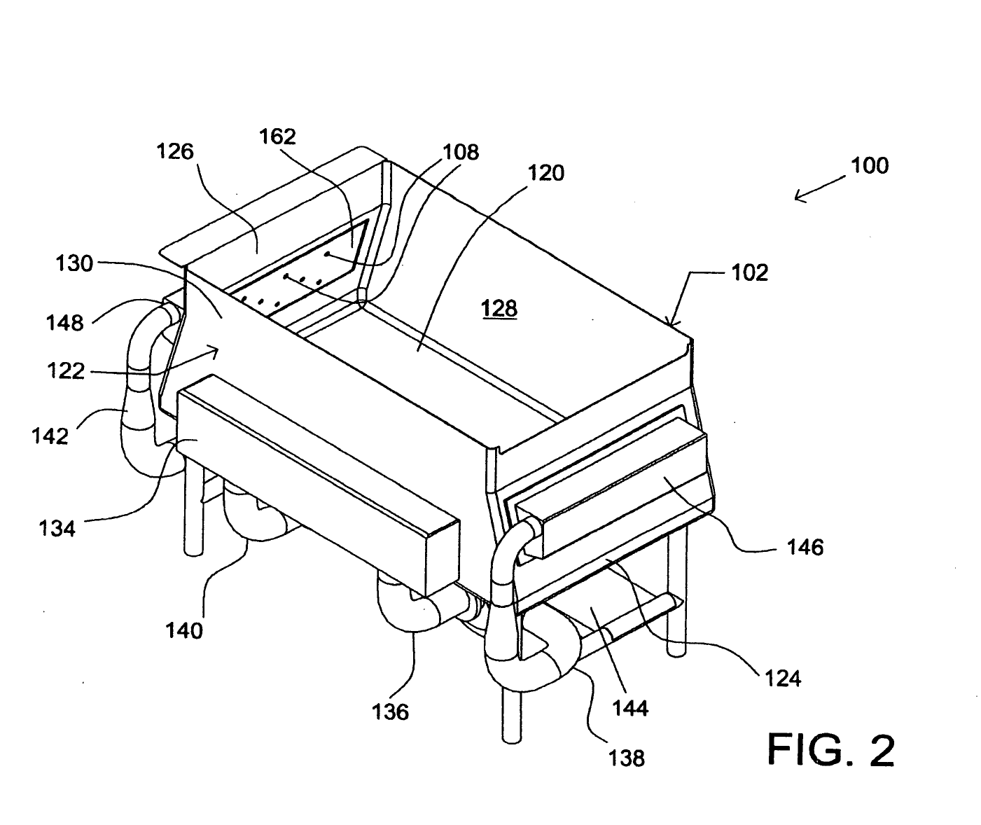

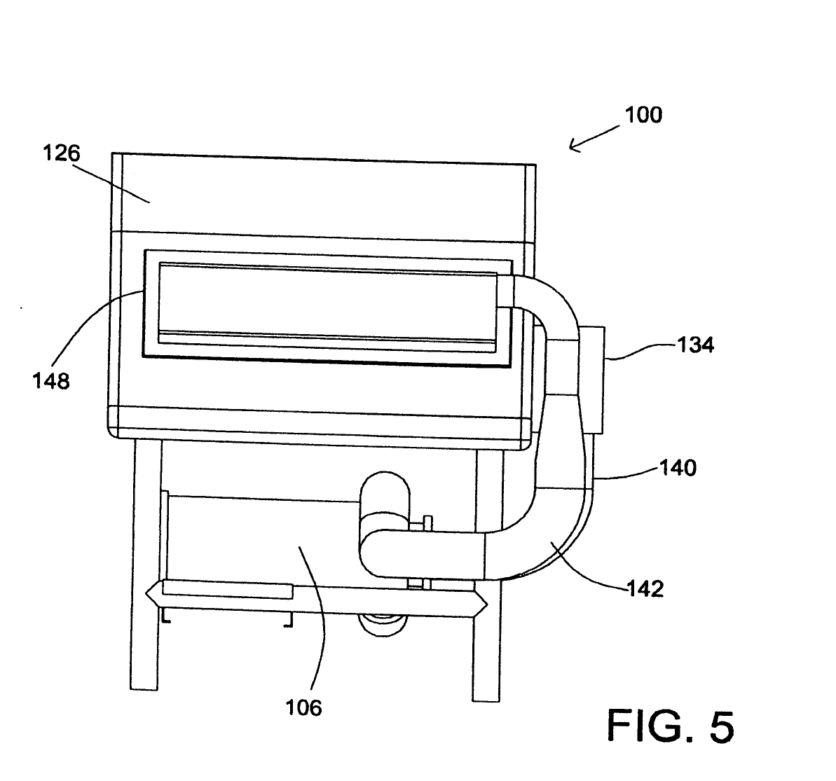

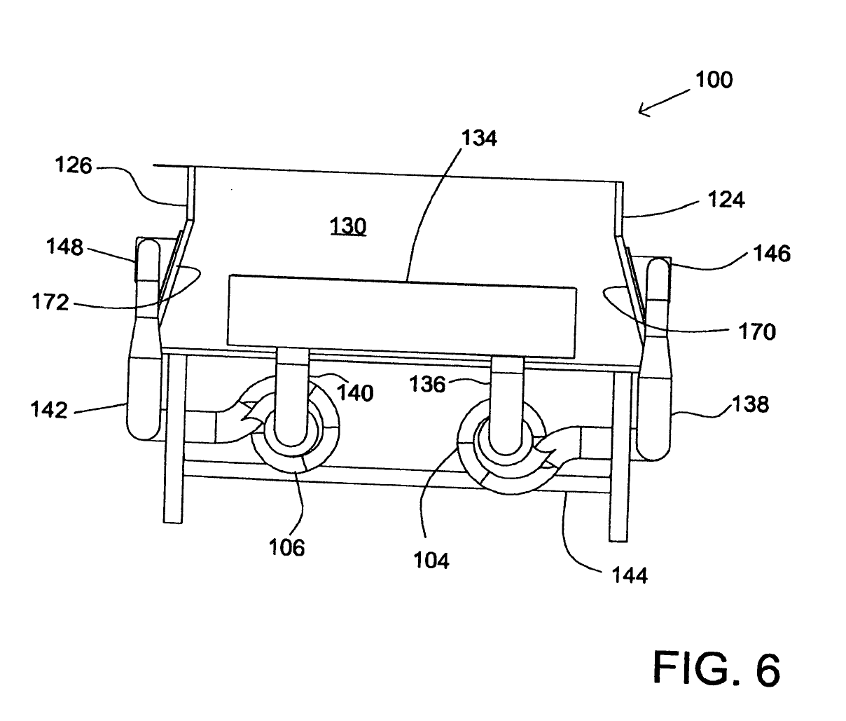

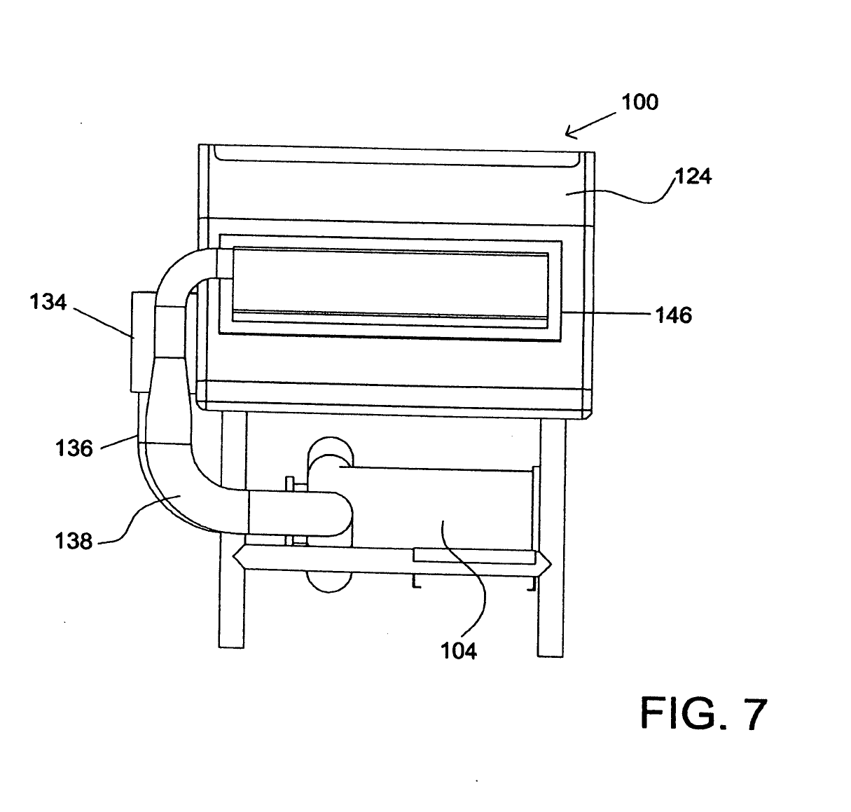

An exemplary kitchenware washing assembly embodying several aspects of the invention is illustrated in FIGS. 1 through 13 and is indicated generally by reference character 100. As shown in FIGS. 1 through 13, the washing assembly 100 includes a tank 102, two pumps 104 and 106, and outlets or discharge openings 108.

The tank 102 can and typically should include a drain 110 and valve system (not shown) to allow the tank 102 to be filled and emptied. The tank 102 will also typically include a faucet (not shown) to fill the tank 102.

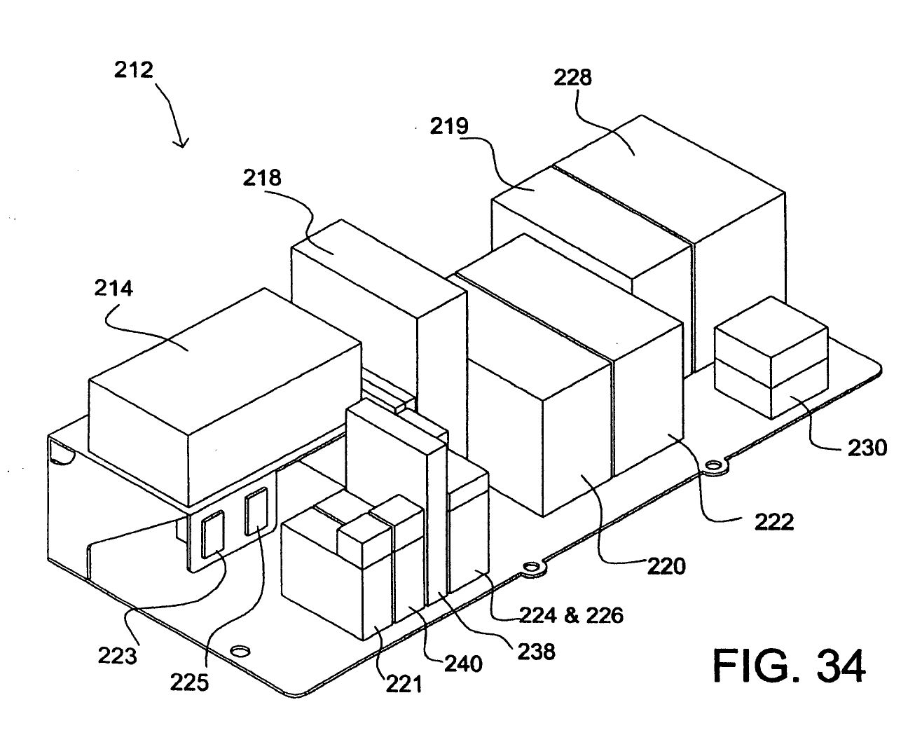

In general operation, the tank 102 is filled to operating level. One or both of the pumps 104 and/or 106 can be operating to pump cleaning fluid (e.g., water and a detergent or soap) from tank 102 through intake cover 150 to outlets or discharge openings 108. The drain 110 and valve system should be in a closed position to maintain the cleaning fluid in the tank 102. By way of example only, FIGS. 15A and 15B show the washing assembly 100 incorporated into an overall commercial washing system, including a scraping station 114, the washing assembly 100, a rinsing station 116, and a sanitizing station 118. Also shown in FIGS. 15A and 15B is an exemplary control system 212 (described in more detail below and shown in FIGS. 34 through 36) that can be used for controlling one or more operations of the kitchenware washing assembly 100.

With continued reference to FIGS. 1 through 3, the tank 102 includes a bottom 120 and an enclosure wall 122 extending generally upwardly from the bottom 120. In the illustrated embodiment, the enclosure wall 122 is formed by four walls 124, 126, 128, and 130. Alternative embodiments, however, can include tanks formed with more or less than four walls and/or formed in any other suitable configuration including cup-shaped, cylindrical, cubical, triangular, trapezoidal, circular, ovular, prismatic, a configuration having four walls generally perpendicular to the bottom, etc.

When the tank 102 is oriented as shown in FIG. 1, the walls 124 and 126 are sidewalls, wall 128 is a front wall, and wall 130 is a back wall. In the illustrated embodiment, the sidewalls 124 and 126 are shorter in height from top to bottom than the length from left to right of the front and back walls 128 and 130. Accordingly, the tank 102 is wider from left to right than the tank 102 is deep from front to back.

In one particular embodiment, the sidewalls 124 and 126 are preferably about twenty-eight inches in length from front to back and eighteen inches in height from top to bottom. Walls 128 and 130 are preferably about forty-two inches in length from left to right at the bottom edge, and preferably about thirty-six inches in length from left to right at the top edge. This difference in length between the top and bottom edges accounts for the angled portions 170 and 172 of walls 124 and 126. Front wall 128 is preferably the same height from top to bottom as sidewalls 124 and 126. In addition, a backsplash 131 can be provided that is preferably slightly higher than the tank walls by a few inches, as shown in FIGS. 15A and 15B. The dimensions are set forth as mere examples and can be varied as understood by those skilled in the art. For example, alternative tank configurations can include a configuration in which all tank walls are the same size and shape, a configuration in which the tank is circular or cup-shaped, or some other geometric configuration.

A wide range of materials can be used for the tank walls and bottom. In one embodiment, the tank walls and bottom are formed from stainless steel, thus providing a sturdy, long-lasting structure. Alternatively, other materials can be used for the tank walls and bottom. For example, the tank could be injection molded or thermoformed from a plastic or other suitable material.

The thickness of the tank walls can also vary depending, for example, on the particular application. In one embodiment, the tank walls and the bottom are formed from fourteen-gauge stainless steel, type 304.

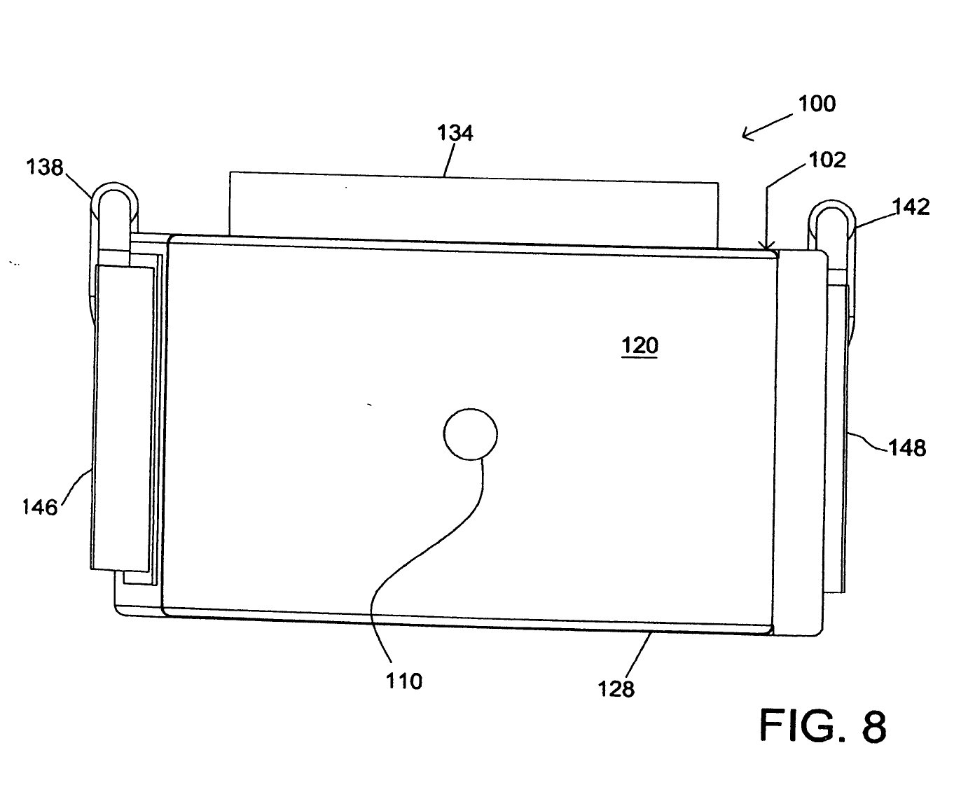

The tank's bottom 120 can be downwardly sloped to cause water to flow to the drain 110 (FIG. 8) when the drain 110 is open. The drain 110 can be conventionally connected to the facility plumbing and drainage system (not shown). Drain 110 can also include a shutoff valve (not shown) that allows the user to open and close the drain 110 to allow the tank 102 to be filled and emptied as desired. The drain 110 can further include a screen or perforated cover (not shown) to prevent debris from entering the drain 110 and clogging or partially clogging it. In various embodiments, the drain 110 and its connection to facility plumbing is standard and in use in most commercial washers.

A commercial washer of the variety disclosed herein should be able to circulate fluid within the tank to create turbulence in the tank. The turbulence helps to clean kitchenware and loosen tough food residues or remnants that become caked-on kitchenware during the cooking or food preparation process. In various embodiments of the present invention, the following components generally provide this function: intake opening 132, pumps 104 and 106, and outlets or discharge openings 108.

As just mentioned, the turbulence in the tank 102 helps to clean kitchenware and loosen tough food residues or remnants that become caked-on kitchenware during the cooking or food preparation process. In various embodiments, operation of the pumps 104 and 106 can advantageously heat the fluid within the tank 102 even without using a heater (e.g., heater 216, 416, 516, 616, etc.). In one particular embodiment, operation of the pumps 104 and 106 can increase the temperature of the fluid within the tank from about sixty-five degrees to about one hundred eighteen degrees Fahrenheit in about ninety minutes without using a heater. This heating can occur, for example, by way of the pumps 104 and 106 creating sufficient turbulence in the tank and by friction-generated heat from the rotating pump impellers. Advantageously, this can allow for reduced operating time for the heater (s), which, in turn, can provide significant energy savings, operating costs, prolong the useful life of the heater.

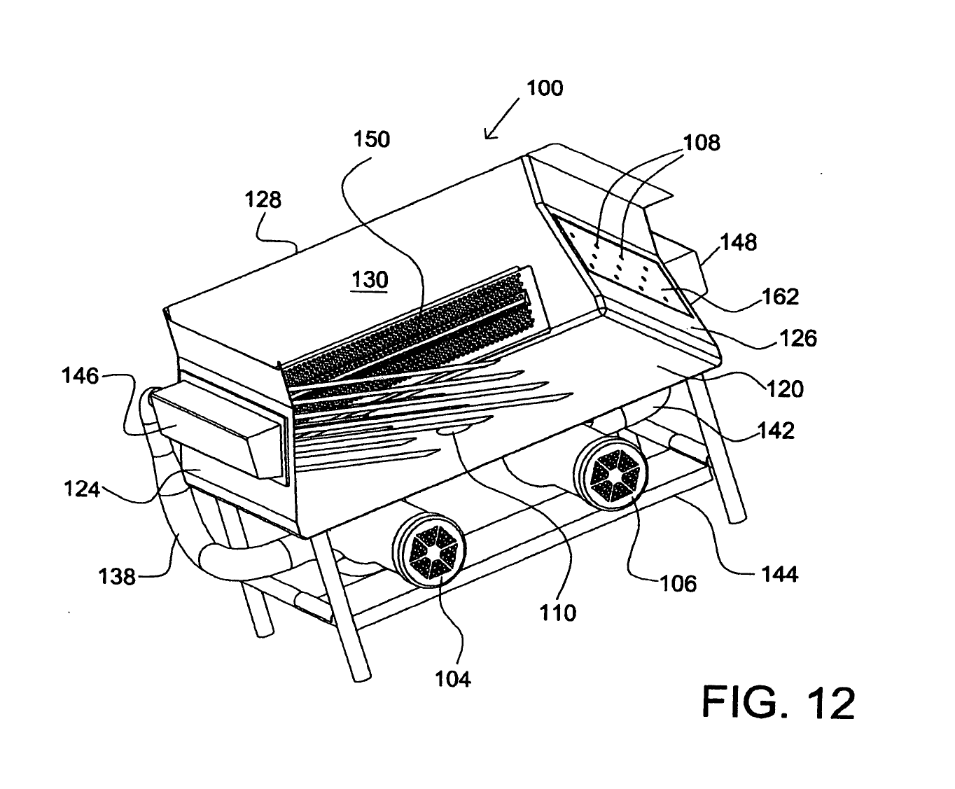

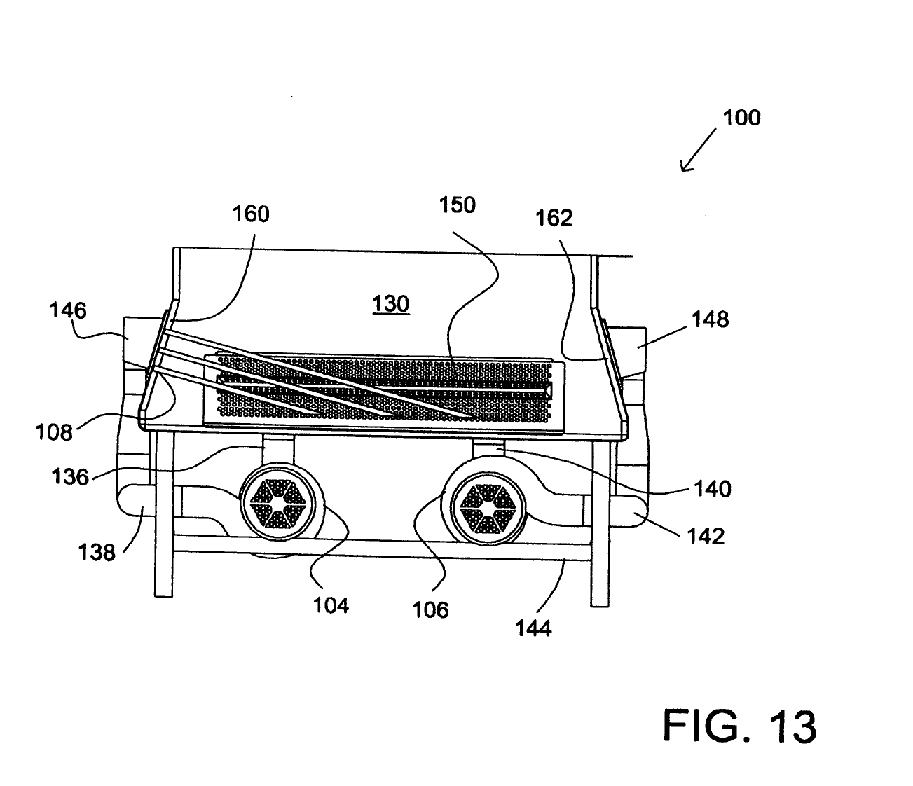

Each pump 104 and 106 is coupled in fluid communication with the tank 102 through the intake opening 132 on the back wall 130 and through outlets or discharge openings 108 on a respective one of the tank sidewalls 124 and 126. By using two pumps 104 and 106, one of the pumps may remain active while the other pump is idle or inoperable due to failure or malfunction, as shown in FIGS. 12 and 13. Accordingly, a multi-pump system allows for at least some use of the tank 102 even when one pump is inoperable and/or being serviced.

As compared to commercial washers having a single pump that is single speed and that creates a constant level of turbulence, a multi-pump design can increase the effectiveness of the washer by providing adjustable levels of turbulence as well as providing higher turbulence, which can be especially useful for removing inordinately caked-on food. With a multi-pump design of the present invention, one pump may be shut down while the other pump runs at a low rate in order to reduce the turbulence to a level more suitable for cleaning more fragile and delicate dishware, such as china and expensive ceramic plates. A multi-pump design also allows for reducing the length (and costs) of the fluid conduits as compared to the fluid conduit length for connecting a single pump to the inlet and both outlets. Either or both pumps 104 and/or 106 can be cycled off and on at various speeds and durations to alter flow patterns in the tank 102. Accordingly, embodiments of the present invention are suitable for use with a variety of cleaning needs including large pots and pans that are not subject to breaking under turbulent tank conditions as well as more delicate and fragile dishware.

Alternative embodiments, however, can include more or less than two pumps depending, for example, on the particular application. For example, another embodiment includes a third pump which may be connected to an outlet chamber on the front wall. Yet another embodiment includes a washing assembly that includes only one pump. Further embodiments can include a separate intake chamber for each pump rather than having each pump 104 and 106 connected to a single intake chamber 134. In such embodiments, one pump can be coupled in fluid communication between a respective intake chamber and outlet, and the other pump can be coupled in fluid communication between the other intake chamber and outlet.

Referring to FIGS. 1 through 3, fluid conduits are used for coupling each pump 104 and 106 in fluid communication between the intake chamber 134 and the outlet chambers 146, 148 on the respective sidewalls 124 and 126. More specifically, fluid conduits 136 and 138 respectively connect the pump 104 to the intake chamber 134 and to the outlet chamber 146. Fluid conduits 140 and 142 respectively connect the pump 106 to the intake chamber 134 and to the outlet chamber 148. Alternatively, however, either or both pumps 104 and 106 can be connected directly to the intake chamber 134 and/or outlet chamber 146, 148 without any connecting fluid conduits.

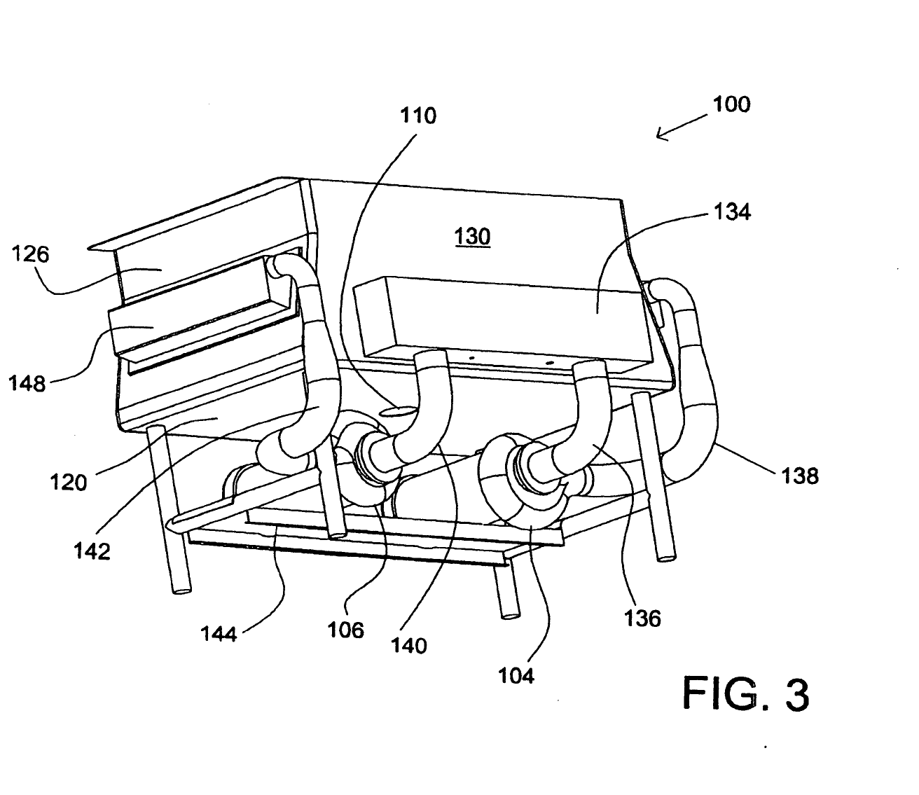

In various embodiments, the pumps 104 and 106 are positioned relative to the intake chamber 134 and outlet chambers 146, 148 in order to optimize (or at least reduce) the length of the conduits 136, 138, 140, 142. For example, and as shown in FIG. 3, each pump 104 and 106 is positioned under the bottom 120 of the tank 102 such that each pump's inlet is aligned with the respective location at which the fluid conduit 136 and 140 connects to the intake chamber 134. This, in turn, reduces the conduit length needed to connect each pump to the intake chamber 134. The shorter conduit lengths can allow the washing assembly 100 to operate more quietly because of less resistance (less wasted power) due to the shorter intake and discharge lengths. In addition, various embodiments allow for smoother less turbulent (and thus quieter) flow in the conduits due to smoother transitions (e.g., fewer sharp corners, fewer turns). Further, the shorter suction conduits reduce the chance of pump cavitation, which, in turn, also allows for quieter operation.

Although the illustrated embodiment includes outlets on two opposing walls, aspects of this invention are not so limited. For example, alternative embodiments of this invention include a tank having outlets on only one wall, a tank having outlets on two walls that are not opposing, and a tank having outlets on more than two walls. In addition, other embodiments include a tank having an outlet and an intake opening on the same wall.

A wide range of materials can be used for the fluid conduits 136, 138, 140, and 142, and the same material need not be used for each fluid conduit. Exemplary materials that can be used for the fluid conduits include rubber, plastic, stainless steel, and combinations thereof, among other suitable materials. In one particular embodiment, the fluid conduits 136, 138, 140, 142 are formed from two-inch or three-inch diameter rubber tubing such that the fluid conduits are relatively flexible. While the fluid conduits 136, 138, 140, 142 are illustrated with generally circular cross-sections, other suitable cross-sectional shapes can be used for the fluid conduits.

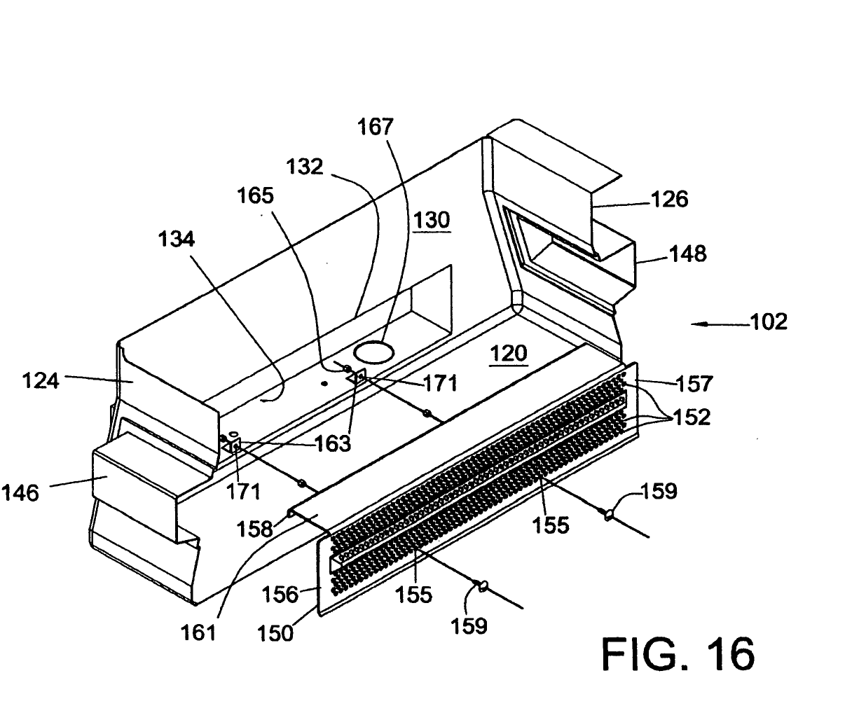

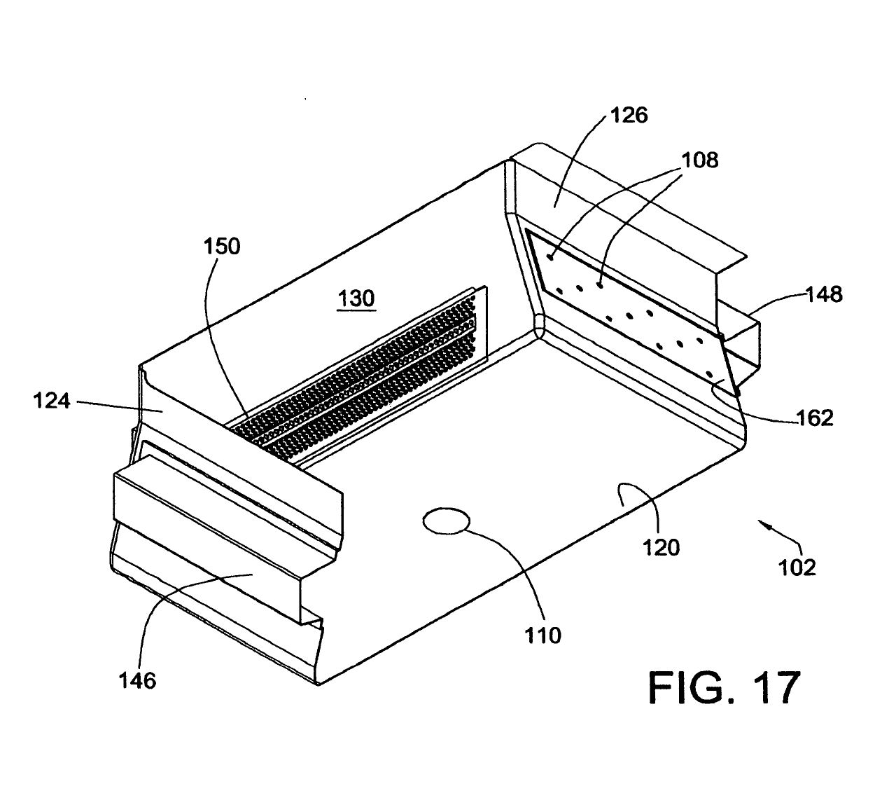

As shown in FIG. 16, the intake opening 132 comprises a front open portion of the intake chamber 134, which, in turn, is disposed on the back wall 130. Alternatively, the intake opening 132 and intake chamber 134 can be located at any other tank location, such as the front wall, bottom, sidewalls, etc.

The fluid conduits 136 and 140 connect to the intake chamber 134 along the bottom of the intake chamber 134 such that the fluid conduits 136 and 140 are spaced apart from one another. Alternatively, the fluid conduits 136 and 140 can be connected to the intake chamber 134 at other suitable locations.

The fluid conduits 136 and 140 can be coupled to the intake chamber 134 in various ways. In embodiments in which the fluid conduits 136 and 140 are formed from relatively rigid pipes, such as stainless steel, the fluid conduits 136 and 140 can be welded, bolted (e.g., by flange connection), threaded, bonded, etc. to the intake chamber 134. In one example embodiment, the fluid conduits 136, 140 and the intake chamber 134 are formed from a weldable material like stainless steel. In this particular example, the fluid conduits 136 and 140 are welded to a wall of the intake chamber 134.

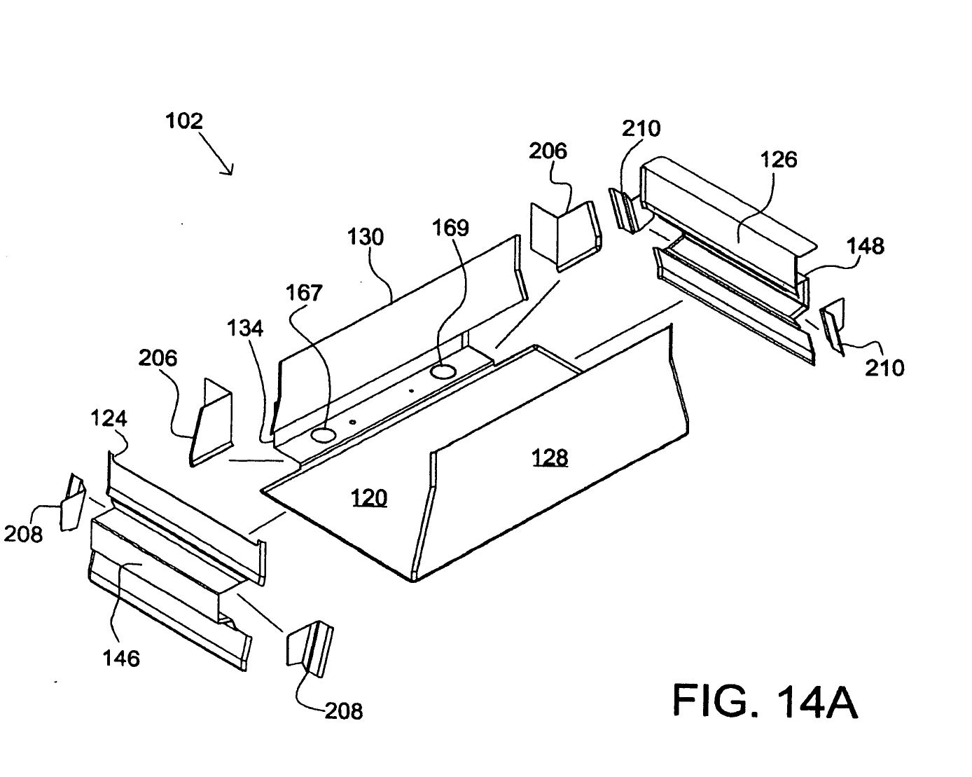

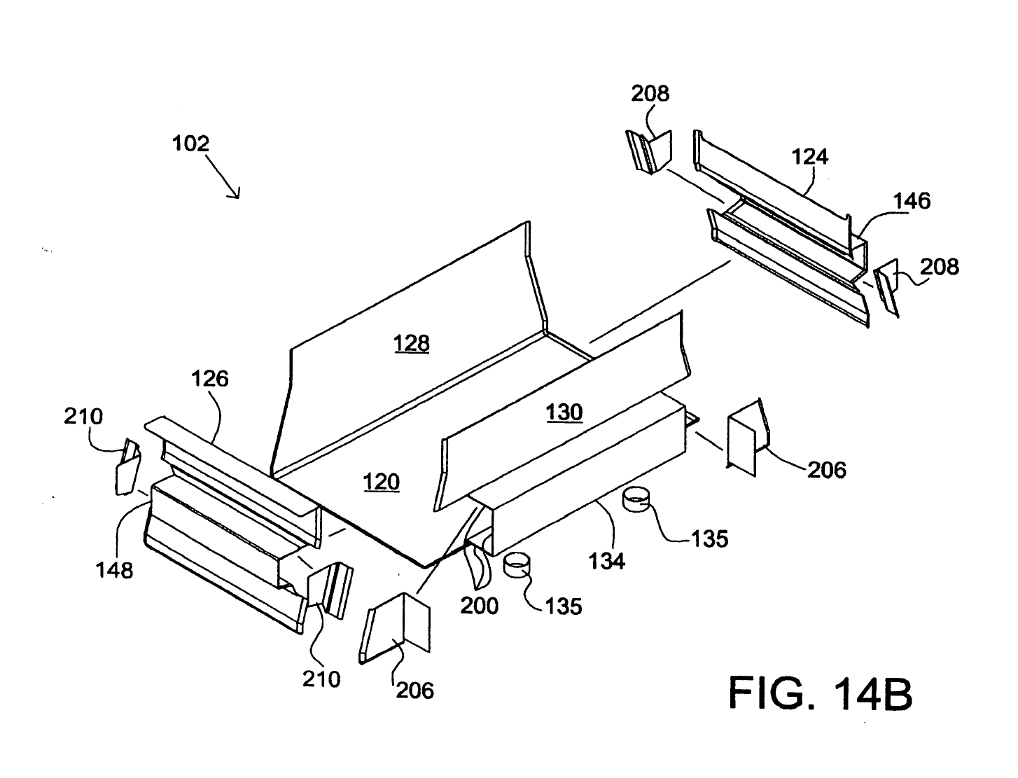

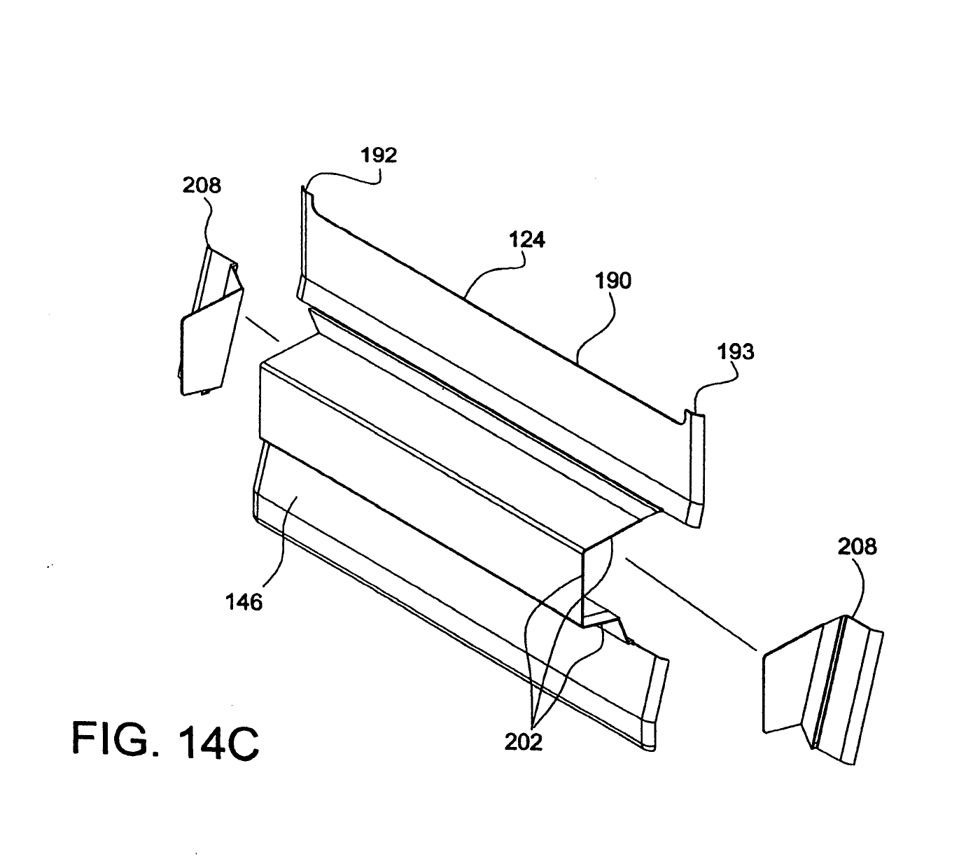

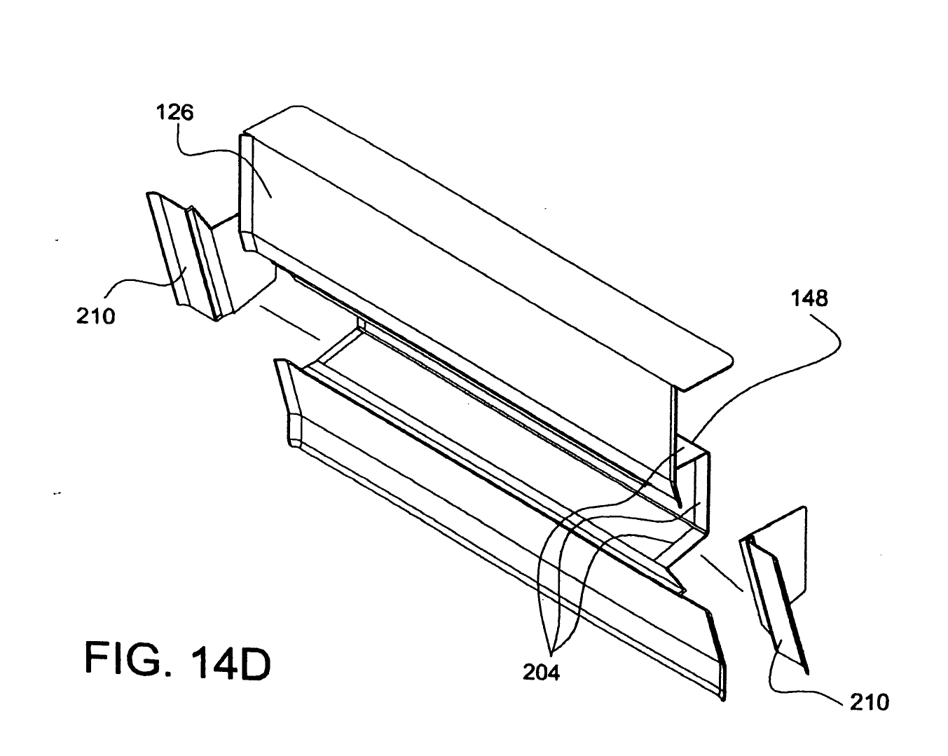

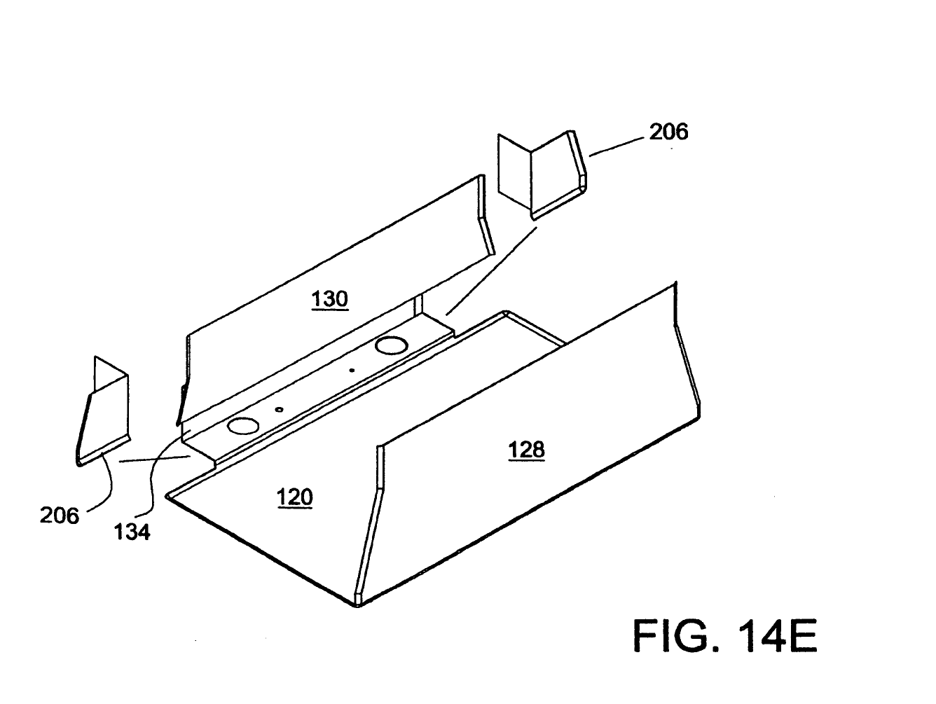

In embodiments in which the fluid conduits 136 and 140 are formed from generally flexible tubing or hoses, the fluid conduits 136 and 140 can be connected to the intake chamber 134 by way of connector members or fittings, such as hose barbs or bibs. For example, hose barbs 135 (FIG. 14B) can be attached (e.g., bolted, welded, adhesively bonded, threaded, etc.) to the intake chamber 134 at locations 167 and 169 (FIG. 14A). Alternatively, in those embodiments in which the tank is formed by injection molding or thermoforming, hose barbs can be unitarily or monolithically formed with the tank such that the hose barbs would not be separately attached to the intake chamber.

A wide range of materials can be used for the hose barbs 135, depending, for example, on the particular material(s) used for intake chamber 134 and/or the particular means by which the hose barbs 135 will be attached to the intake chamber 134. In one particular embodiment, the hose barbs 135 are formed from stainless steel and are welded to the intake chamber 134.

The fluid conduits 136 and 140 can be coupled to the hose barbs 135 in various ways depending, for example, on the particular material(s) forming the hose barbs 135 and conduits 136, 140. In one particular embodiment, end portions of the conduits 136 and 140 are slid over the hose barbs 135, and then clamps (not shown) are used to retain the conduits 136 and 140 to the hose barbs 135. Alternatively, other suitable means can be employed for coupling the fluid conduits 136 and 140 to the intake chamber 134.

The fluid conduits 138 and 142 connect to the respective outlet chambers 146 and 148 along the chamber end walls 208, 210. Alternatively, the fluid conduits 138 and 142 can be connected to the respective outlet chambers 146 and 148 at other suitable locations.

The fluid conduits 138 and 142 can be coupled to the respective outlet chambers 146 and 148 in various ways. In embodiments in which the fluid conduits 138 and 142 are formed from relatively rigid pipes, such as stainless steel, the fluid conduits 138 and 142 can be welded, bolted (e.g., by flange connection), threaded, bonded, etc. to the respective outlet chambers 146 and 148. In one exemplary embodiment, the fluid conduits 138, 142 and the outlet chambers 146, 148 are formed from a weldable material, such as stainless steel. In this particular example, each fluid conduit 138 and 142 is welded (e.g. extrusion welded, etc.) to a wall of the corresponding outlet chamber 146 and 148.

In embodiments in which the fluid conduits 138 and 142 are formed from generally flexible hoses, the fluid conduits 138 and 142 can be connected to the respective outlet chambers 146 and 148 by way of connector members or fittings, such as hose barbs or bibs. For example, hose barbs can be attached (e.g., bolted, welded, adhesively bonded, threaded, etc.) to the outlet chambers 146 and 148 in various ways. Alternatively, in those embodiments in which the tank is formed by injection molding or thermoforming, hose barbs can be unitarily or monolithically formed with the outlet chambers 146 and 148 such that the hose barbs would not be separately attached to the outlet chambers.

A wide range of materials can be used for the hose barbs, depending, for example, on the particular material(s) forming the outlet chambers 146, 148 and/or the particular means by which the hose barbs are attached to the outlet chambers 146 and 148. In one particular embodiment, the hose barbs are formed from stainless steel and are welded to the outlet chambers 146 and 148.

The fluid conduits 138 and 142 can be coupled to the hose barbs in various ways depending, for example, on the particular material(s) forming the hose barbs and conduits 138 and 142. In one particular embodiment, end portions of the conduits 138 and 142 are slid over the hose barbs, and then clamps (not shown) are used to retain the conduits 138 and 142 to the hose barbs. Alternatively, other suitable means can be employed for coupling the fluid conduits 138 and 142 to the respective outlet chambers 146 and 148.

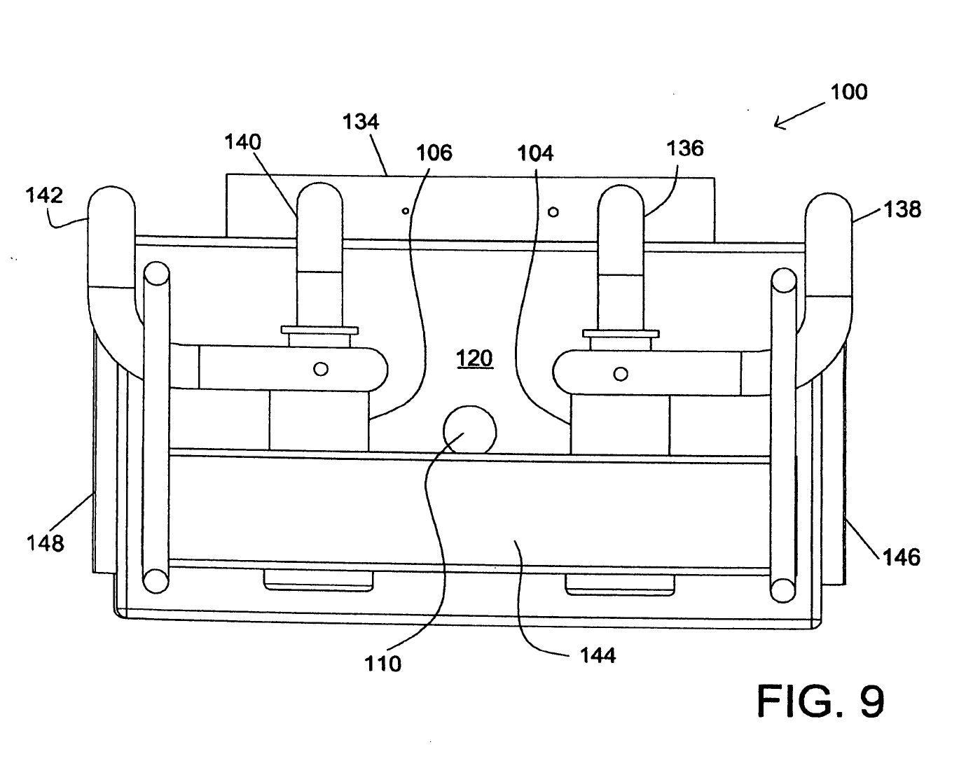

As shown in FIG. 9, the pumps 104 and 106 are positioned and supported by a slidable shelf 144. The shelf 144 can be positioned generally under the tank 102, thereby providing a convenient storage location for the pumps 104 and 106. When the pumps 104 and/or 106 need to be serviced, the shelf 144 can be slidably moved out from under the tank 102 to thereby provide access to the pumps 104 and 106. In some embodiments, each pump 104 and 106 is positioned on a separate shelf so that each pump can be separately slid out from under the tank 102. In such embodiments, one pump can thus be serviced without having to disconnect and/or slide the other pump out from under the tank. In various embodiments, the pumps 104 and 106 are configured such that they can be readily detached from their respective conduits 136, 138, 140, and 142.

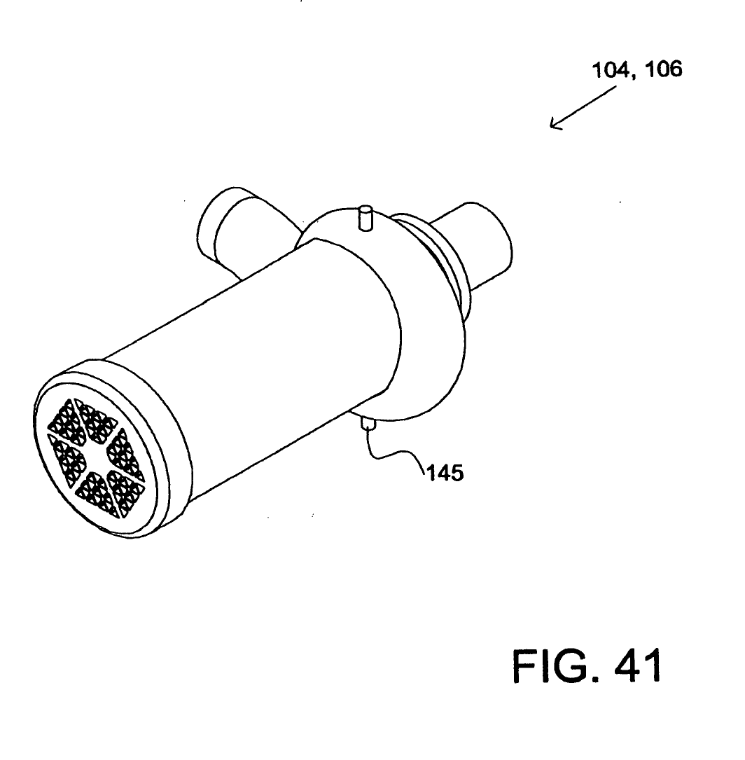

As shown in FIG. 41, each pump 104 and 106 includes a drain 145 positioned at or near a low point in each pump. These drains 145 provide an operator with the ability to drain a substantial portion of the fluid from the tank 102, interconnecting conduits 136, 138, 140, 142 and/or from each pump 104 and 106. Each drain 145 is preferably operable with little effort by the operator. By way of example only, these drains 145 can be controlled by a manual valve, an actuator activated valve, combinations thereof, and/or by other suitable means.

In various embodiments, each pump 104 and 106 is a variable speed pump that is separately operable at a different speed as compared to the other pump. A control system (e.g., control system 212 described herein and shown in FIGS. 34 through 36) can be used for controlling the operation of the pumps 104 and 106. The control system can include one or more modes configured to operate one pump at a different speed than the other pump. For example, the control system may include a mode in which one pump is idle while the other pump is operational.

When operating, the pumps 104 and 106 draw cleaning fluid from the tank 102 through inlet holes 152 of the intake cover 150 and into the respective fluid conduits 136 and 140. The pumps 104 and 106 direct the cleaning fluid through the respective fluid conduits 138 and 142 to the outlet chambers 146 and 148 for discharge by the openings 108 into the tank 102.

A wide range of pumps can be used for pumps 104 and 106. In one particular embodiment, each pump 104 and 106 comprises a one and one-half horsepower three thousand four hundred fifty revolutions per minute pump. In another embodiment, each pump 104 and 106 is a closed-coupled, end suction centrifugal pump with a maximum capacity of three hundred gallons per minute at eighteen hundred revolutions per minute, and each pump 104 and 106 includes a two horsepower, frequency drive duty motor. Alternatively, other suitable pumps can be used.

In one particular embodiment, the intake opening 132 is preferably about seven inches in height from top to bottom, and thirty inches in length from left to right. In addition, the intake chamber 134 is preferably about four inches deep from front to back as measured from the intake opening 132 to the back wall of the intake chamber 134. The dimensions are set forth as mere examples and can be varied as understood by those skilled in the art.

Referring now to FIGS. 16 through and 23, an intake cover 150 can be positioned to cover intake opening 132. The intake cover 150 includes inlets and a projection 154 that extends into the tank 102.

As used herein, the term “inlet” broadly includes any opening for receiving fluid from the tank, such as perforations, pipes, and holes. In the illustrated embodiment, the intake cover's inlets are inlet holes 152 in the intake cover 150. The term “inlet holes”, as used herein, refers to mere holes in the intake cover 150, or equivalent openings, which do not include separate parts such as pipes, nozzles, or the like for receiving fluid flow from the tank.

The inlets holes 152 allow fluid to be drawn into the intake chamber 134, while the intake cover 150 restricts food debris and other small items like silverware from entering the intake opening 132 and entering the pumps 104 and 106. In addition, the projection 154 helps keep kitchenware (e.g., plates, pans, dishware, etc.) from being drawn up flush against the inlet holes 152 and blocking fluid passage through the inlet holes 152, which might otherwise decrease operational efficiency of the kitchenware washing assembly.

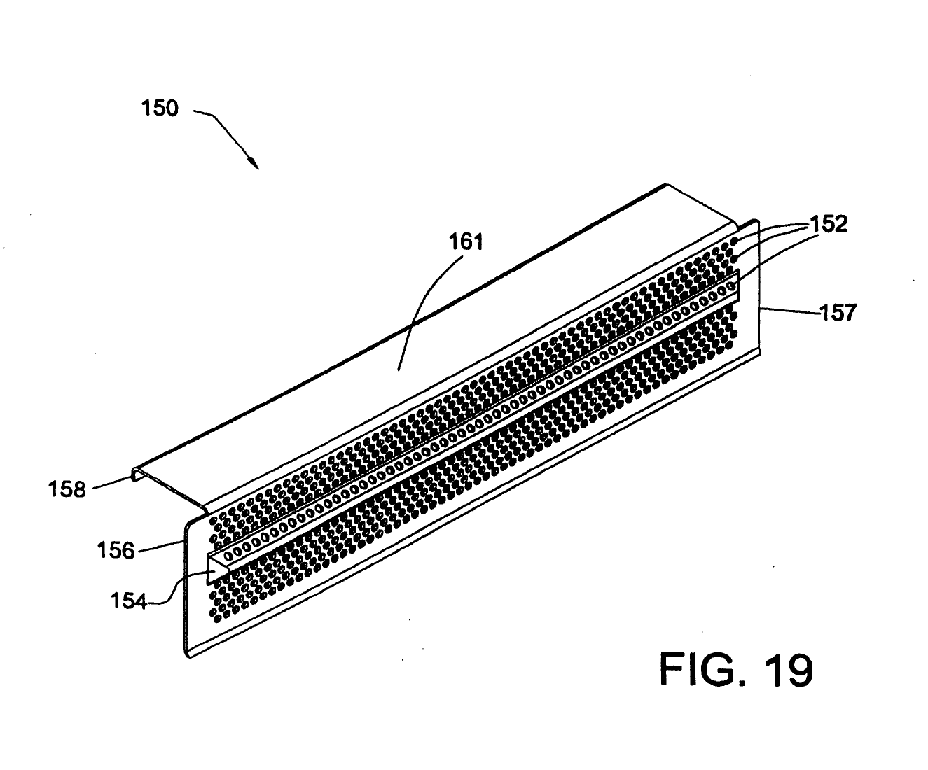

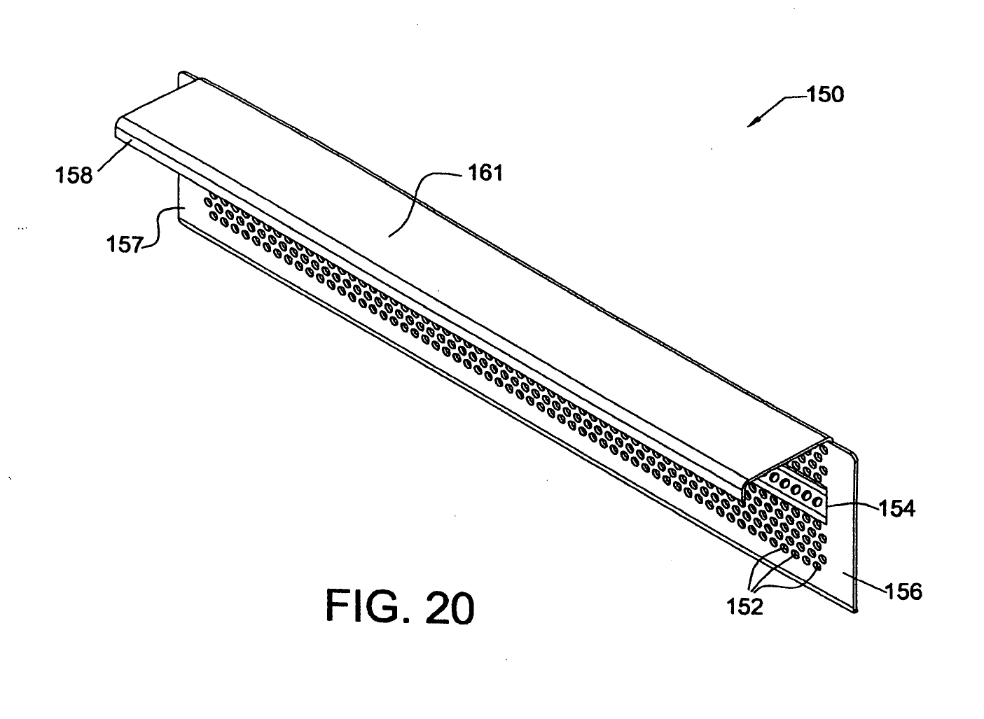

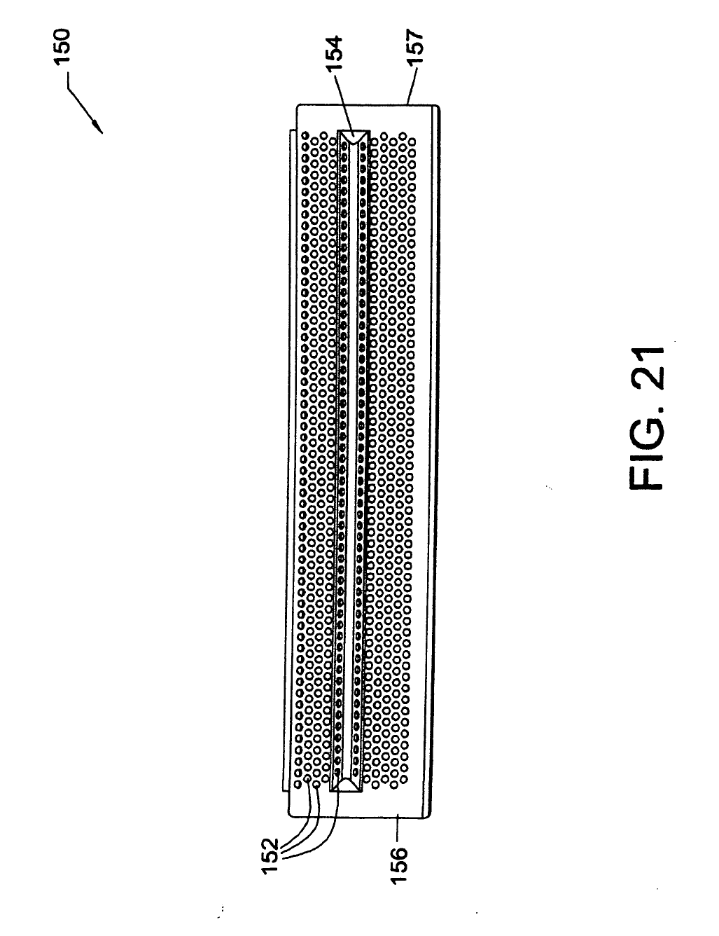

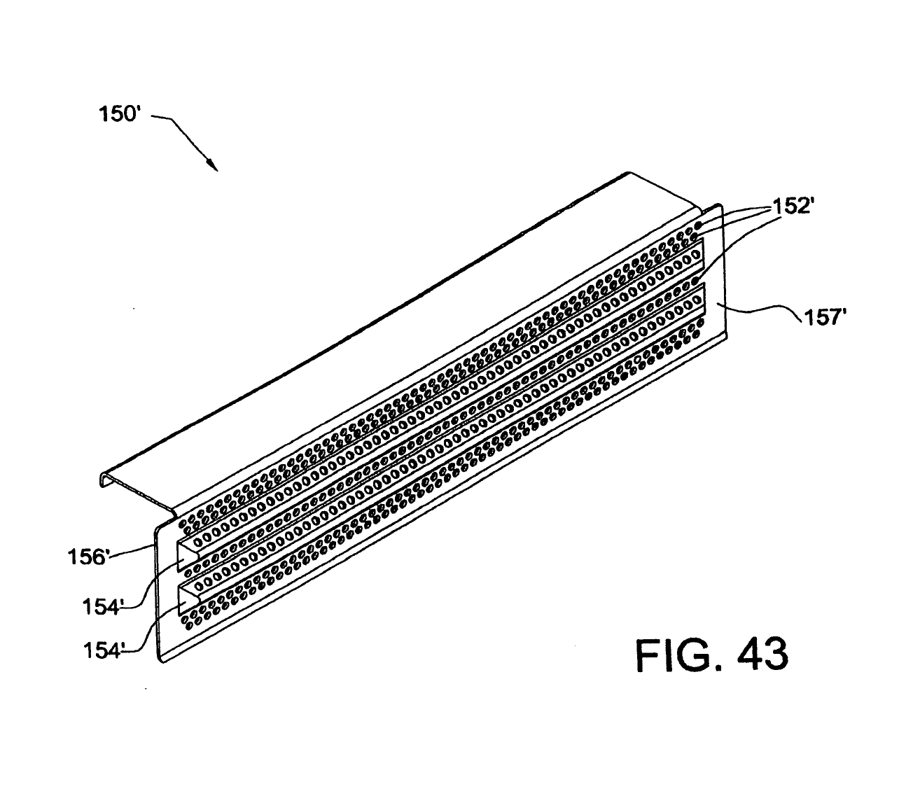

In the illustrated embodiment, the projection 154 comprises a rib that extends longitudinally between the first and second sides 156 and 157 of the intake cover 150. As shown in FIG. 19, the projection 154 does not extend completely across the intake cover 150. But in other embodiments, the projection extends completely across the intake cover from its first side to its second side. Yet other embodiments include one or more projections that extend diagonally across the intake cover (e.g., between upper and lower corners of the intake cover). Additional embodiments include one or more vertically extending projections. In further embodiments, the intake cover includes a plurality of projections that extend into the tank. These projections can extend longitudinally, vertically, diagonally, in a crossing pattern, parallel with one another, and combinations thereof, etc. The particular number and arrangement of projections on the intake cover can vary depending, for example, on the particular application. By way of example only, FIG. 43 shows an alternative embodiment of an intake cover 150′ having inlet holes 152′ and two projections 154′ longitudinally extending between the intake cover's first and second sides 156′ and 157′.

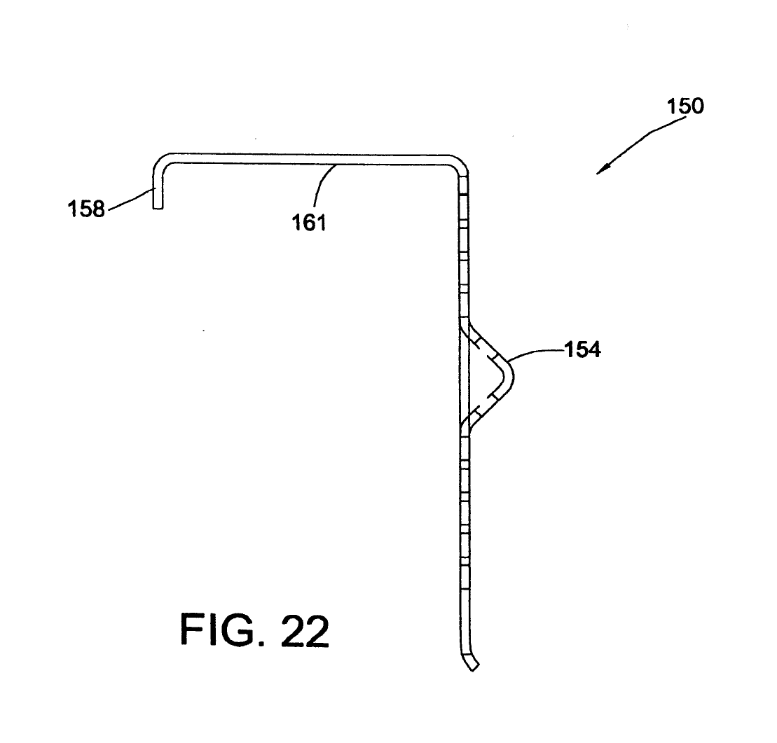

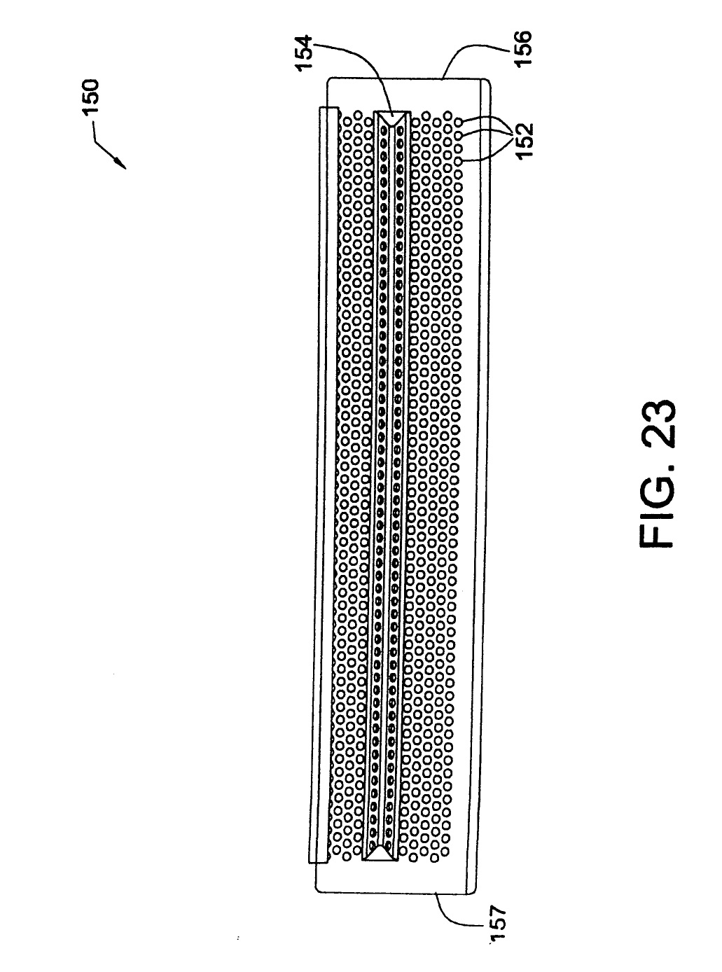

With further reference to FIG. 22, the projection 154 has a generally V-shaped longitudinal cross-section with a generally flat or rounded bottom portion. Stated differently, the projection 154 defines a generally V-shaped channel with inwardly sloping walls that connect to a generally flat or rounded bottom portion.

Alternative embodiments, however, include projections having other cross-sectional shapes and geometric configurations including hemispherical and substantially solid cross-sections (e.g. trapezoidal, triangular, rectangular, etc.) that do not define a channel, among other suitable cross-sectional shapes and geometric configurations.

In various embodiments, the intake cover 150 is detachable from the tank 102. Advantageously, this allows the interior of the intake chamber 134 (and components therein) to be readily accessed, for example, for cleaning and sanitizing. In addition, having a detachable intake cover 150 also allows the intake cover 150 itself and its inlet holes 152 to be more easily serviced, for example, to replace the intake cover 150, clean out the inlet holes 152, and/or clean other portions of intake cover 150.

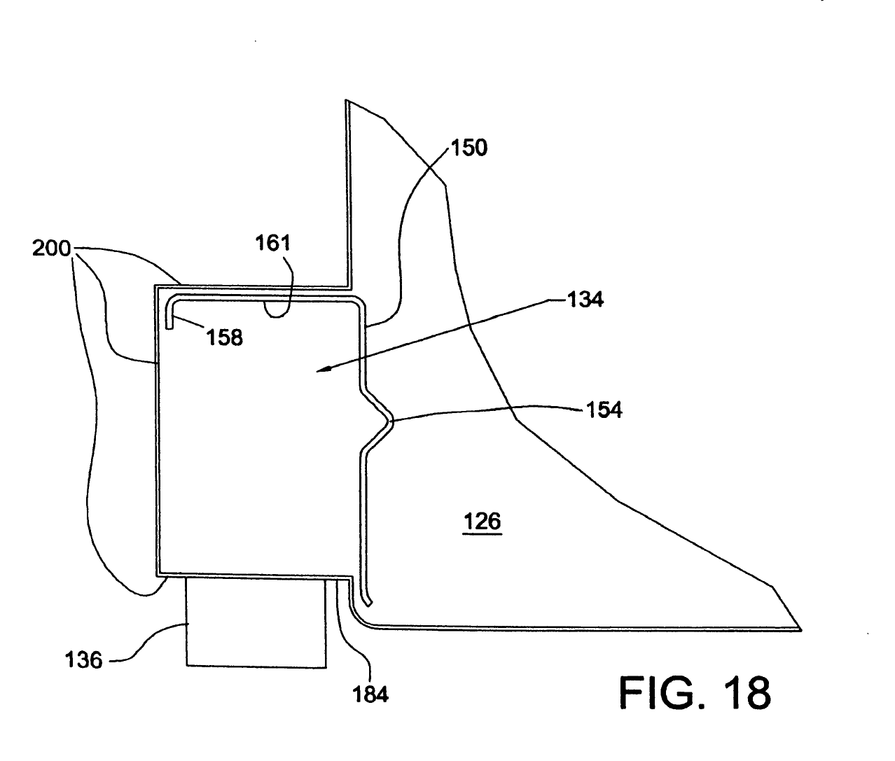

As shown in FIG. 16, the intake cover 150 includes fastener holes 155, and an upper flange 161 having a downwardly depending lip 158. The intake cover 150 is installed by positioning the intake cover 150 over the intake opening 132 such that the lip 158 is positioned adjacent a back wall of the intake chamber 134, as shown in FIG. 18. Screws 159 (FIG. 16) are inserted into the fastener holes 155, through holes 171 of tabs 163, and retained to tabs 163 by nuts 165. Alternatively, the intake cover 150 can be attached to the tank 102 using other suitable means. For example, another embodiment includes an intake cover that is hingedly attached to the tank using hinge bars. In this embodiment, the intake cover can hingedly swing open into the tank to thereby provide access to the intake chamber and any components therein (e.g., heater, etc.).

The particular inlet hole pattern (e.g., the number, size, shape, and positions of the holes, etc.) can vary depending, for example, on the desired velocity or fluid flow rate through the inlet holes. In the illustrated embodiment, the projection 154 includes a portion of the inlet holes 152. Alternatively, the projection 154 can instead include all or none of the inlet holes 152.

In addition, the inlet holes 152 can be patterned (e.g. shaped, sized, positioned, etc.) to substantially distribute the flow of intake fluid across the intake cover 150. In one embodiment, the inlet holes 152 are patterned to substantially evenly distribute the intake fluid pressure across a lateral length of the intake cover 150. In this particular embodiment, the inlet holes 152 are patterned such that more of the intake cover's material mass is relatively distributed in front of the locations (e.g., 167 and 169 in FIG. 14A) at which the fluid conduits 136 and 140 connect to the intake chamber 134. The inlet holes 152, which are aligned with the locations at which the fluid conduits 136 and 140 connect to the intake chamber 134, can be smaller and/or be more spaced apart than the other inlet holes 152. Varying the inlet hole size and/or staggering inlet hole spacing can help equalize the fluid pressure and flow across the lateral length of the intake cover 150. This, in turn, can help equalize the static pressure and return velocity of the fluid within the intake chamber 134, thereby reducing turbulence of the fluid flow into the conduits 136 and 140.

In one particular embodiment, the intake cover 150 is formed from a sheet of stainless steel into which the inlet holes 152 are formed (e.g., laser cut, etc.). The sheet can be cut into a particular configuration (e.g., width, length, etc.), and then bent to form the projection 154, upper flange 161 and downwardly depending lip 158. Alternatively, a wide range of other suitable materials and manufacturing processes can be used to form the intake cover.

The washer assembly 100 includes outlets for directing fluid from the pumps 104 and 106 into the tank 102. As used herein, the terms “outlet” broadly includes any opening such as perforations, pipes, and discharge openings for directing fluid into the tank.

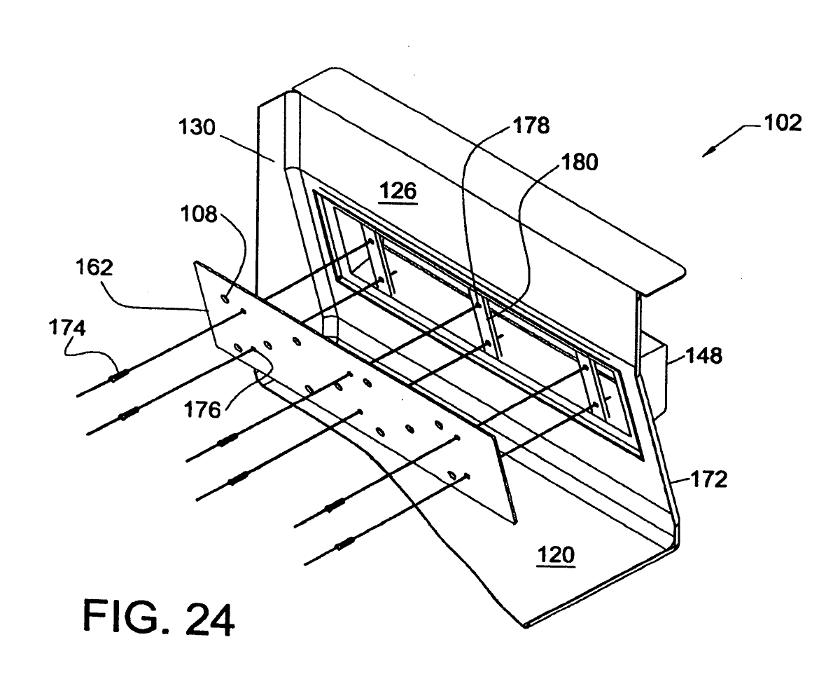

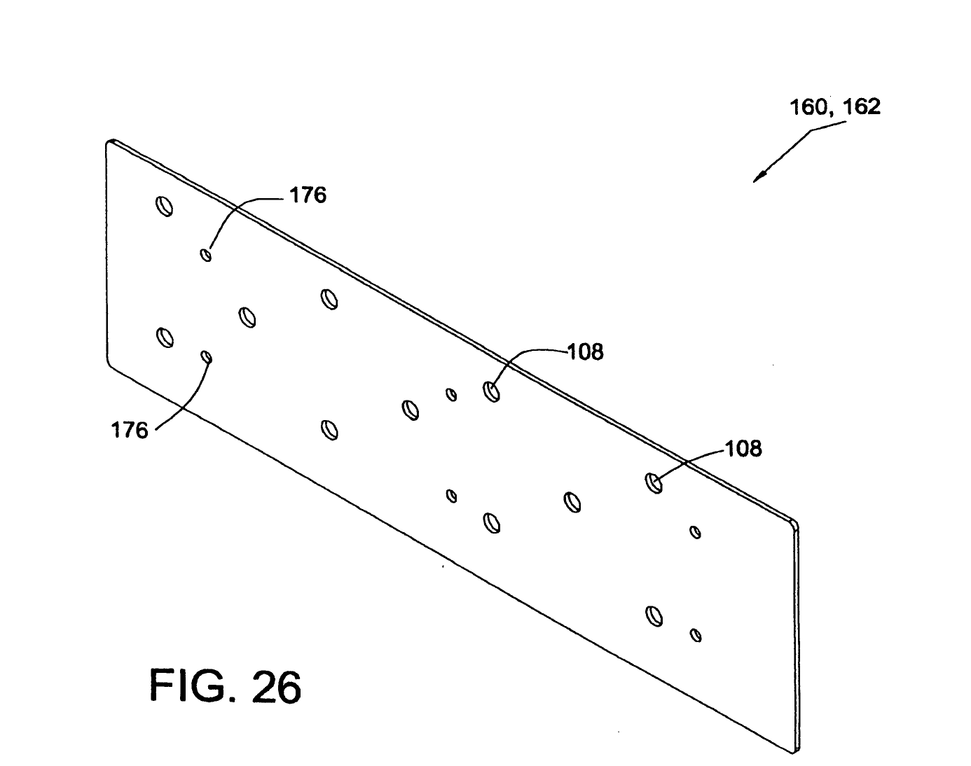

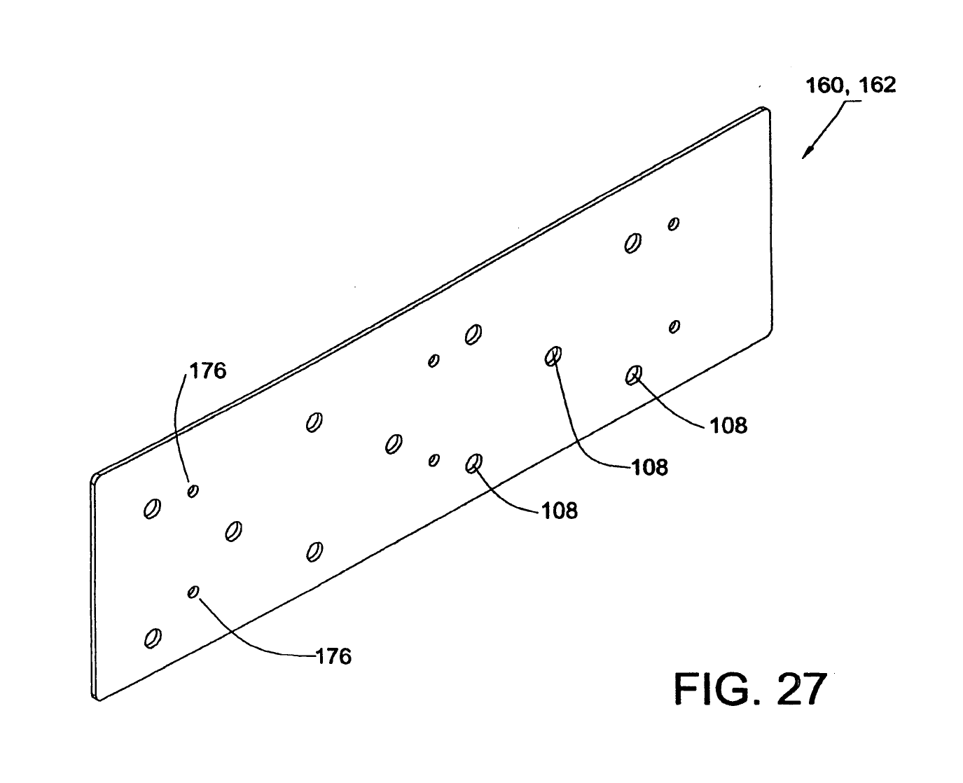

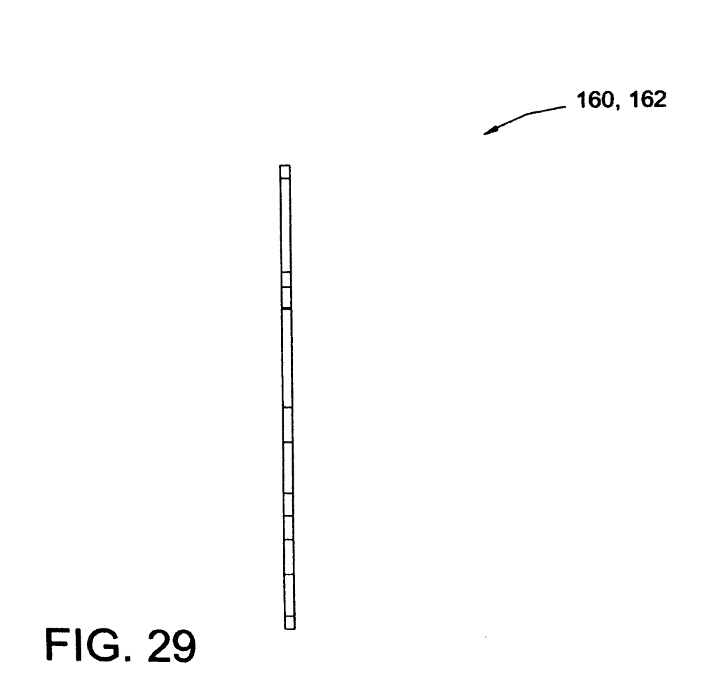

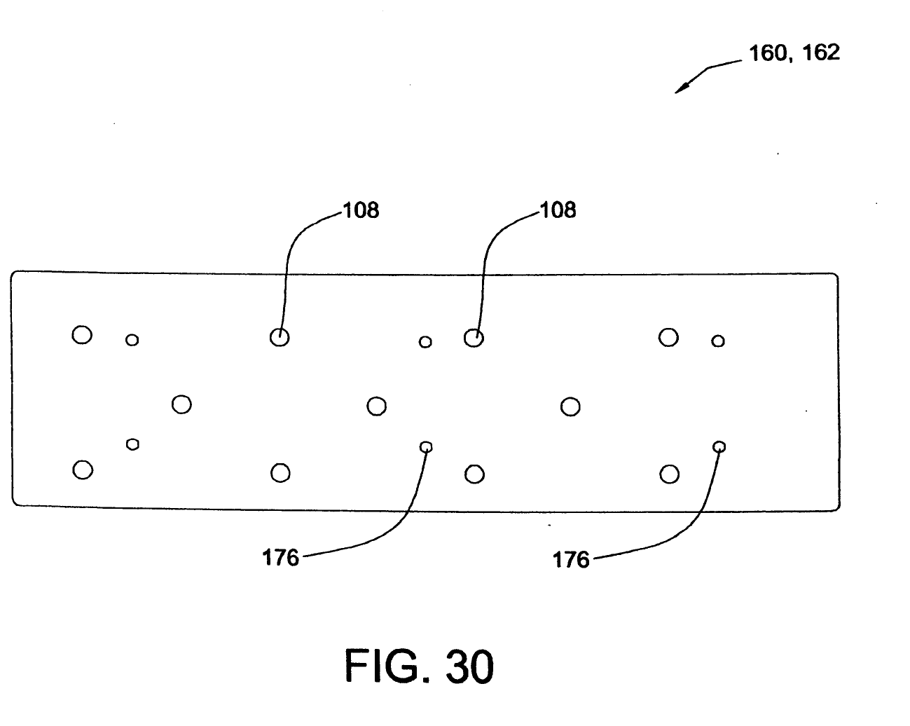

In the illustrated embodiment of FIGS. 24 through 30, the outlets are discharge openings 108 that are formed in the detachable outlet covers 160 and 162. The term “discharge openings”, as used herein, refers to mere holes in the outlet covers 160 and 162, or equivalent openings, which do not include separate parts such as pipes, nozzles, or the like for directing the fluid flow.

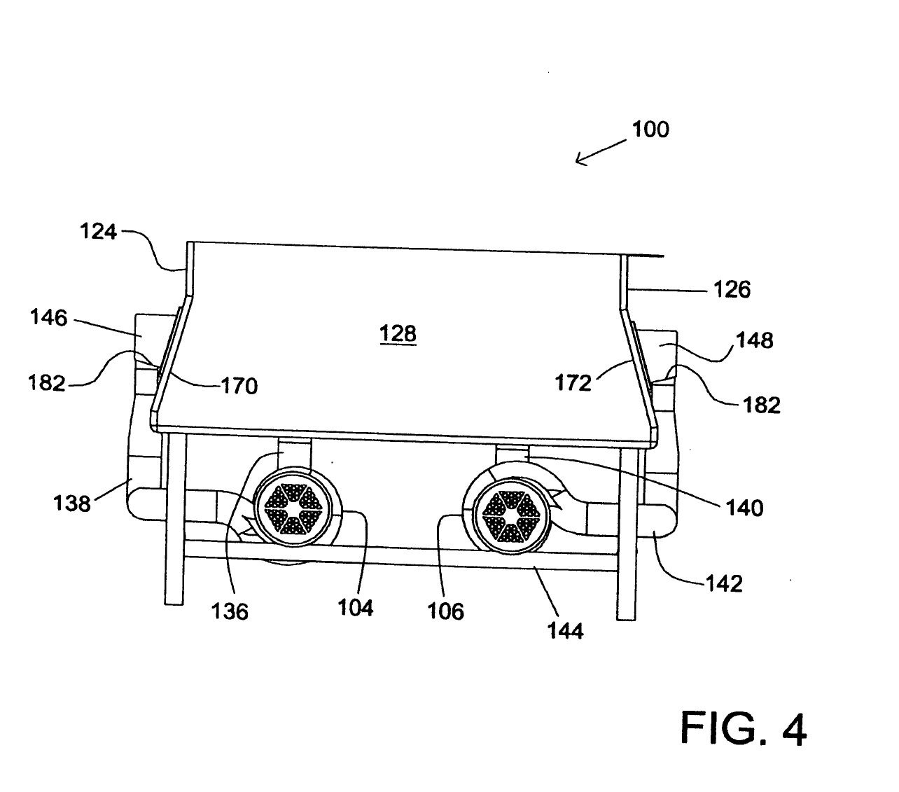

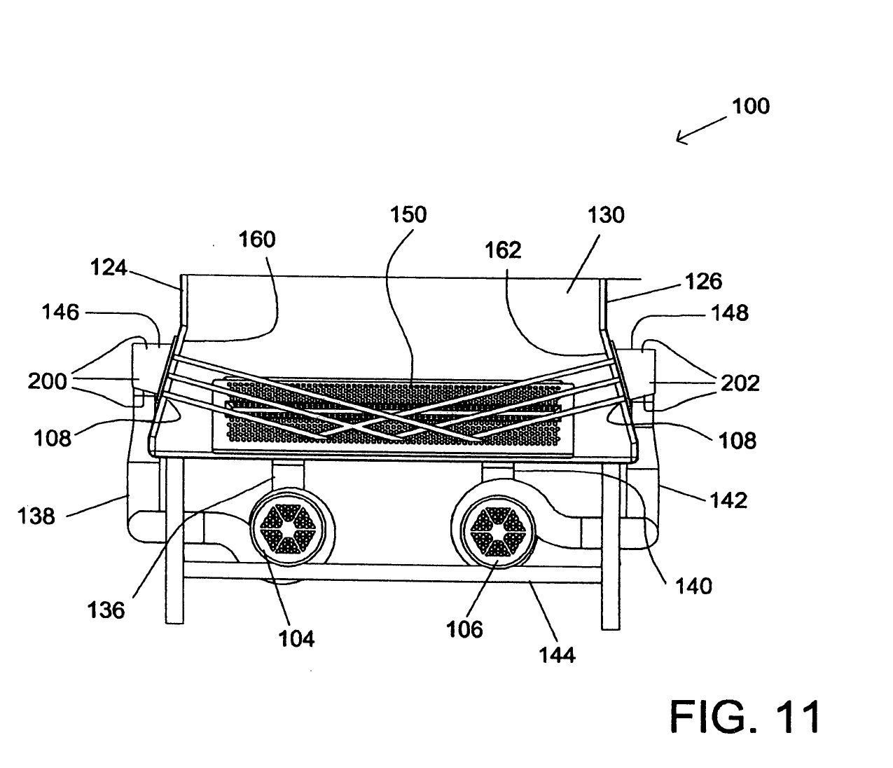

Because it is desirable to have the fluid directed down into the tank 102 to avoid splashing fluid out of the tank, the walls 124 and 126 preferably include portions 170 and 172 (FIG. 4) that are angled downwardly. The outlet covers 160 and 162 (FIG. 11) are disposed on these downwardly angled wall portions 170 and 172 such that at least some of the discharge openings 108 are located on the angled wall portions, and, more preferably, all discharge openings 108 are located on the angled portions.

By providing the angled wall portions 170 and 172, the need to include separate pipes and nozzles to direct fluid down into the tank is eliminated and the size of the opening at the top of the tank 102 is increased. Eliminating the need for separate pipes and nozzles also allows for the elimination of problems associated with pipes and nozzles unnecessarily extending into the tank and getting in the way when then tank is full of dishware, personnel catching their hands on pipes and nozzles during the dishwashing process, and/or increased manufacturing costs associated with pipes and nozzles.

In other embodiments, however, a similar effect is accomplished by angling the entire tank walls, but this reduces the size of the opening at the top of the tank. Nevertheless, aspects of the present invention will work fine by angling the entire wall and/or locating the discharge openings on the wall itself. If the entire wall is angled it, of course, includes an angled portion.

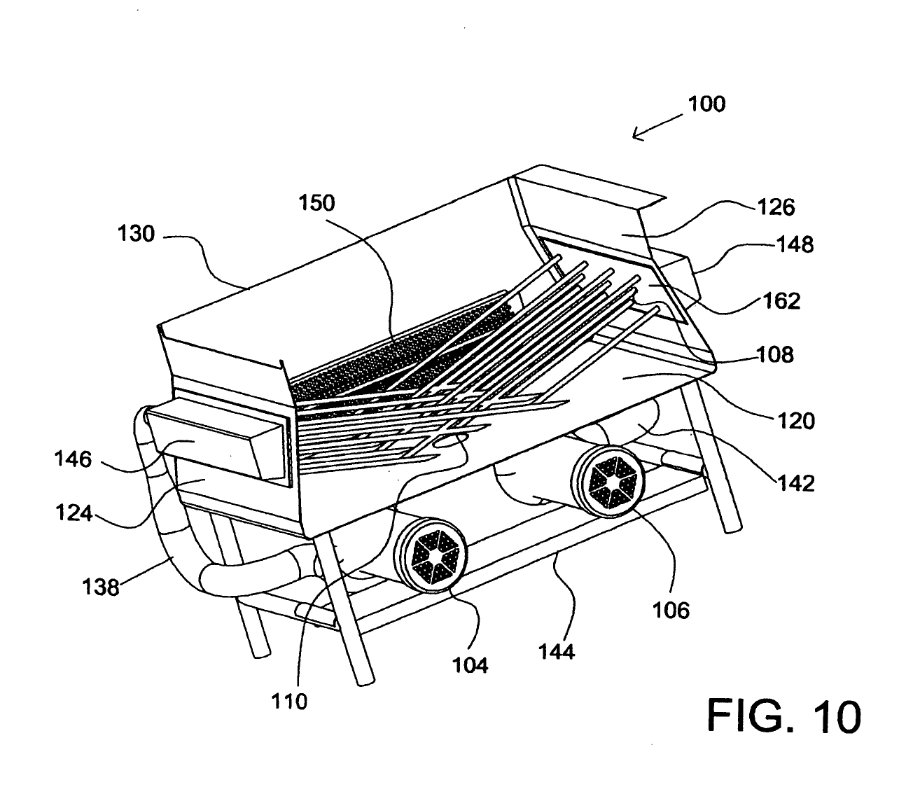

In the illustrated embodiment, the outlet covers 160 and 162 are positioned on opposing walls 124 and 126. In embodiments having a circular or ovular shaped tank, the outlet covers 160 and 162 can be positioned on opposed portions of the curved wall. Alternative embodiments, however, include washer assemblies having outlets or discharge openings on only one wall or on more than two walls. But placing the outlets on opposed walls is generally preferred. With the opposed configuration, turbulence in the tank is increased to facilitate cleaning kitchenware. As shown in FIGS. 10 and 11, the opposed discharge openings 108 discharge the fluid such that the fluid forms a crossing pattern. The crossing pattern causes increased turbulence in the tank 102 to enhance the cleaning ability of the washer assembly 100 while minimizing (or at least reducing) splashing of washing fluid from the tank 102.

The particular pattern (e.g., number of, size, shape, positions of the discharge openings, etc.) can vary depending, for example, on the desired velocity or fluid flow rate through the openings. For example, the illustrated embodiment includes circular discharge openings 108 having a diameter of about 7/16 inches. Alternatively, other sizes and shapes of openings can be used, for example, in order to increase or decrease the velocity or fluid flow rate through the openings.

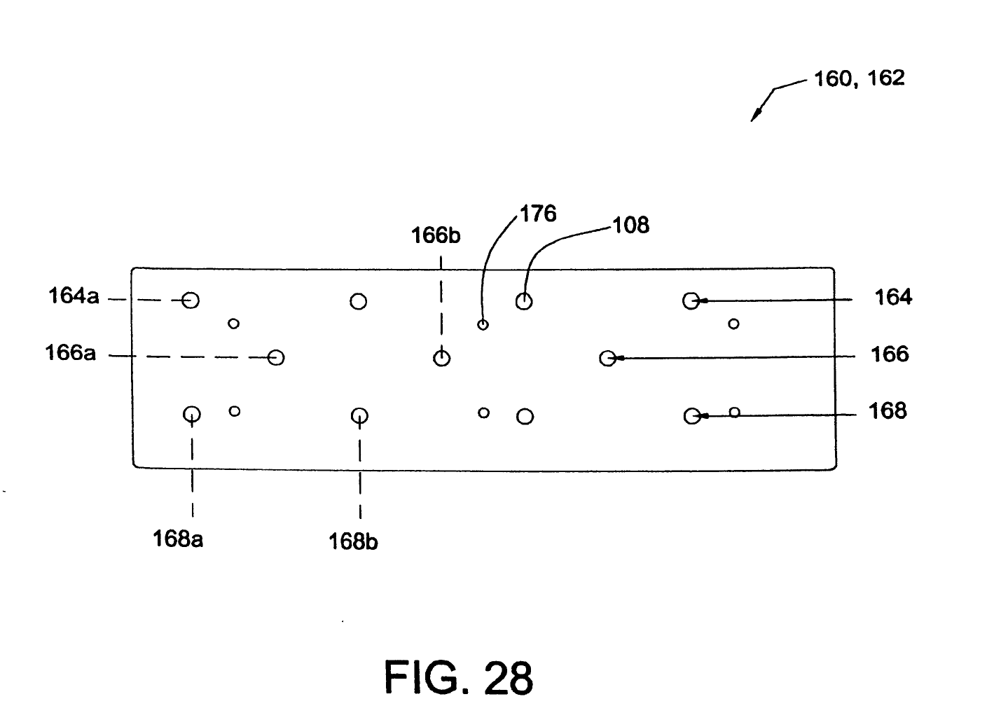

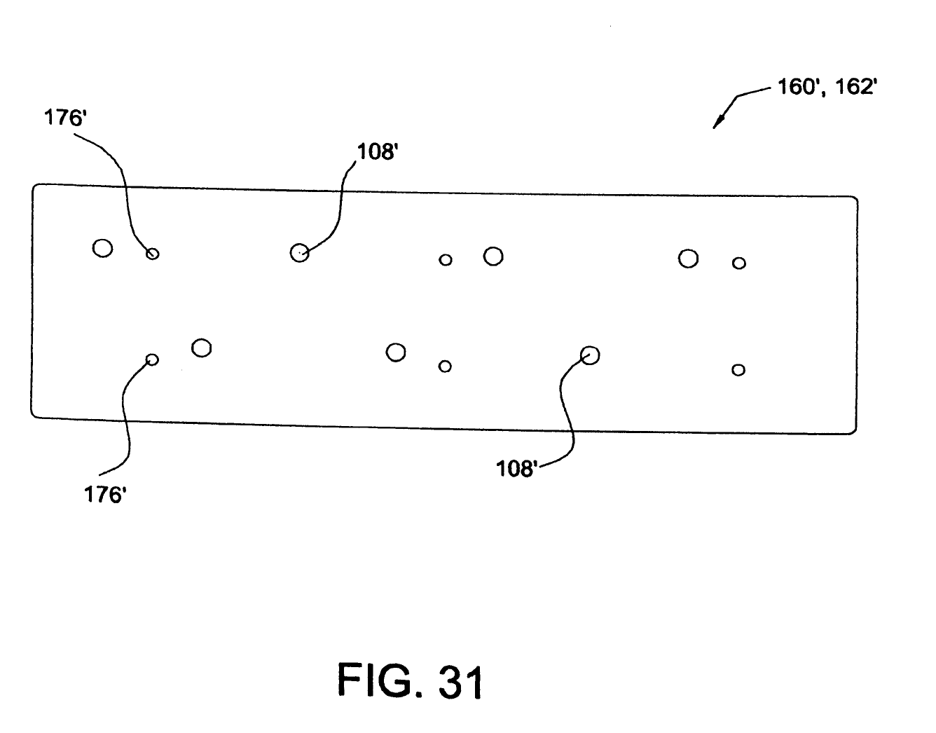

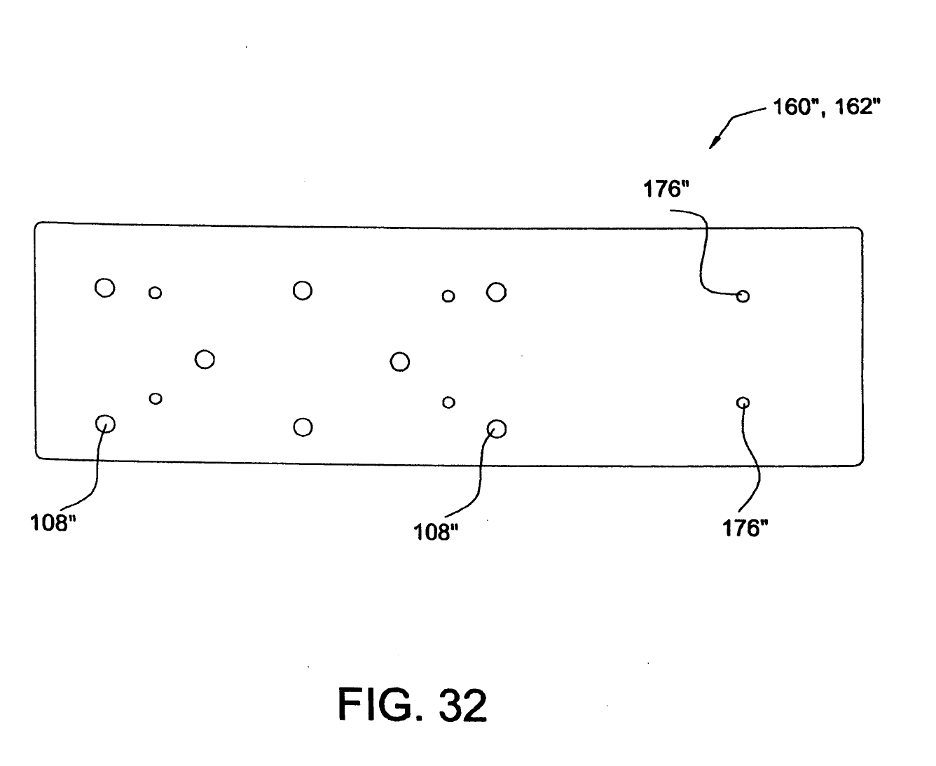

In addition, the discharge openings 108 of each outlet cover 160 and 162 can be arranged in any number of rows and columns. FIG. 28 illustrates an exemplary arrangement in which the discharge openings 108 are arranged in three rows 164, 166, 168. In one embodiment, the distance between horizontal centers of the discharge openings 108 is preferably about 5.27 inches (as shown in FIG. 28 between points 168a and 168b). The vertical distance between centers of the openings 108 in each row is preferably about 1.94 inches (as shown in FIG. 28 between points 164a and 166a). The horizontal distance between hole centers for adjacent rows is preferably half the distance between horizontal centers in a given row and is about 2.635 inches (as shown in FIG. 28 between points 166b and 168b). The distances, number, and arrangement of discharge openings 108 shown and described are exemplary only, as the distances, number, and arrangement of such openings can be altered. For example, FIGS. 31 through 32 respectively illustrate outlet covers 160′, 162′ 160″, 162′, having outlets 108′, 108″ and fastener holes 176′, 176″. The outlets 108′, 108″ form a pattern that is different than the outlet pattern of the outlet covers 160, 162 shown in FIG. 28.

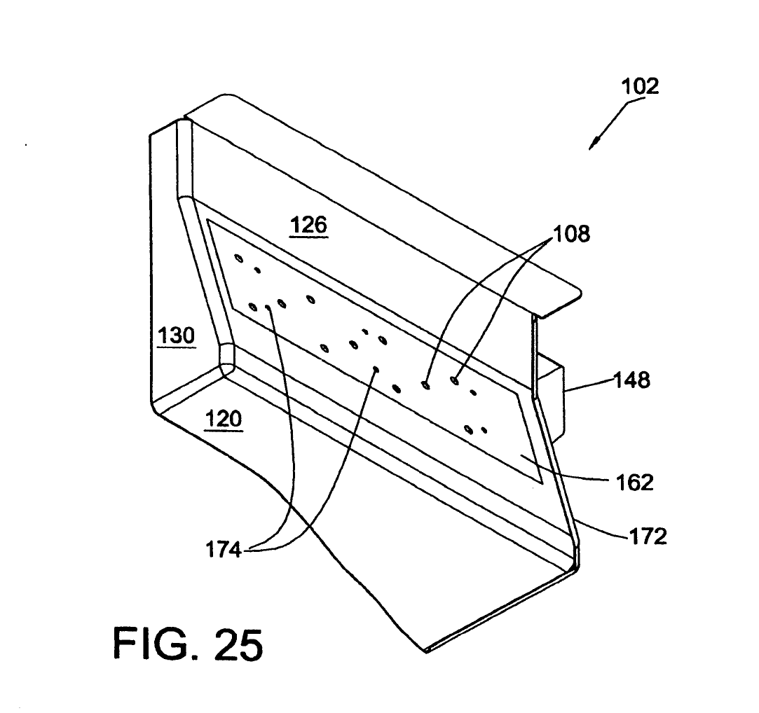

As shown in FIG. 4, sidewalls 124 and 126 include angled portions 170 and 172, respectively, upon which the outlets or discharge openings 108 (FIG. 25) are located. In one embodiment, the angled wall portions 170 and 172 are angled between about sixty degrees and eighty degrees from horizontal. In another embodiment, the angled portions 170 and 172 are angled about seventy-five degrees from the horizontal. In the illustrated embodiment, the outlet covers 160 and 162 include discharge openings 108 which are located on the angled portions 170 and 172 such that fluid directed through the discharge openings 108 forms a crossing pattern as shown in FIGS. 10 and 11. To enhance fluid rotation in the tank 102, various embodiments offset the opposing patterns on the opposed walls 124 and 126 so that the discharge openings 108 are not on directly opposed paths. In one particular embodiment, this is accomplished by shifting the discharge openings pattern on one of the outlet covers slightly to the left, and/or shifting the discharge openings pattern on the other outlet cover slightly to the right.

In one exemplary embodiment, the rearward-most discharge openings 108 of the outlet cover 160 are preferably about 7.3 inches from the back edge of wall 124, and the forward-most discharge openings 108 of outlet cover 160 are about 4.6 inches from the front edge of wall 124. This adjustment is reversed for the outlet cover 162 in order to create a forward/rearward offset between opposed discharge openings. The rearward-most discharge openings 108 of the outlet cover 162 are preferably about 4.6 inches from the back edge of wall 126, and the forward-most discharge openings 108 of outlet cover 162 are about 7.3 inches from the front edge of wall 126. The arrangement shown creates desirable fluid rotation within the tank 102. Aspects of this invention will, however, work well if the discharge openings on opposed walls are in direct opposed relationship. Turbulence in the tanks is still significant, even though fluid rotation is less.

As shown in FIG. 24, the outlet covers 160 and 162 can be detached from the tank 102. Advantageously, this feature allows the interior of the outlet chambers 146 and 148 to be readily accessed, for example, for cleaning. Having detachable outlet covers also allows the outlet covers themselves to be more easily serviced, for example, to replace the outlet covers, clean out the outlets or discharge openings, and/or clean the outlet covers.

A wide range of systems and methods can be used to detachably connect the outlet covers 160 and 162 to the tank 102. In the illustrated embodiment, screws 174 are inserted through fastener holes 176 defined by the covers 160 and 162, and through fastener holes 178 defined by vertically extending supports members 180. The support members 180 are coupled to the tank 102, for example, by welding or other suitable attachment means. The particular type of fastening method, number of fasteners, and arrangement of the fastener holes can vary depending, for example, on the pressure at which the fluid will be discharged from the discharge openings 108 into the tank 102.

In various embodiments, each outlet cover 160 and 162 can have its perimeter sealed in a substantially fluid-tight manner. In addition, the fastener holes 178 can also be sealed in a substantially fluid-tight member. This sealing can help ensure that fluid is discharged into the tank 102 through the discharge openings 108 and that the fluid doesn't circumvent the discharge openings 108 by escaping through the fastener holes 178 and/or the interface between the outlet covers 160, 162 and the tank walls 124 and 126. By way of example, the interfaces between the tank walls 124, 126 and the respective outlet covers 160, 162 can be sealed by positioning a resilient sealing member generally around each outlet cover's perimeter between the outlet cover and the tank wall. And by way of further example, resilient O-rings can be used to seal the fastener holes 178. Alternatively, a wide range of other sealing members can be employed for sealing the outlet covers 160 and 162 and/or fastener holes 178.

In various embodiments, a plurality of detachable interchangeable outlet covers is provided. Each outlet cover (or each respective pair) can have outlets or discharge openings forming a different pattern (e.g., arranged differently, differently sized openings, differently shaped openings, etc.) from the other detachable covers. By selecting from amongst the interchangeable outlet covers, the operator can customize the kitchenware washing assembly with a particular pattern of outlets or discharge openings. For example, the operator may want to use a particular outlet pattern for heavy pots and pans, but use a different pattern for more delicate and fragile dishware. Or, for example, the operator may want to use a particular outlet pattern for one tank wall, but use a different pattern for another tank wall. Accordingly, the interchangeable outlet covers can even further increase the utility and efficiency of a kitchenware washing assembly.

In the illustrated embodiment, the outlet chambers 146, 148 and the intake chamber 134 are configured to provide drainage into the tank. With this positive drainage, fluid will drain out of the outlet chambers 146, 148 and intake chamber 134 such that little to no fluid will remain within these chambers 134, 146, 148. By eliminating (or at least reducing) the amount of standing fluid within the intake chamber 134 and outlet chambers 146, 148, the kitchenware washing assembly will be more sanitary.

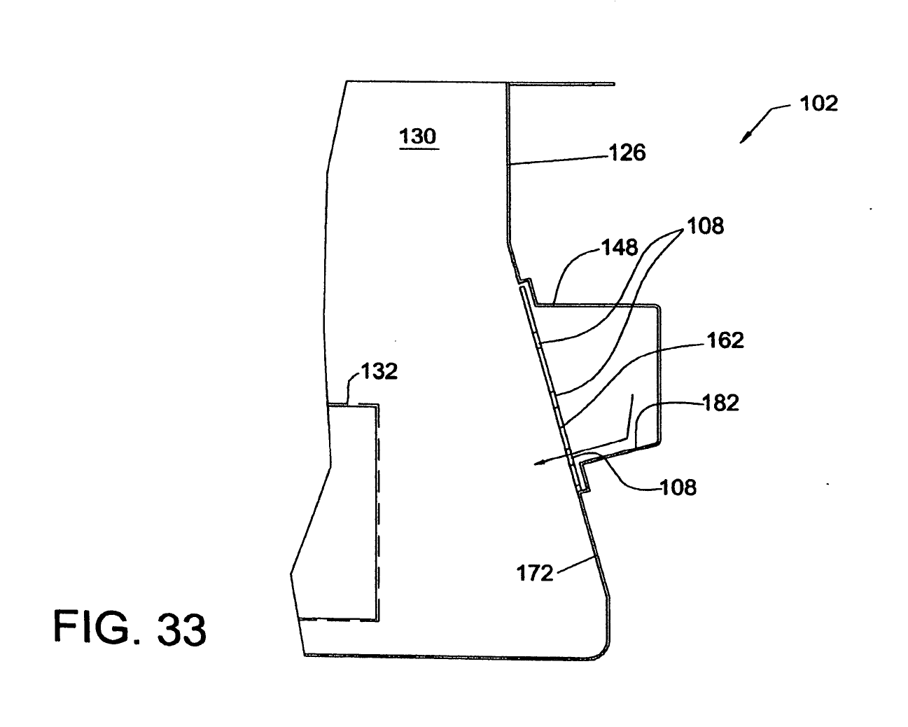

As shown in FIGS. 4 and 33, the outlet chambers 146 and 148 include a bottom 182 that generally slopes downwardly towards the tank 102, thereby providing positive drainage into the tank 102. Positive draining into the tank 102 is further facilitated by the positioning of the outlet chambers 146 and 148 on the respective angled wall portions 170 and 172.

The outlet covers 160 and 162 also include at least some discharge openings 108 adjacent the bottom 182 of the respective outlet chambers 146 and 148 when the outlet covers 160 and 162 are positioned to cover the outlet chambers 146 and 148, as shown in FIGS. 24 and 25. This also facilitates drainage from the outlet chambers 146 and 148 through those discharge openings 108 into the tank 102.

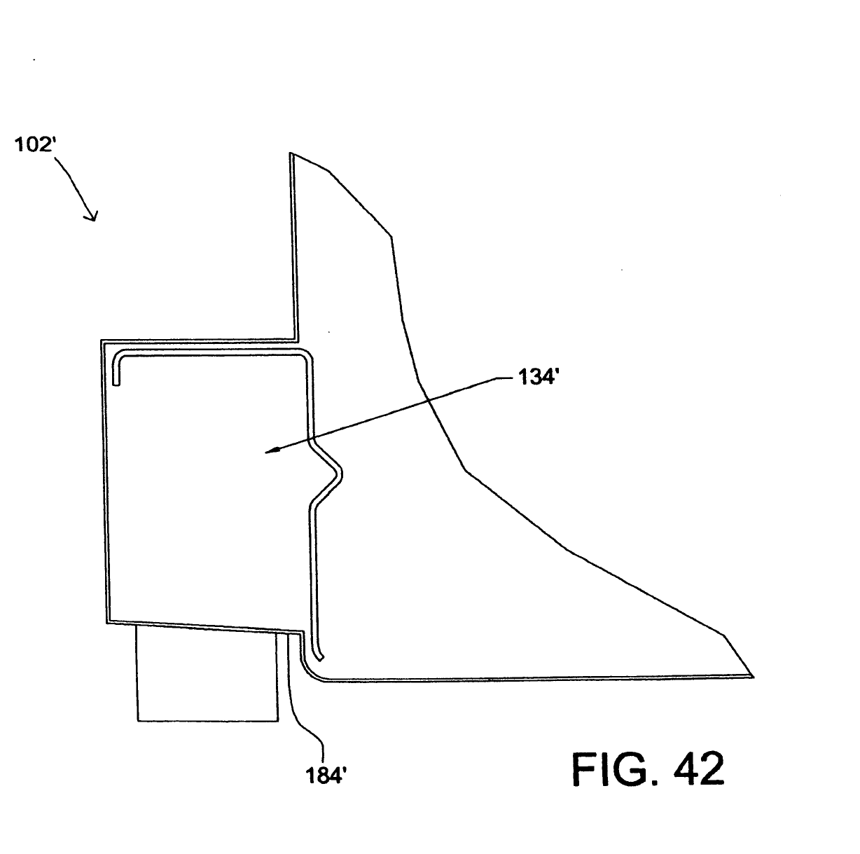

The intake chamber 134 can also have positive draining into the tank 102. For example, at least some of the inlet holes 152 in the intake cover 150 can be positioned adjacent the bottom 184 of the intake chamber 134 in order to facilitate drainage from the intake chamber 134 through those inlet holes 152 into the tank 102. See FIG. 18. Additionally, or alternatively, the intake chamber 134′ can also include a bottom 184′ that generally slopes downwardly toward the tank 102′ to provide positive drainage from the intake chamber 134′ into the tank 102′, as shown in FIG. 42. As yet another alternative, the intake chamber 134 can be positioned on a wall portion that is angled downwardly.

As shown in FIGS. 14C, 15A and 15B, the washer assembly 100 includes an overflow 190 formed as an elongated cutaway portion between edges 192 and 193 in sidewall 124 adjacent its top edge. When fluid in the tank 102 reaches the overflow 190, fluid spills over into the scraping station 114 (FIGS. 15A and 15B) and down the scraping station's drain. Further, grease and floating debris also spill over the overflow 190 and are disposed of in the scraping station 114. The scraping station 114 is equipped to dispose of grease and debris. Thus, the overflow 190 can serve two purposes: ensuring that the tank 102 does not overfill and spill onto the surrounding floor, and allowing grease or floating debris to be removed from the tank 102. The overflow 190 could also be formed by cutting a narrow, elongated opening in sidewall 124.

The tank 102 can be formed using a wide range of manufacturing processes. In various embodiments, the tank 102 includes an at least partially unitary construction. This can provide considerable reduction in manufacturing costs as compared to existing tank designs in which the tank walls are all formed from pieces that are welded together to form the tank. Forming two or more of the tank components unitary or monolithically with one another can reduce the overall amount of welding labor, and costs associated with manufacturing a tank.

The manufacturing process according to one particular embodiment will now be described in detail. As shown in the figures, the intake chamber 134 is on the back wall 130, and outlet chambers 146 and 148 are on the respective sidewalls 124 and 126. A substantial portion of each chamber 134, 146, and 148 is formed unitary or monolithically with the corresponding wall 130, 124, and 126 on which it is disposed.

As shown in FIGS. 14A and 14B, the tank's front and back walls 128 and 130 and bottom 120 are unitarily formed with one another. The tank's sidewalls 124 and 126, however, are separate components that are attached (e.g., welded, etc.) to the front and back walls 128 and 130 and bottom 120.

In addition, the intake chamber 134 includes a longitudinal wall 200 (FIG. 14B) that is formed unitary with the back wall 130. The outlet chamber 146 includes a longitudinal wall 202 (FIG. 14C) that is formed unitary with the sidewall 124. The other outlet chamber 148 includes a longitudinal wall 204 (FIG. 14D) that is formed unitary with the sidewall 126. Each longitudinal wall 200, 202, 204 forms at least portions of a top, back and bottom of the corresponding chamber 134, 146, 148 such that each chamber is generally box-shaped with an open side into the tank 102. Alternatively, other chamber walls besides longitudinally extending chamber walls and/or chamber walls having other geometries besides box-shaped (e.g., rounded, triangular, etc.) can also or instead be unitarily formed with a tank wall or bottom.

Each chamber 134, 146, 148 includes end walls 206, 208, 210, respectively, that are separately attached to the tank 102 and the longitudinal chamber walls 200, 202, 204. In one particular embodiment, the chamber end walls 206, 208, 210 are welded to the tank 102 and to the longitudinal chamber walls 200, 202, 204. Alternatively, other suitable methods can be used for attaching the chamber end walls.

In one particular manufacturing process, the tank 102 is formed as follows. A first sheet of stainless steel is cut and bent to form the front wall 128, bottom 120, back wall 130, and longitudinal chamber wall 200. A second sheet of stainless steel is cut and bent to form the sidewall 124 and longitudinal chamber wall 202. A third sheet of stainless steel is cut and bent to form the sidewall 126 and longitudinal chamber wall 204. The edges of the sidewalls 124 and 126 are welded to the edges of the front wall 128, back wall 130 and bottom 120. Rather than using three separate sheets of stainless steel material to form the tank 102, alternative embodiments can include using a single sheet of stainless steel material which is cut to form the three sheets of stainless steel.

The chamber end walls 206, 208, 210 are welded to the tank 102 and the corresponding chamber wall 200, 202, 204. As shown in FIG. 14A through 14E, the stainless steel portions that ultimately form the chamber end walls 206, 208, 210 also form a portion of the corresponding tank wall 130, 124 and 126. The chamber end walls 206, 208, 210 can be formed (e.g., laser cut, etc.) from the same sheet of stainless steel that is used to form the respective longitudinal chamber wall 200, 202, 206. Alternatively, the chamber end walls can each be formed from one or more separate sheets of stainless steel.

In alternative embodiments, the tank's sidewalls, front wall, and back wall are all formed unitary with one another and with the tank's bottom. These alternative embodiments can also include an intake chamber and/or an outlet chamber formed unitary with one or more of the tank walls, e.g., front, back, or sidewalls. A particular one of these alternative embodiments includes an intake having at least one wall formed unitary with the back wall, and two outlet chambers each having at least one wall formed unitary with one of the sidewalls. In this alternative embodiment, each chamber includes end walls that are separately attached (e.g., welded, etc.) to the tank and to the unitarily formed chamber walls. This tank can thus be formed as follows according to this alternative embodiment. A sheet of stainless steel is cut and bent to form the front wall, back wall, two sidewalls, bottom, and longitudinal chamber walls. The junctions between adjoining tank walls are welded to form the enclosure wall. The chamber end walls are welded to the tank and the corresponding unitarily formed chamber wall. The portions forming the chamber end walls can also form a portion of the corresponding tank wall to which it is attached. The chamber end walls can be formed (e.g., laser cut, etc.) from the same sheet of stainless steel that is used to monolithically form the tank bottom and tank walls. Alternatively, the chamber end walls can be formed from one or more separate sheets of stainless steel.

In yet another embodiment, the tank sidewalls can be unitarily formed with one another and with the tank bottom. The tank's front and back walls can be separate components that are attached (e.g., welded, etc.) to the sidewalls and the bottom. In this alternative embodiment, an intake chamber and/or an outlet chamber can be formed unitary with one of the tank walls, e.g., front, back, or sidewalls.

In each of the embodiments mentioned above, any of the chamber end walls could be formed unitary with their respective tank wall. Additionally, or alternatively, any of the chamber end walls can be formed unitary with their respective longitudinal chamber wall.

A further aspect of the invention includes a control system having a consolidated removable control module. The consolidated removable control module includes a plurality of electronic components (e.g., a circuit breaker or fuse, a motor starter, a relay, a printed circuit board electronic circuitry, etc.) for substantially controlling one or more operations of a kitchenware washing assembly. In various embodiments, the removable control module is a pluggable module that can be removed as a unit such that, in the event of a failure of one or more of the electronic components, the removable control module can simply be removed and replaced in its entirety by a layperson. Advantageously, this can allow for the elimination of costly service calls by a technician, for example, to perform diagnostics in the field to determine which individual component failed, and downtime of the machine while waiting for that service to be performed.

The control system includes electronics or similar control components for controlling one or more operations of the washing assembly. The control system can include a controller having a microprocessor, a real-time clock, a memory or other form of computer readable medium, and computer executable instructions including one or more wash cycle schemes. The computer executable instructions can be predefined or programmable by an operator. For example, the control system can include a programmable EPROM chip that provides for custom computer executable instructions to be applied to control the various components of the washing assembly, including a pump, and/or heater. Such a control system can provide for controlling a washing assembly operation such as providing power to one or more fluid pumps for extracting and injecting washing fluid from the tank. This can include controlling a variable speed motor associated with a pump for providing various cleaning fluid flow rates into and out of the tank.

The control system can also include a user interface device such as a keypad, buttons, or dial. A display can also be included for displaying programmed cycle information and other information pertinent to the use and operation of the control system and/or the washing assembly. Additionally, a data communication interface can provide for data connectivity to other systems, a remote control, and/or administration system. The user interface device or data communication interface can be utilized to provide or change a computer executable instruction of the control system.

The control system can also provide power and/or control to one or more heaters, an automatic cleaner dispenser system, and/or a water supply or drain solenoid, by way of additional examples. The control system can also receive one or more signals from sensors or other components located about the kitchenware washing assembly or from an external source. For example, a temperature signal that is indicative of a temperature of the washing fluid can be provided from a temperature sensor (e.g., thermocouple, etc.). Additionally, a fluid level sensor can provide a signal to the control system that is indicative of a fluid level within the tank. Or, for example, the control system can receive a single from a sensor indicative of the concentration of cleaning solution in the fluid within the tank. In response, the control system may control an automatic cleaner dispenser system (e.g., solenoid, etc.) to dispense the cleaning solution, such as soap in definable and measurable amounts into the tank as a function of the detected concentration of cleaning solution in the tank and/or as a function of time, temperature, and/or cycle.

The control system can control an operation of the washing assembly as a function of the temperature signal or other received signals, the computer executable instructions, user input, and/or data input. In addition, the control system can generate outputs including an alarm output associated with the operation of the washing assembly and/or the status of a component thereof. The above control system components are set forth by way of example and are not intended to be limiting.

In operation, the control system can control the dispensing of washing fluid into the tank and the heater to heat the washing fluid in the tank to a specified temperature. For example, the control system can control the operation of the heater to activate the heater to heat the washing fluid and to deactivate the heater to allow the washing fluid to cool. The control system can also control operation of the pump(s), such as by altering the frequency of the pump(s), speeding up or slowing down the pump(s), causing the pump(s) to pulsate, etc.

The microprocessor can be programmed to provide a wash cycle program that provides cycles for predetermined time periods and the pump speed (e.g., washing fluid flow rate and/or resulting tank turbulence) and/or heat can be varied to provide predetermined cleaning cycles. The control system can provide for the removal of the washing fluid at the end of a cycle and for generating an alarm, an indicator.

The control system can also monitor and store operational data, profiles, and administrative features for the kitchenware washing assembly. The control system can generate operational reports. Various data can be monitored, stored, and/or reported, such as how many wash cycles and of what type, water temperature, soap and chemical levels and time (e.g., soap injection time, soap ounces per minute, total soap used, etc.), number of water changes, how many times the water has been drained and refilled, how many gallons of water were used for all water changes, heater core temperature, pump operational data, and/or when was last water change, etc. Advantageously, this data acquisition, storage and reporting can allow the operation of the kitchenware washing assembly to be tailored for specific cleaning needs of a particular user's application and/or particular industry. For example, the operation of the kitchenware washing assembly can be controlled in accordance with definable cycles which specify operational events including timing, duration, temperatures, pump speeds, soap or chemical concentration levels, cleaning solution changes, etc. By way of example, a user interface may be provided that allows the user to specify the control or operational parameters for one or more wash cycles or schemes to thereby customize or tailor the operation of the kitchenware washing assembly for specific cleaning needs. For example, the user interface may allow the user to specify the timing, duration, water temperature, temperature ranges, maximum water temperature, cleaning solution or soap concentration levels, pump operational parameters (e.g., speeds, frequencies, pulsations, etc.), cleaning solution changes, fills and drains, event logging, data reporting, maintenance reporting, alarming, etc.

In addition, data and operational parameters can be stored along with a serial number or other identifying data for a kitchenware washing assembly. This data can then be reported, for example, like a snapshot of performance to a technician to thereby allow for improved service calls and improved servicing of the kitchenware washing assembly. This stored data may also be used by the controller, for example, to conduct self-diagnostics. As another example, this data reporting and report generation can include generating reports for health departments, or others. In various embodiments, controller or microprocessor is configured to store events monitored and controlled by the microprocessor and to communicate to provide stored operating data over a communication interface at a predetermined period of time, on a demand basis, and/or in response to a request from a remote unit. Exemplary operating data that can be stored and/or communicated include includes system sensors, system cycles, system usage time, timing of events such as beginning and ending of cycles, water additions, cleaning solution drainage, cleaning solution changes, water changes, water usage, temperatures, pump speeds, cleaning solution measurements, release of cleaning solutions or detergents, cleaning solution concentration levels, alarm conditions, maintenance requirements, sanitizing times, dry fire periods, etc.

Various embodiments can also include enhanced data acquisition and reporting, such as determination of operating costs including calculating amount of water and soap used and cost for the soap used and/or determination of maintenance requirements as a function of an operating characteristic (e.g., operating time or usage, etc.). For example, it may be determined that maintenance on a pump is required or recommended after five hundred hours of pump operation, refill cleaning solution, etc.

The control system can be enclosed within a housing and have one or more control modules that are removable from the housing for replacement and maintenance. The housing and each control component can be configured to enable the control component to be plugged into and unplugged from the housing without requiring wiring or other similar technical and/or skilled operations on the part of the user or operator. For example, the housing can be configured to have one or more slots configured to receive one or more control components (e.g., plugs and receptacles, etc.). Each slot can include a connector for electrically coupling the control component to other components of the washing assembly such as a pump, heater, sensor, solenoid, user interface, or data communication port or interface. By being pluggable, the individual control component can be removed from the housing slot for maintenance or replacement by an operator without requiring wire management or other technical skills.

In various embodiments, the control system can be consolidated with each control module having two or more electronic components configured to substantially control one or more washing assembly operations. For example, each control module can include, but is not limited to, electronic components such as a circuit breaker or fuse, a motor starter, a relay, a transformer, a printed circuit board electronic circuitry, a processor, or a memory. In addition, the consolidated control system can be a pluggable module that can be removed as a unit. In such embodiments, if a component of the control system fails, the entire control module can be readily and quickly removed from the housing and replaced with another complete control module. This eliminates costly downtime and the need for diagnosis in the field to determine which individual component failed. The original control module can be diagnosed and repaired when convenient and returned to service when needed. In addition, this control module replacement can be performed by an unskilled operator without requiring the assistance of a skilled or semi-skilled service or repair technician.

A housing can be provided for containing the consolidated and removable control module. The housing can be located above a back portion of the tank. But the housing can be located in any position about the kitchenware washing assembly. In this manner, an operator can have easy access to the control system for operation and maintenance. Also, the control system can be positioned such that it is less susceptible to washing fluid spills. In some embodiments, the housing is positioned to be at a level between the operator's waist and eye to provide convenient operator access. In one embodiment, the lower portion or bottom of the housing can be positioned greater than about forty inches above the floor on which the washing assembly and/or the operator are standing.

The housing can include a cover for enclosing and protecting the electronic components. In some embodiments, the cover can be attached to the housing by one or more fasteners, such as a screw, and/or the cover can be attached with one or more hinges or hinge-type devices. Additionally, in some embodiments, a seal can be placed between the cover and the housing to provide a substantially water tight seal and access for the enclosed electronic components. The cover and/or the seal can be of any design, type, arrangement, or combination for enclosing and protecting the control system electronic components.

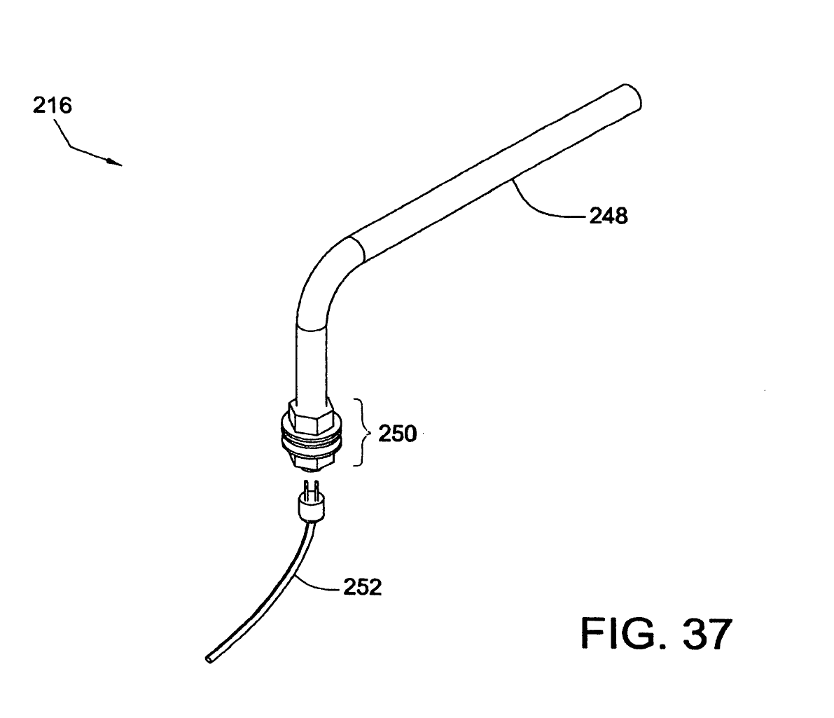

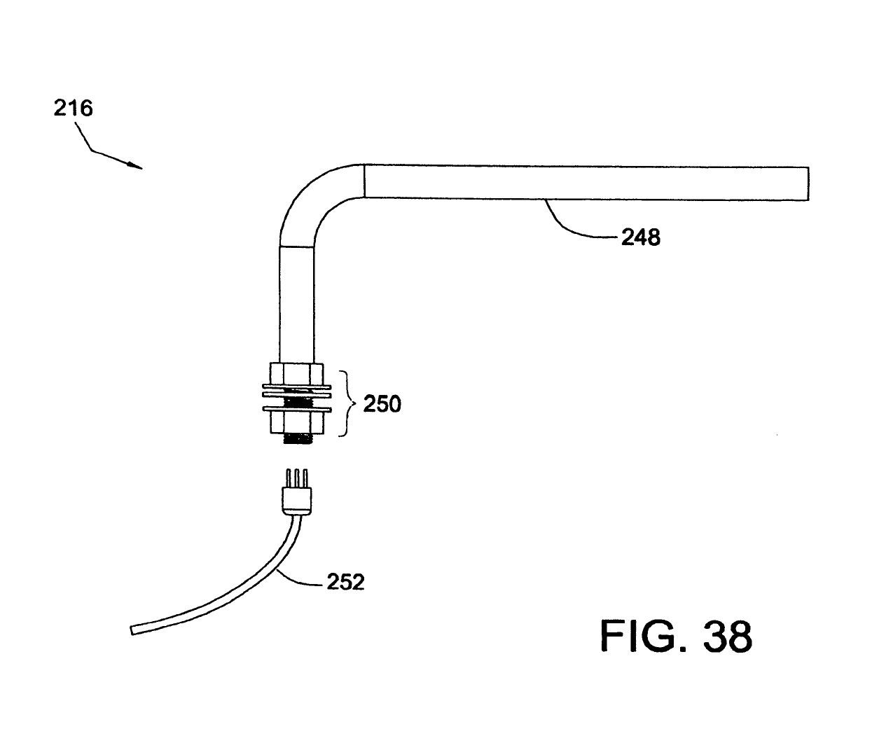

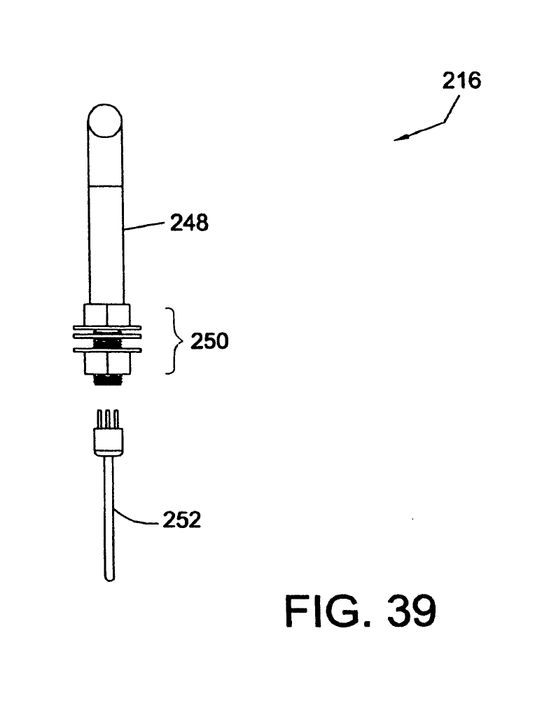

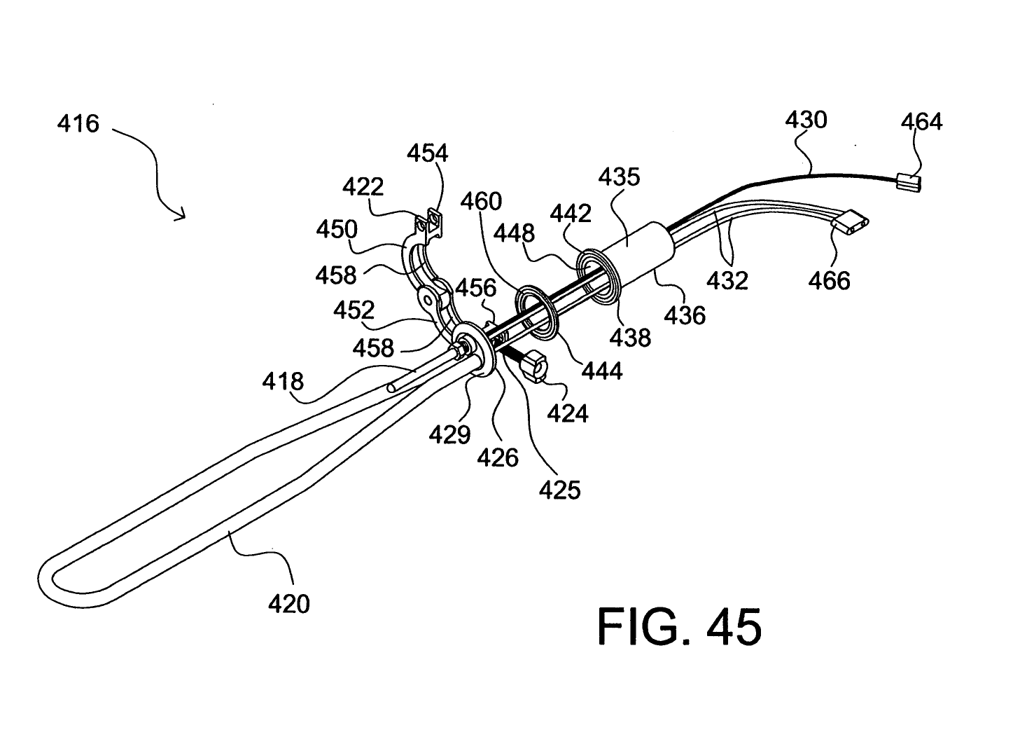

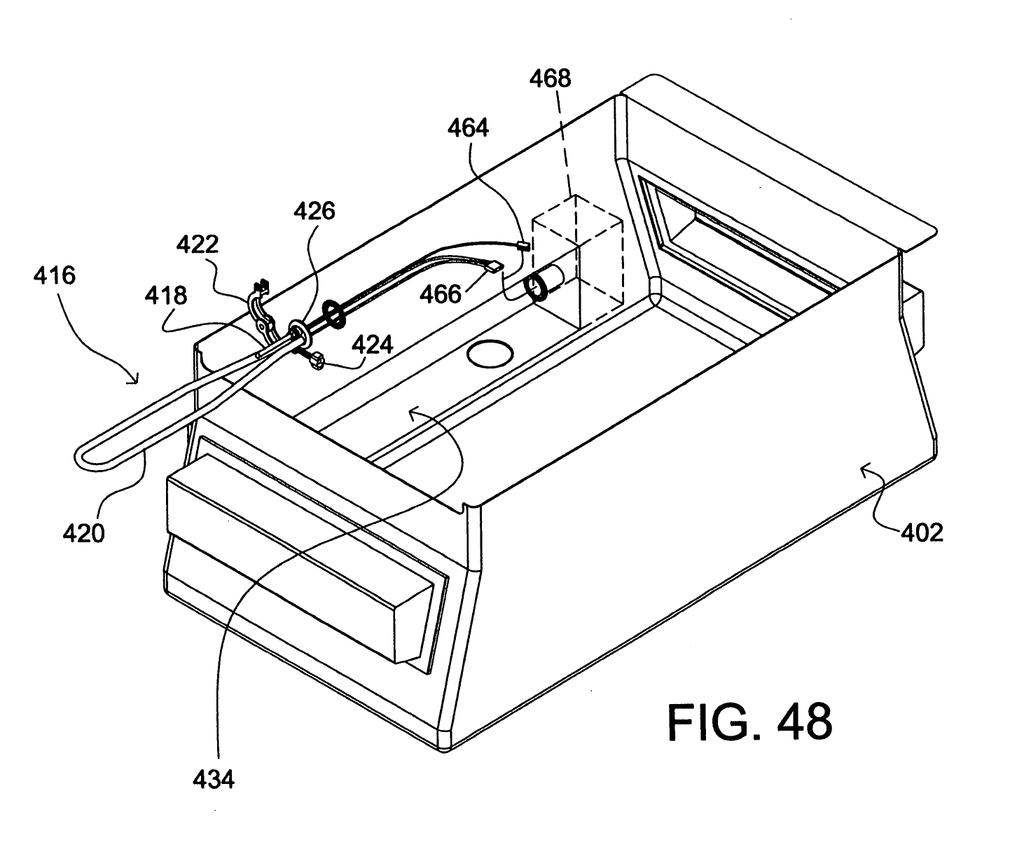

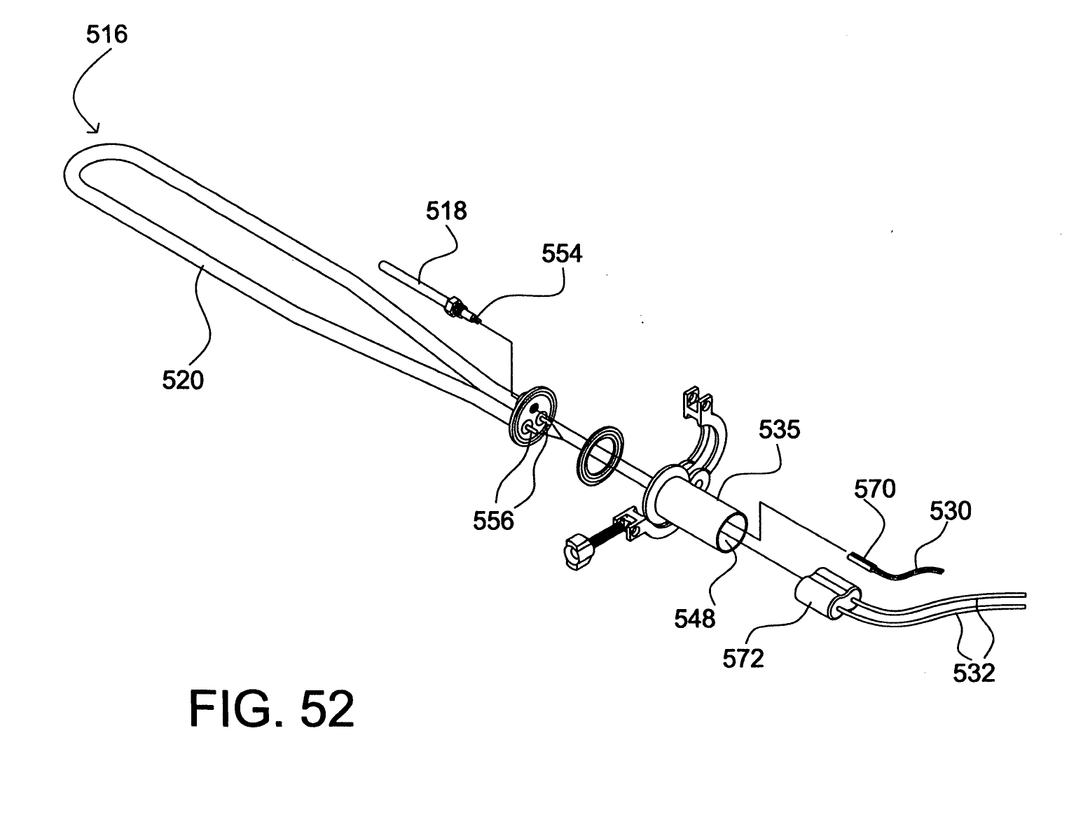

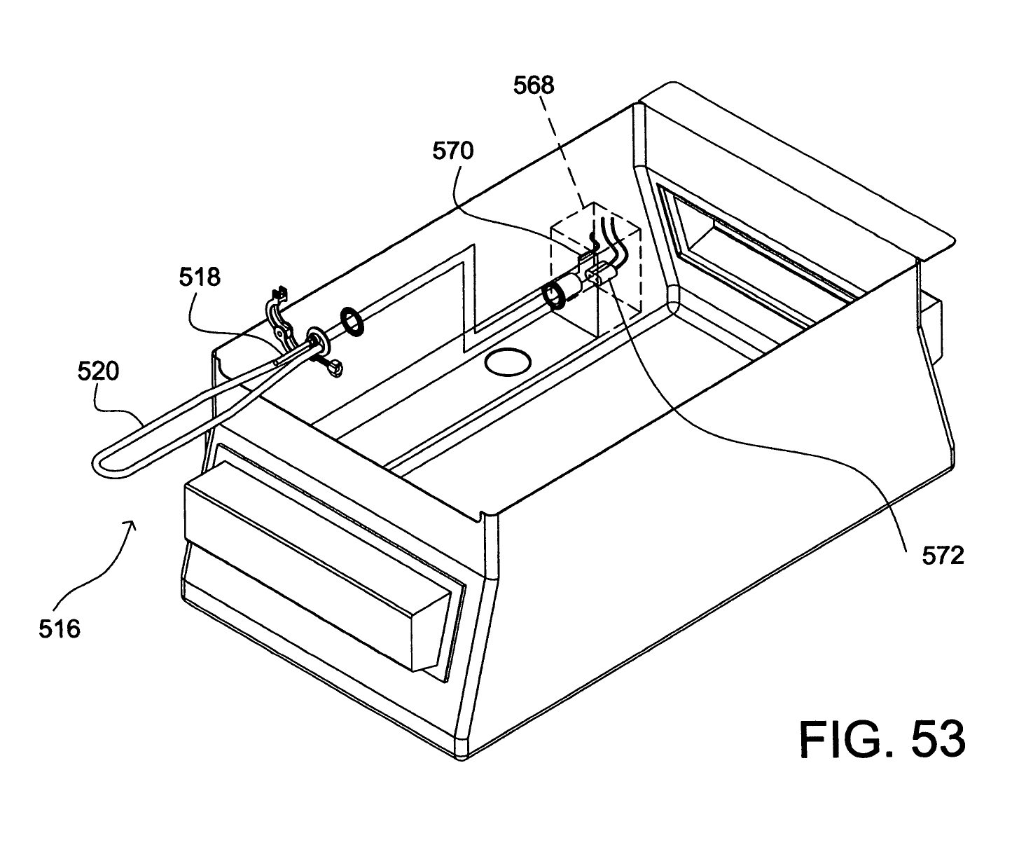

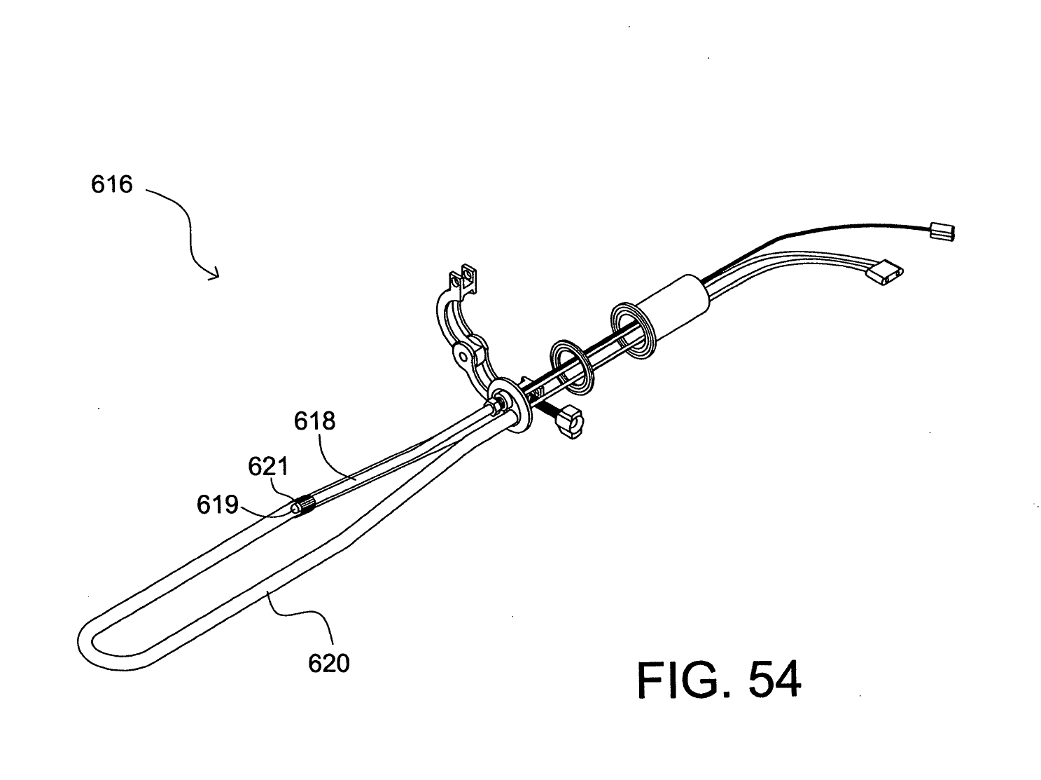

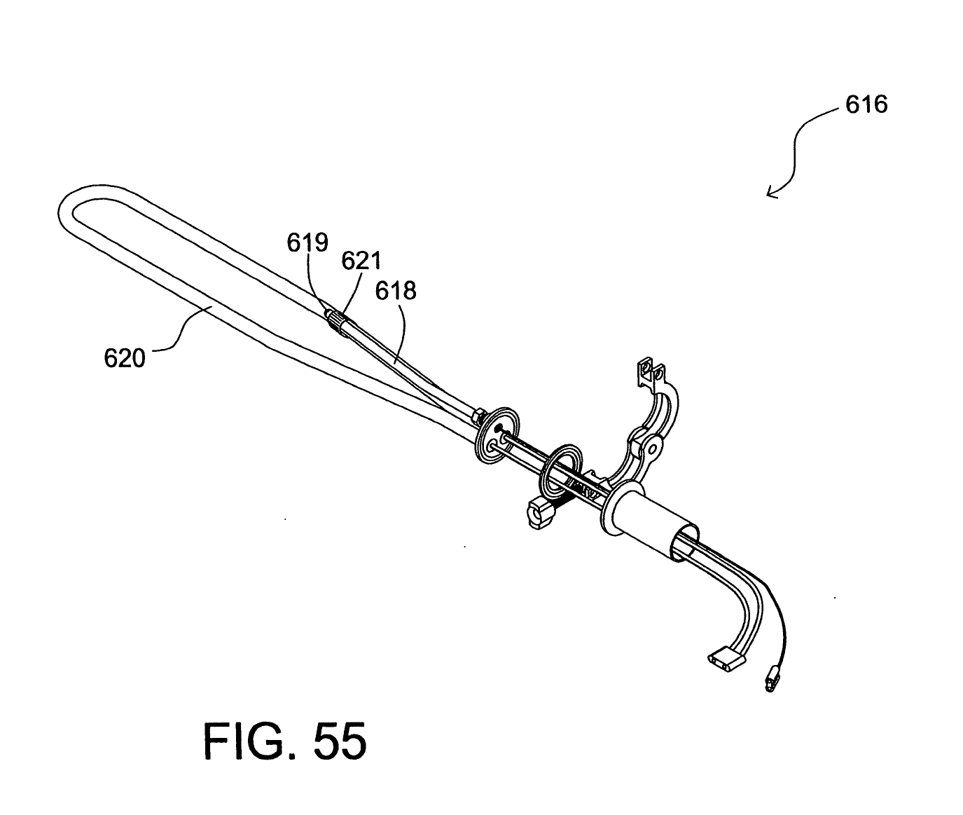

Referring now to FIGS. 34 through 36, there is shown an exemplary implementation of a control system 212 that can be used for controlling one or more operations of the kitchenware washing assembly 100. As shown, the control system 212 includes a solid state controller 214 (e.g., microprocessor). The controller 214 is coupled to a heater (e.g., heater 216 shown in FIGS. 37 through 40, heater 416 shown in FIGS. 45 through 51, heater 516 shown in FIGS. 52 through 53, heater 616 shown in FIGS. 54 and 55) through a solid-state relay 218. In addition to the heater solid-state relay 218, the control system 212 also includes a breaker 219 and a receptacle and plug 221 for the heater (e.g., 216, 416, 516, 616, etc.).

The control system 212 also includes one or more receptacles and plugs for one or more thermocouples. As shown, the control system 212 includes a receptacle and plug 223 for a thermocouple (or other suitable sensor) in the tank for determining the temperature of the water. The control system 212 also includes a receptacle and plug 225 for a heater thermocouple or other type of temperature sensor. By way of example only, a thermocouple may be built into or embedded within the heater 216 (FIGS. 37 through 40) for determining the temperature of the heater. Or, for example, a thermocouple 418, 518 may be spaced apart from and external to the heating element 420, 520 as shown in FIGS. 45 through 51 and FIGS. 52 and 53. In yet another embodiment shown in FIGS. 54 and 55, a thermocouple 618 may be relatively flexible such that the thermocouple 618 may be flexed or bent to allow its end portion 619 to be positioned relatively close to the heating element 620.

With continued reference to FIGS. 34 through 36, the controller 214 is coupled to the pumps 104 and 106, for example, for providing power to the pumps 104 and 106 and/or controlling variable speed motors associated with the pumps 104 and 106 for providing various cleaning fluid flow rates into and out of the tank 102. Regarding the motors, the control system 212 includes motor contractor and overloads 220 and 222, and motor receptacles and plugs 224 and 226.

The control system 212 also includes a main breaker 228 and a plug and receptacle 230 for the main power. The control system 212 further includes a ground block 232.

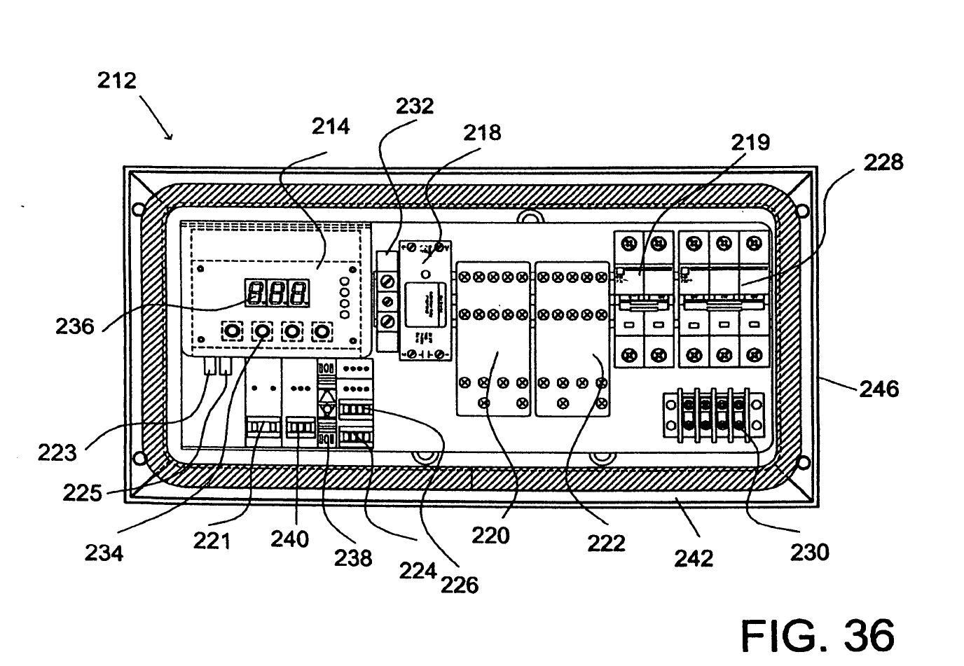

The control system 212, or more specifically, the controller 214 in the illustrated embodiment includes a control panel 234 (FIG. 36) that includes controls, such as a keypad, buttons, and/or dials, for activating the pump speeds, wash cycles, heater(s), and cleaner dispenser(s). The controller 214 also includes a display 236 (e.g., digital readout screen) for displaying programmed information and other information pertinent to the use and operation of the control system 212 and controller 214. For example, the digital readout screen may display the type of washing scheme, cycle, operating parameters, and/or titles customized by the user via a user interface.

The control system 212 can also provide power and/or control to an automatic cleaner dispenser system. In this regard, the illustrated control system 212 includes a fuse block 238 and receptacle and plug 240 for a soap pump.

In the illustrated embodiment, the control system 212 is enclosed within a housing 242. In various embodiments, the entire control system 212 is a pluggable module that can be removed as a unit. In such embodiments, if a component of the control system fails, the entire control module can be readily and quickly removed from the housing 242 and replaced with another complete control module. This eliminates costly downtime and the need for diagnosis in the field to determine which individual component failed. The original control module can be diagnosed and repaired when convenient and returned to service when needed. In addition, the control module replacement can be performed by an unskilled operator without requiring the assistance of a skilled or semi-skilled service or repair technician. Additionally, or alternatively, each control appendage (e.g. pump motor(s), soap pump(s), thermocouple(s), heater(s), etc.) can be readily and quickly unplugged from the control system for individual replacement when required.

In various embodiments, the individual electronic components of the control system 212 can also be individually removed from the housing 242, thus also allowing for relatively easy replacement and maintenance. For example, the housing 242, microprocessor 214, solid-state heater relay 218, heater breaker 219, heater receptacle and plug 221, thermocouple receptacles and plugs 223 and 225, motor contractor and overloads 220 and 222, motor receptacles and plugs 224 and 226, main breaker 228, main power plug and receptacle 230, ground block 232, soap pump fuse block 238, and soap pump receptacle and plug 240 can be configured such that each of these various components can be individually plugged into and unplugged from the control module without requiring wiring or other similar technical and/or skilled operations on the part of the user or operator.

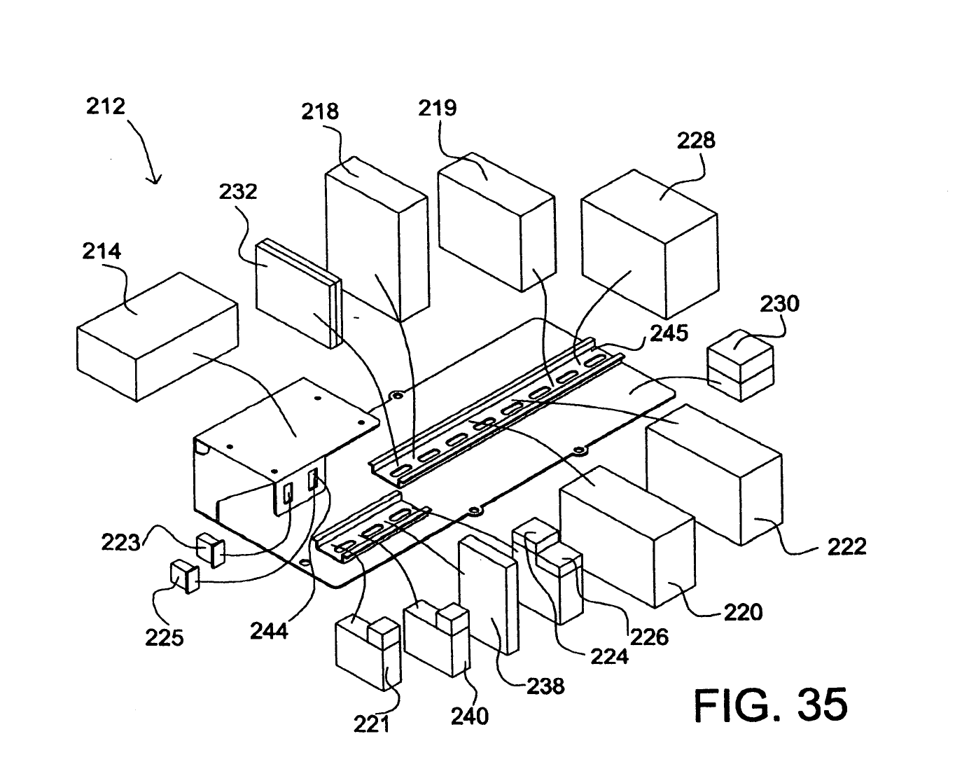

As shown in FIG. 35, the housing 242 includes slots 244 configured to receive components, such as the receptacles and plugs 223 and 225. Each slot 244 can include a connector for electrically coupling the component to other components of the washing assembly 100 such as one or more thermocouples 418, 518, pumps 104 and 106, heater 216, 416, 516, 616, soap pumps, sensors, solenoids, user interfaces, data communication ports or interfaces, etc. The housing 242 also includes DIN rails 245 formed on or mounted to the housing 242 using screws, other suitable mechanical fasteners, among other methods. The solid-state heater relay 218, heater breaker 219, heater receptacle and plug 221, motor contractor and overloads 220 and 222, motor receptacles and plugs 224 and 226, main breaker 228, main power plug and receptacle 230, ground block 232, soap pump fuse block 238, and soap pump receptacle and plug 240 are configured to be detachably mounted to the DIN rails 245. Accordingly, each individual component can be relatively easily removed from its corresponding slot 244 or from the corresponding DIN rail 245 for maintenance or replacement by an operator without requiring wire management or other technical skills.

In the exemplary embodiment shown in FIG. 36, the housing 242 includes a removable cover 246 for enclosing and protecting the components within the housing 242. In some embodiments, the removable cover 246 is a laminated covered or transparent membrane that help protects the control system 212 from fluid spills from the tank 102.

Various embodiments include a heater (e.g., electric heater element, heater 216, 416, 516, 616, etc.) coupled to or at least partially housed within the intake chamber 134. For example, the heating element can be attached to the bottom 184 of the intake chamber 134, or may be mounted in any other suitable location. A thermocouple (or other suitable sensor) located a suitable distance away from the heater can be used for determining the temperature of the water. This thermocouple can be interfaced to a microprocessor that controls operation of the heater such that the heater maintains a specified fluid temperature in the tank. For example, in one particular embodiment, Proportional-Integral-Derivative (PID) control methodology is used during normal operation to control the temperature of the fluid in the tank. With this exemplary PID control, fluid temperature is monitored as the process variable for deviation from a desired value or set point in a continuous feedback loop. Corrective action (e.g., shutting down the heater, increasing the amount of heat produced by the heater, etc.) is taken whenever the monitored temperature sufficiently deviates from the set point. In this exemplary manner, PID control can be efficiently used to monitor the fluid temperature in the tank based on the current values and rates of change of the monitored variables.

Another thermocouple (or other suitable sensor) can be associated with (e.g., embedded, located in, or otherwise coupled to) the heater element. This second thermocouple can be used for fluid low level detection, and thus help determine whether a desired fluid level is in the tank. If this second thermocouple senses that the heater has an abrupt temperature increase (e.g., more than a predetermined temperature increase over a predetermined time interval), that detected condition is indicative of a low fluid level in which the fluid level has dropped too low to cover the heater element and absorb the heat produced thereby. To help prevent damage to the heater by operating during low fluid level conditions, the second thermocouple is interfaced to a microprocessor that deactivates the heater and the pumps to ensure that the heating element and pumps do not overheat.

In the illustrated embodiments, the microprocessor 214 (FIGS. 34 through 36) is coupled to the heater 216 (FIGS. 37 through 40), 416 (FIGS. 45 through 51) 516 (FIGS. 52 and 53), 616 (FIGS. 54 and 55). The control system 212 includes controls that control the microprocessor 214 to cause the heater 216, 416, 516, 616 to heat the fluid in the tank 102 to a specified temperature. The microprocessor 214 is coupled to the heater 216, 416, 516, 616 through the solid-state relay 218. The microprocessor 214 can be programmed to provide a wash cycle program that provides wash cycles for predetermined time periods and the pump speed (e.g., tank turbulence) and/or heat can be varied to provide predetermined cleaning cycles. Thus, the tank 102 may operate at a mild presoak turbulence level at a higher (uncomfortable to the touch) heat to loosen caked-on food from the dishware, followed by a more turbulent flow in the tank to break away loosened food debris, followed by a final cycle at reduced temperature during which employees can finish the cleaning process.

As one example program, the following operations can be performed by the controller 214 and sensors (e.g., thermocouples, etc.) upon activation of the program: determine whether the fluid temperature is at one hundred ten degrees Fahrenheit; if it is not, cause the heater to heat the fluid to one hundred ten degrees Fahrenheit; when the fluid temperature is at one hundred ten degrees, initiate a three minute presoak cycle during which time the pumps operate at between about thirty to thirty-five hertz; proceed to a three minute intermediate cycle during which time cycle the pumps are increased to forty to forty-five hertz, thus increasing tank turbulence and cleaner agitation; proceed to a heavy duty clean cycle during which time cycle the pumps are increased to fifty to sixty hertz for eight minutes; proceed to an idle mode at about thirty hertz which prevents grease suspended in the cleaning fluid from settling back onto the kitchenware and allows removal of the kitchenware from the tank 102. It is also contemplated that overnight cycles can also be provided that allow the tank temperature to be increased to much higher temperatures of around one hundred fifty degrees Fahrenheit or higher to further facilitate cleaning. Because such temperatures are too hot for the human touch, the most difficult-to-clean kitchenware could be cleaned overnight for extended periods of time while personnel are not around and thus are not exposed to the tank of hot water. The next morning, the control system can deactivate the heater to allow the tank temperature to cool down to about one hundred fifteen degrees and let the heat dissipate, thus allowing the personnel to retrieve the cleaned kitchenware from the cooled tank fluid with their bare hands.

It is also contemplated that a cover could be provided to prevent personnel from putting their hands in the water and/or alarms can be activated to warn of the hot water temperature. In one particular embodiment, the cover may be configured for rolling across the work surface of the kitchenware washing assembly. There may also be a switch associated with this cover indicating position of the cover and one or more operations may be controlled as a function of the switch cover position.

In various embodiments, the microprocessor 214 provides preprogrammed wash cycle programs, but is also adapted to allow the user to create programs to cater to specific cleaning needs.

As noted herein, various embodiments include the control system 212 controlling operation of the kitchenware washing assembly in a manner such that kitchenware washing assembly includes a plurality of distinct wash cycles or schemes. In one particular embodiment, the control system has the capability of operating the kitchenware washing assembly in five different wash cycle types (e.g., light, medium, normal, heavy, overnight, etc.) of varying degrees of aggressiveness based on water temperature, chemical solution concentration and/or pump speed. In such embodiments, the control system may include automatic time compensation in which the control system automatically adjusts timing and aggressiveness of one or more operations within a cycle as a function of the previously defined cycle and/or user-defined cycle as will now be described. One exemplary operational sequence may be a light type of wash cycle in which the pump(s) operate at about thirty hertz for about ten minutes with about four ounces of soap in the tank. Another wash cycle may be a medium type of wash scheme. In this case, the control system 212 can inject or dispense the delta difference of soap of cleaning solution in order to transition from the light wash cycle to the medium cycle to make the wash cycle more aggressive. The control system 212 can also change the operation of the pump(s) for the medium type washing cycle, such as by increasing the pumps to about thirty-five or forty hertz thus making the pumps more aggressive. There may be further higher level or more aggressive cleaning cycles for which the control system may dispense the delta difference of soap or chemical solution, increases the pump(s) operating frequency, and/or control the heater(s) in order to transition to these more aggressive cleaning cycles.

Another exemplary wash cycle may include a wash cycle in which the washing fluid temperature is definable by a user to temperatures up to and including two hundred twelve degrees Fahrenheit and/or the boiling point of the cleaning fluid. Other exemplary wash cycles include heating the fluid in the tank to a range of about one hundred sixty to about one hundred seventy degrees Fahrenheit for a first type of washing cycle, heating the fluid in the tank to greater than about one hundred seventy degrees Fahrenheit but less than about two hundred twelve degrees Fahrenheit for a second type of washing cycle, and heating the fluid in the tank to about two hundred twelve degrees Fahrenheit or higher for a third type of washing cycle.

FIGS. 37 through 40 illustrate an exemplary heater 216 according to one exemplary embodiment of the invention. As shown, the heater 216 includes a housing 248 and a threaded coupling 250. The housing 248 is shown in a generally L-shaped configuration and is formed from stainless steel. Alternatively, other shapes and materials can be used for the housing 248.

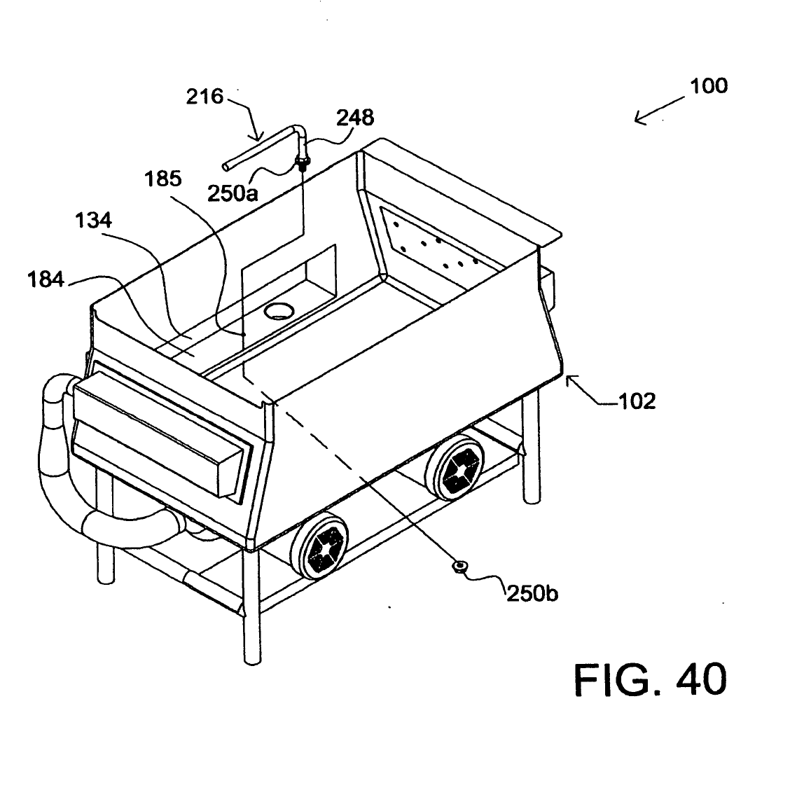

As shown in FIG. 40, the threaded coupling 250 can be used to couple the heater 216 to the bottom 184 of the intake chamber 134, with the housing 248 positioned within the intake chamber 134. In this particular illustrated embodiment, a threaded portion 250a of the coupling 250 is inserted at least partially through a hole 185 in the bottom 184 of the intake chamber 134. A nut 250b is then threaded onto the threaded portion 250a to thereby attach the heater 216 to the tank 102. Alternatively, the heater 216 can be coupled to the tank 102 using other suitable means and/or positioned at other suitable tank locations, such as through a wall of the tank 102 and/or through the opening at the top of the tank. In addition, the electrical power for the heater 216 is provided by way of an electrical cord 252. Accordingly, the heater 216 can be relatively easily removed from the tank 102 by unplugging the electrical cord 252, removing the intake cover 150, and unscrewing the nut 250B. Therefore, the heater 216 in this particular embodiment can be relatively easily removed and replaced by another heater 216, thereby eliminating the need to wait and pay for a costly service call by a technician.

In one particular embodiment, the heater 216 includes a cartridge heater having a heating element within the housing 248. A thermocouple is also within the housing 248, although other types of temperature sensors (e.g., transducers, thermistors, etc.) can also be used. The thermocouple (or other temperature sensor) can be built into or embedded within the heater 216, or the thermocouple can be spaced apart from the heater and/or external to the heater housing 248.

FIGS. 45 through 51 illustrate another exemplary heater 416 according to one embodiment of the invention. As shown, the heater 416 includes a thermocouple 418 and a heating element 420. The heating element 420 is spaced apart from the thermocouple 418. Alternatively, other types of temperature sensors (e.g., transducers, thermistors, etc.) can be employed besides thermocouples. In addition, the thermocouple 418 can also be embedded within or integral with the heating element 420.

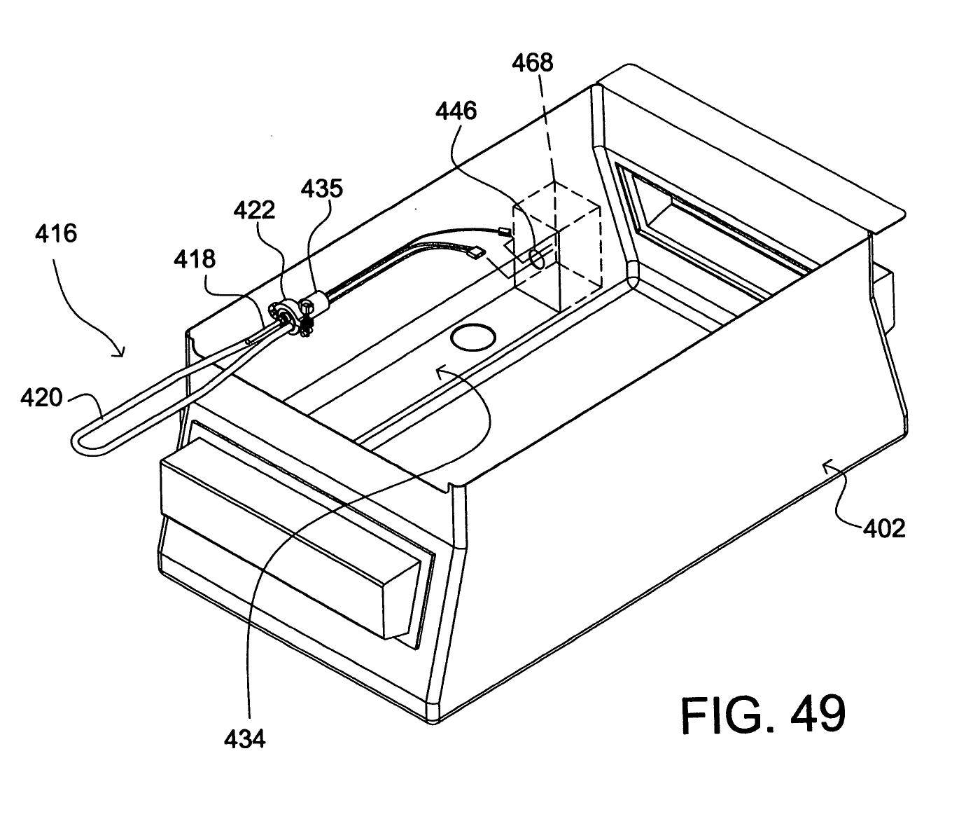

The heater 416 can be releasably secured within the tank 402 with at least one securing device 422. For example, the heater 416 can be positioned within the tank 402 by inserting the heater 416 from outside the tank 402 through a hole 446 (FIG. 49) into the tank 402. Or, for example, the heater 416 can be positioned within the tank 402 by inserting the heater 416 into the hole 446 from the inside of the tank 402. With the heater 416 positioned within the tank 402, the securing device 422 can then be used to releasably secure the heater 416 within the tank 104.

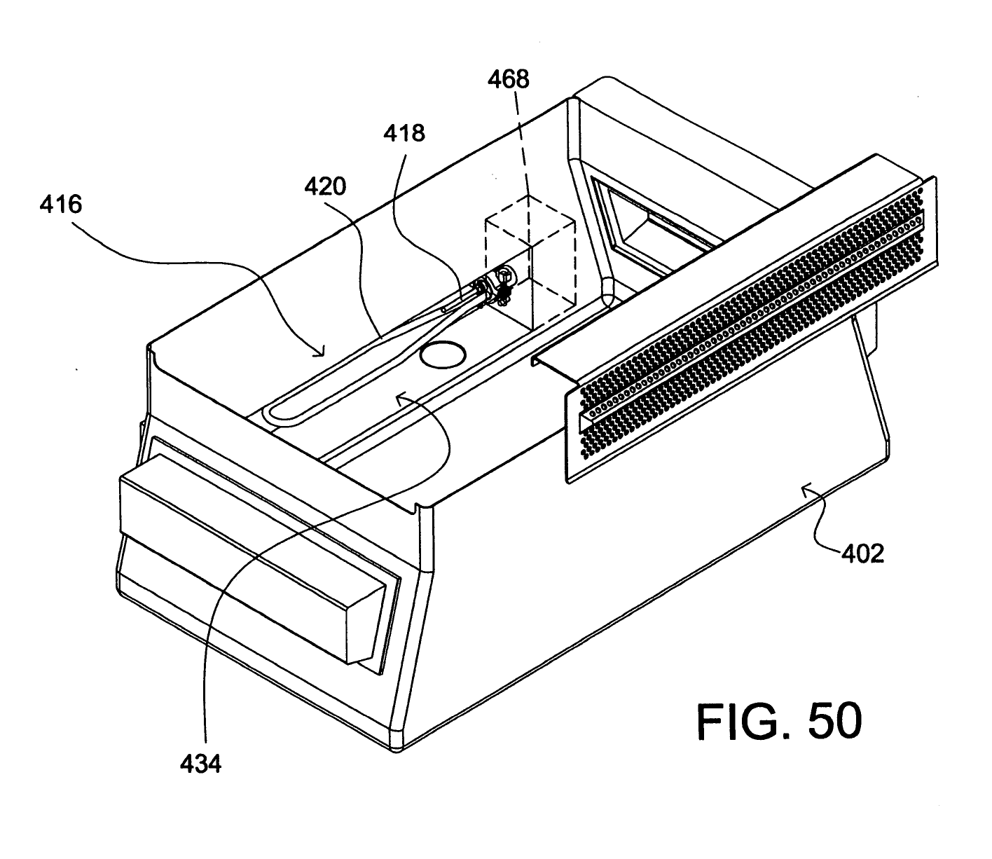

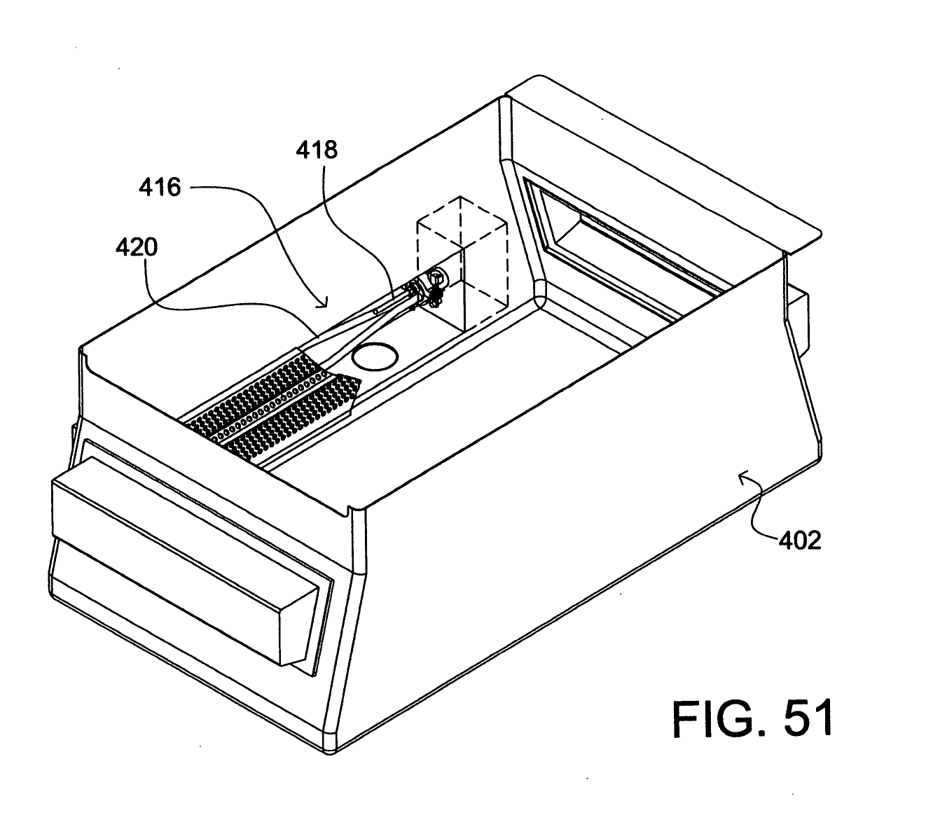

In various embodiments, the securing device 422 has a releasing portion 424 that is located within the tank 402 (as shown in FIGS. 50 and 51). In such embodiments, the heater 416 can be removed, installed, and/or replaced solely from within the tank 402 without having to crawl under the tank.

In various embodiments, the securing device 422 can also be engaged and/or disengaged without the use of any tools. This allows the heater 416 to be readily detached and/or installed within the tank in a relatively quick and efficient manner. Alternative embodiments include heaters that are secured within a tank with one or more securing devices located outside the tank and/or with one or more securing devices that can only be disengaged with the use of a tool, such as a screwdriver, wrench, pliers, etc.

In various embodiments, the heater 416 (and its heating element 420 and thermocouple 418) comprise a pluggable module such that the heater 416 can be removed as a unit. For example, in the event of a failure of one or more of the heater's components (e.g., thermocouple 418, heating element 420, wiring 430, 432, connectors 464, 466, etc.), the removable heater module can simply be removed and replaced in its entirety by a layperson. Advantageously, this can allow for the elimination of costly service calls by a technician, for example, to perform diagnostics in the field to determine which individual component of the heater 416 failed, and/or downtime of the machine while waiting for that service to be performed.

In the illustrated embodiment of FIGS. 45 through 51, the thermocouple 418 and heating element 420 are both mounted to a base 426. Various ways can be used to mount the thermocouple 418 and heating element 420 to the base 426, including welding, adhesives, interference or friction fit, threaded connections, etc.

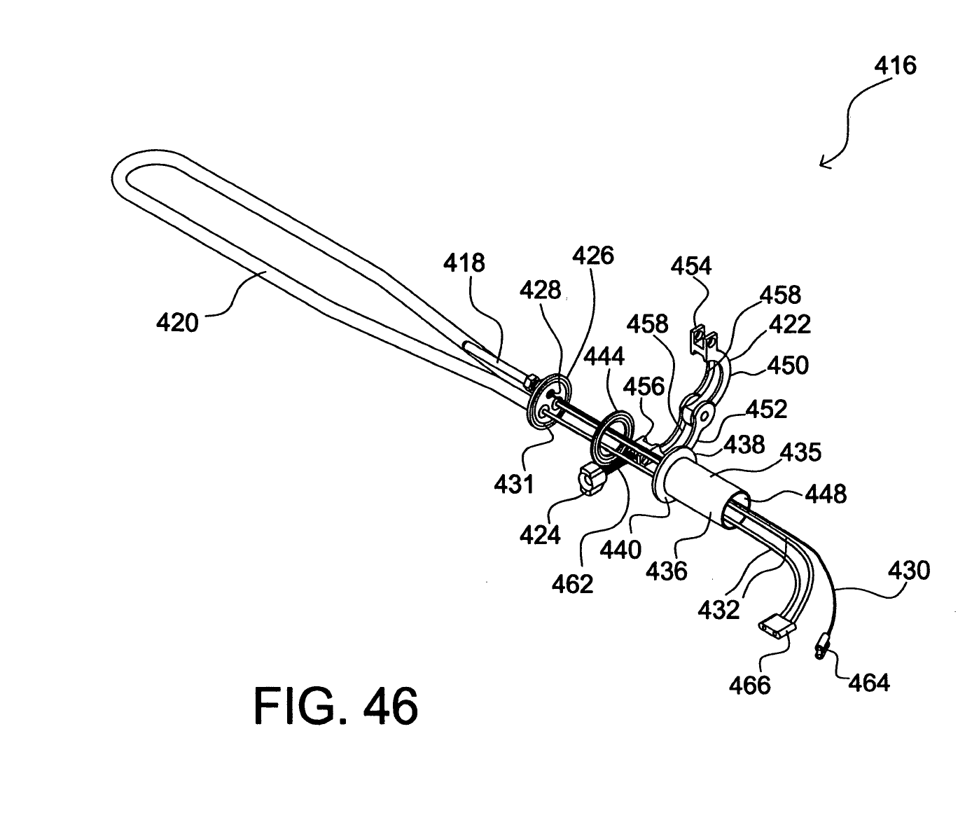

The base 426 defines openings 428 as shown in FIG. 46. These openings 428 accommodate for the thermocouple's wiring 430 and heating elements wiring 432. As shown, the base 426 is generally circular. Alternatively, other shapes (e.g., rectangular, triangular, etc.) can be used for the base depending, for example, on the particular manner in which the heater 416 is secured within the tank 402.

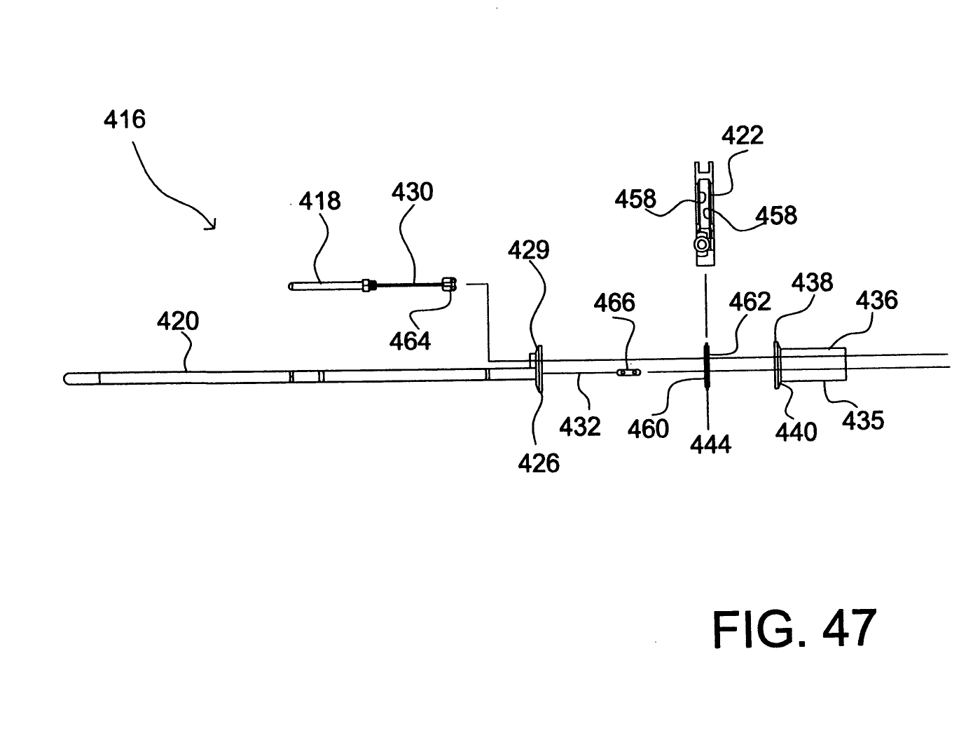

The base 426 also includes an angled or tapered portion 429. This tapered portion 429 (FIG. 47) cooperates with the securing device 422 to facilitate clamping action in a manner more fully described below. The base 426 also defines an annular groove 431 (FIG. 46) configured to receive at least a portion of a resilient sealing member 444 (e.g., resilient O-rings, etc.).

A wide range of materials can be used for the base 426 depending, for example, on the particular material(s) used for thermocouple 418, heating element 420, and/or the particular manner by which the thermocouple 418 and heating element 420 are attached to the base 426. In one particular embodiment, the base 426 is formed from stainless steel.

A fitting 435 is positioned within an opening 446 (e.g., hole, cutout, notch, etc.) of the tank 402. As shown in FIG. 49, the opening 446 is a hole defined through an end wall of the intake chamber 434. Alternatively, this opening 446 can be at other suitable tank locations, such as another wall of the intake chamber 434 or another tank wall external to the intake chamber 434.

In various embodiments, the fitting 435 is positioned within the opening 446 and then welded to the tank 402. Alternatively, the fitting 435 can be attached to the tank 402 with other ways, such as bolts, adhesives, threaded connections, etc. In yet other embodiments, such as those in which the tank is formed by injection molding or thermoforming, the fitting can be unitarily or monolithically formed with the tank such that the fitting would not be separately attached to the tank.

A wide range of materials can be used for the fitting 435 depending, for example, on the particular material(s) used for the tank 402 and/or particular method by which the fitting 435 is attached to the tank 402. In one particular embodiment, the fitting 435 is formed from stainless steel and is welded to the tank 402.

The fitting 435 defines a passage 448 through which may extend the thermocouple wiring 430 and/or heating element wiring 432, for example, to electrically connect to a control system (e.g., 212) outside the tank 402. In other embodiments, the fitting 435 may define more than one passage therethrough. For example, the fitting may define one passage for the heating element wiring, and another passage for the thermocouple wiring.

In the illustrated embodiment, the fitting 435 includes a generally hollow cylindrical portion 436 and a shoulder 438. The shoulder 438 abuts against an inner surface of the tank 402 after the fitting 435 has been installed, e.g., positioned within the opening 446 and attached to the tank 402.

As shown in FIGS. 46 and 47, the shoulder 438 includes a tapered or angled portion 440. This tapered portion 440 cooperates with the base's tapered portion 429 and the securing device 422 to facilitate clamping action in a manner more fully described below. The fitting 435 also defines an annular groove 442 (FIG. 45) configured to receive at least a portion of a resilient sealing member 444 (e.g., resilient O-rings, etc.) also described below.

With continued reference to FIGS. 45 through 51, the securing device 422 includes a clamp. When the heater 416 is releasably secured within the tank 402 (FIG. 50), the clamp 422 and its releasing portion 424 are within the tank 402. Alternatively, however, the clamp 422 and its releasing portion 424 could also be positioned outside the tank. In addition, other means could also be used to releasably secure a heater within the tank including screws, bolts, threaded coupled unions, etc.

In the particular illustrated embodiment, the clamp 422 comprises two semi-circular members 450 and 452 that are hingedly coupled to one another. The releasing portion 424 can releasably engage the respective end portions 454 and 456 of the semi-circular members 450 and 452. In one particular embodiment, the releasing portion 424 comprises a thumbscrew having a threaded portion 425 (FIG. 45) that is configured to threadedly engage a correspondingly threaded opening or bore in the end portion 456 of the semi-circular member 452. In this particular embodiment, the securing device 422 can thus be engaged and/or disengaged depending on the direction of rotation of the releasing portion 424 without the use of any tools. Accordingly, this allows the heater 416 to be readily detached and/or installed within a tank in a relatively quick and efficient manner.

When the end portions 454 and 456 are engaged to one another by the releasing portion 424, the semi-circular members 450 and 452 cooperate to define a generally annular shape having a central opening. The semi-circular members 450 and 452 are configured (e.g., sized and shaped, etc.) to be clamped circumferentially around the base 426 and the fitting's shoulder 438.

To facilitate the clamping action and thus make a more secure connection, each semi-circular member 450 and 452 includes inner tapered portions 458 (FIGS. 45 through 47). These tapered portions 458 cooperate with the base's tapered portion 429 and the fitting's tapered portion 440 in pulling the base 426 and fitting 435 together.

In other embodiments, however, one or more of the clamp, base, and fitting do not include tapered portions. For example, one embodiment includes the base and fitting having tapered portions, but not the clamp. Yet another example embodiment includes the clamp having tapered portions but not the base and fitting.

In various embodiments, the connection for the heater 416 is sealed in a substantially fluid-tight manner. This sealing can help ensure that fluid does not leak or escape from the inside of the tank through the interface between the heater 416 and tank 402. By way of example, the interface between the tank 402 and the heater 416 can be sealed by sandwiching a resilient sealing member 444 generally between the base 426 and the fitting 435. In the illustrated embodiment, the resilient sealing member 444 comprises a resilient O-ring having opposed annular shoulders 460 and 462 configured to fit, respectively, within the base's groove 431 and the fitting's groove 442.

To control operation of the heater 416, a control system may be provided, such as the control system 212 shown in FIGS. 34 through 36 and described above. Alternatively, other control systems can be employed for controlling operation of the heater 416.

In the illustrated embodiment of FIGS. 45 through 51, wiring 430 extends from the thermocouple 418, and wiring 432 extends from the heating element 420. Preferably, a quick-disconnect or pluggable electrical connection (e.g., pin-and-socket connector, etc.) is used for electrically connecting the wiring 430, 432 to the control system. Alternatively, other detachable electrical connections can be used beside quick-disconnects and pluggable electrical connections.

As shown in FIGS. 45 through 51, connectors 464, 466 are respectively disposed at the ends of the wiring 430, 432. As shown, the connectors 464, 466 include sockets or receptacles for receiving pins, which are electrically connected (e.g., by wiring, etc.) to the control system. The electrical connectors 464, 466 and pins may be housed within the housing 468 outside the tank 402. The connectors 464, 466 are preferably configured (e.g., sized, keyed, etc.) so that the connector 464 can only receive the pins relating to the thermocouple 418, and so that the connector 466 can only receive the pins relating to the heating element 420. This keyed arrangement makes it easier for a layperson to electrically connect the thermocouple 418 and the heating element 420 to the control system. For example, the layperson can thread or run the wires 430 and 432 through the passage 448 defined through the fitting 435, and then plug the connectors 464 and 466 into the corresponding pins, thereby electrically connecting the thermocouple 418 and heating element 420 to the control system. To electrically disconnect the thermocouple 418 and heating element 420 from the control system, the layperson can simply continue pulling the wiring 430, 432 into the tank 402 through the fitting passage 448 until the connectors 464, 466 are pulled away from the pins.

FIGS. 52 and 53 illustrate another embodiment in which the heater 516 includes a quick-disconnect (pluggable) electrical connection for electrically connecting to a control system. In this particular embodiment, the thermocouple 518 and heating element 520 include pins 564 and 566, respectively, for electrically connecting to the control system, which is located outside the tank. In this particular example, connectors 570, 572 are respectively disposed at the ends of wires 530 and 532. The connectors 570, 572 include receptacles or sockets for receiving the pins 564, 566, respectively. The connectors 570, 572 are preferably configured (e.g., sized, keyed, etc.) so that the connector 570 can only receive the thermocouple's pins 554, and so that the connector 572 can only receive the heating element's pins 566. This keyed arrangement makes it easier for a layperson to electrically connect the thermocouple 518 and heating element 520 to the control system. By way of example, the layperson can electrically connect the thermocouple 518 and heating element 520 to the control system by positioning the heater 516 so that the pins 564, 566 extend through the passage 548 defined by fitting 535, and plug into the corresponding receptacles or sockets of connectors 570, 572 within housing 568. To electrically disconnect the thermocouple 518 and heating element 520 from the control system, the layperson can move the heater 516 relatively away from the housing 568 until the pins 564, 566 are unplugged from the corresponding receptacles or sockets of the connectors 570, 572. Alternatively, a wide range of other quick-disconnect (pluggable) and/or detachable electrical connections (e.g., pin-and-socket connector, etc.) can be used for electrically connecting the thermocouple 518 and heating element 520 to the control system.

In various embodiments, the housings 468, 568 may include at least one opening to allow fluid to drain out of the housing. The housings 468, 568 are preferably configured to house and thus protect the electrical wiring and connectors, such as wiring 430, 432, 530, 532 and the electrical connections between this wiring and the control system, which as described herein can include pin-and-socket connectors, other quick-disconnect (pluggable) connections, and/or other detachable electrical connections.

Various aspects of the invention relate to tank fluid low level detection and heater temperature high limit protection. When there is no water in the tank or insufficient water within the tank to cover the heater (e.g., 216, 416, 516, 616 etc.), the heater can damage itself by overheating if it remains in operation. In various embodiments of the present invention, control logic has been provided that enables tank fluid low level detection and heater temperature high limit protection using a thermocouple, such as the thermocouple integrated with the heater 216, or the thermocouple 418, 518, 618 of heater 416, 516, 616. For example, in one embodiment, the controller 214 automatically cuts power to the heater if the heater temperature as determined by the thermocouple reaches a predetermined high limit set point.

As an additional or alternative way of protecting the heater from overheating, the controller 214 can deactivate the heater when an abrupt temperature rise of the heater is detected by the thermocouple. An abrupt temperature rise can occur when there is insufficient water around that heater to absorb the heat produced by the heater. When the thermocouple detects that the heater's temperature has risen by a predetermined amount over a predetermined amount of time (e.g., over the last few time slices or seconds), that detected condition is indicative that there is insufficient water in the tank to cover the heater. Because continued operation of the heater could damage the heater by overheating, the controller 214 automatically shuts down the heater. By way of example, contacts within the controller 214 can open up such that the heater solid-state relay 218 loses power to its coil side and shuts down power to the heater. Additionally, or alternatively, the control system 212 could also emit a warning (e.g., visual display, emit sounds, etc.) to the operator to shut down the heater.

In these exemplary embodiments, the heater temperature high limit protection and tank fluid low level detection are determined via temperature sensing with the fluid within the tank acting as the conductor or medium through which the temperature sensing occurs. In other embodiments, however, capacitative sensing or floats can be employed to determine tank fluid low level detection and/or heater temperature high limit protection.

For those embodiments including the heater 416 (FIGS. 45 through 52), 516 (FIGS. 52 and 53), or 616 (FIGS. 54 and 55), the controller's hysteresis or deadband can be increased to accommodate for the spaced distance separating the thermocouple 418, 518, 618 from the heating element 420, 520, 620. By way of background, the deadband or hysteresis is the amount of a measured variable (e.g., temperature, etc.) between the point where a switch closes and then re-opens. In various embodiments, the deadband or hysteresis is implemented within the control logic or by software of the controller 214.

In the particular heater embodiment 616 shown in FIGS. 54 and 55, the relative flexibility of the thermocouple 618 allows the thermocouple 618 to flex or bend. This, in turn, allows the end portion 619 of the thermocouple 618 to be positioned relatively close to the heating element 620. This close spacing can improve/reduce reaction time and also allows a lower deadband or hysteresis setting to be used for the heater 616 than for other heater embodiments (e.g., 416, 516, etc.) in which the thermocouple (e.g., 418, 518, etc.) is spaced a greater distance away from the heating element (e.g., 420, 520, etc.). With continued reference to FIGS. 54 and 55, the end portion 619 of the thermocouple 618 is shown attached to the heating element 620 with at least one securing device 621. The securing device 621 may comprise a clamp or a band. Alternatively, other means could also be used to secure the end portion 619 of the thermocouple 618 to the heating element 620.

The heater 616 can be releasably secured to a tank (e.g., 102, 102′, 402, etc.) of a kitchenware washing assembly (e.g., 100, etc.) in a substantially similar manner as described above for the heater 416 and shown in FIGS. 45 through 51. Alternatively, other suitable methods and devices can be used to releasably secure the heater 616 to a tank of a kitchenware washing assembly.

Over time and repeated wash cycles, the water within the tank can get stagnate and dirty such that the tank water needs to be replaced. It can be very difficult, however, to determine when to change the tank water. Plus, changing the tank water too frequently can be costly. Conversely, waiting too long to change the tank water can lead to insufficient cleaning of the kitchenware such that kitchenware will need to be rewashed. Accordingly, it is desirable to automate the decision as to when the tank water should be changed. It is also desirable to provide some means for ensuring that the tank water is in fact changed when it should be. In various embodiments, control logic has been provided for accomplishing these tasks.

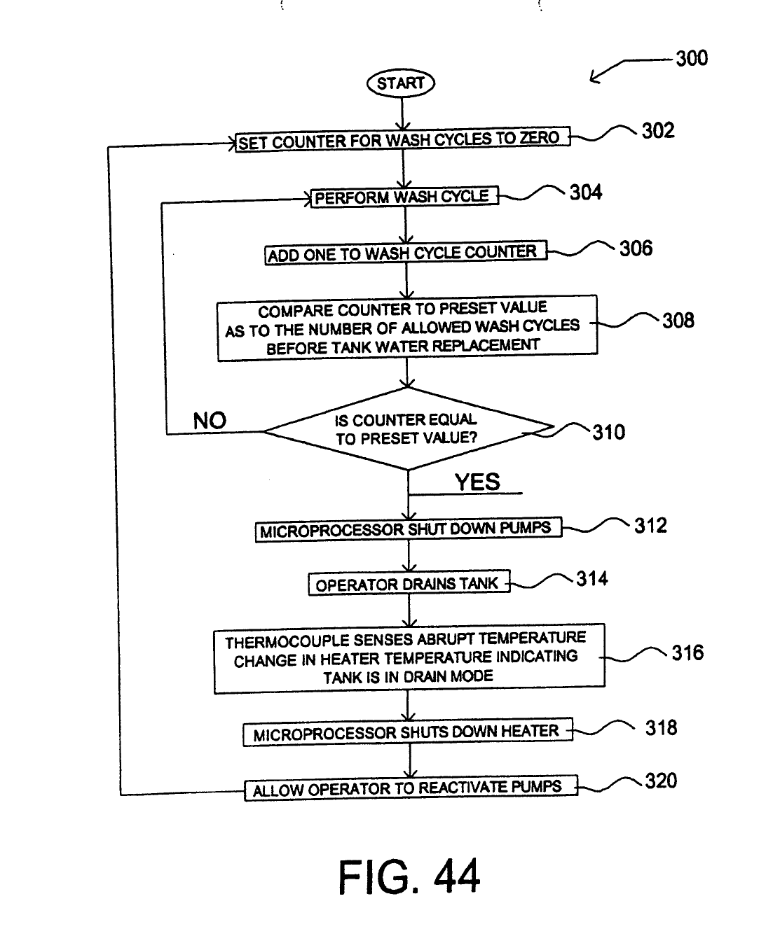

FIG. 44 illustrates various operations of an exemplary process 300 for monitoring tank water replacement according to one particular embodiment. As shown, the controller 214 maintains a counter that tracks the number of wash cycles, amount of run time, and/or time that has elapsed since the water was last changed. At operation 302, the counter is set to zero. For each washing cycle 304, the counter is increased by one (operation 306) and then the counter is compared (operation 308) to determine whether the counter is equal to a preset value. The preset value can be a value entered by the operator, and/or preprogrammed into the control system 212. The preset value is the allowable or acceptable number of wash cycles that can be performed before the tank water is replaced. The number of acceptable or allowable wash cycles may vary, however, depending, for example, on the particular type of items being washed and the size of the tank, among other factors.

The operator can continue performing wash cycles if the counter does not equal the preset value (operation 310). But when the counter equals the preset value that is an indicator that the tank water should be replaced.

To help ensure that the tank water is replaced once the number of wash cycles equals the preset value, the controller 214 shuts down the pumps (operation 312) and will not allow the pumps to be reactivated until the water is drained from the tank. Accordingly, the operator should then drain the tank (operation 314).

To automatically determine whether the water is being drained or has been drained from the tank, the tank fluid low level detection described above can be employed. That is, the thermocouple associated with the heater (e.g., the thermocouple within the heater 216, or thermocouple 418, 518, 618 of heater 416, 516, 616, etc.) will detect (operation 316) a relatively abrupt temperature rise in the heating element when the water breaches or drains below the heater. This temperature rise indicates to the controller 214 that the tank water is being or has been drained. The controller 214 shuts down the heater at operation 318. Now that the controller 214 knows that the tank water should be replaced (via operations 308 and 310) and that the tank water is being or has been drained (via operation 316), the controller 214 allows the operator to reactivate (or the controller may automatically activate) the pumps 104 and 106 (operation 320). The controller 214 also resets the counter back to zero (operation 302). Additionally, or alternatively, the control system 212 could also notify the operator (e.g., by a visual display, emitting sounds, etc.) to manually reset the counter.

According to another aspect of the invention, a method relating to operation of a kitchenware washing assembly generally includes monitoring temperatures within the inside of a tank to detect a temperature differential indicative of two different fluid level conditions/states (e.g., at about full capacity and at less than full capacity, full and empty, that the fluid is being drained, full and partially empty, etc.). The temperature differential may indicate that one of the two different sensed temperatures was sensed while the inside of the tank held a different amount of fluid for washing kitchenware than when the other temperature was sensed. The monitoring may include monitoring the sensed temperatures to detect when the temperature sensed within the inside of the tank has increased by a predetermined amount over a predetermined time interval.

By way of example, various embodiments use a temperature sensor (e.g., thermocouple 416, 516, 616, etc.) and control system to monitor temperatures within the tank to detect a particular temperature differential between a first temperature sensed within the fluid in the tank and a second temperature sensed outside the fluid. In these particular embodiments, the particular temperature differential between the first and second temperatures thus indicates that the fluid level within the tank was sufficient such that the first temperature was sensed by the temperature sensor when the location at which the temperature sensing occur was within the fluid, and such that the second temperature was sensed after the fluid has dropped and/or is below the location at which the temperature sensing occurs.

This method can also include using the detection of that particular temperature differential in connection with the operation of the kitchenware washing assembly. For example, one or more operations (e.g., pumps, heaters, etc.) can be controlled as a function of the temperature monitoring. As described above, the detection of the temperature differential can used for heater temperature high limit protection, tank fluid low level detection, and/or tank water replacement. In various embodiments, upon detection of the particular temperature differential, a controller may automatically shut down or deactivate one or more operations, such as the heater, pumps, soap dispenser, etc. Or, for example, an alarm may be generated after detecting the particular temperature differential, which, in turn, indicates to the operator to shut down or deactivate one or more operations of the kitchenware washing assembly.

This method may further include monitoring washing cycles to detect an indicator that the fluid for washing kitchenware should be replaced, and after detecting the indicator that the fluid for washing kitchenware should be replaced, inhibiting, limiting, or restricting a wash cycle at least until the temperature differential has been detected. In various embodiments, a control system of the kitchenware washing assembly may be preprogrammed with one or more preset programs and/or provided with control logic for monitoring washing cycles and for accomplishing other operations of these methods.

According to another aspect of the invention, a method relating to operation of a kitchenware washing assembly generally includes counting a number of washing cycles since a replacement of the fluid within tank, comparing the counted number of washing cycles to a preset value, and using the comparison in connection with the operation of the kitchenware washing assembly. In some embodiments, the preset value may be input by the operator (e.g., by a user interface of a control system, etc.), and/or the preset value may be preprogrammed into the controller. As described above, FIG. 44 illustrates one exemplary implementation of this method, although other implementations are possible. In addition, various embodiments can include a control system of the kitchenware washing assembly being preprogrammed with one or more preset programs and/or provided with control logic for accomplishing the operations of these methods.

The comparison of the counted number of washing cycles to a preset value can be used in various ways. By way of example, various embodiments generate an alarm when the counted number of cycles equals or exceeds the preset value, thus indicating to the operator that the tank water should be changed. Other embodiments control one or more operations as a function of counted wash cycles and/or as a function of fluid replacement intervals.

Further embodiments inhibit, limit, or restrict further wash cycles (e.g., automatically deactivating one or more operations, such as the pumps, heaters, soap dispensers, etc.) if the counted number of cycles equals or exceeds the preset value. The method may also include monitoring for an indicator (e.g., temperature differential as described above, a predetermined temperature, a predetermined temperature rise over a predetermined amount of time, etc.) of fluid drainage from the tank. In these embodiments, inhibiting the wash cycles may continue at least until after the indicator of fluid drainage has been detected.

In embodiments in which one or more operations are deactivated if the counted number of cycles equals or exceeds the preset value, the method can also include monitoring for an indicator (e.g., temperature differential as described above, etc.) of fluid drainage from the tank, and allowing reactivation of the deactivated one or more operations if the indicator is detected. Assuming reactivation is allowed, various embodiments include the deactivated one or more operations being automatically reactivated by a controller and/or manually reactivated by an operator.

In various embodiments, a kitchenware washing assembly may include different types of washing cycles, such as the washing cycles described above and/or light cleaning, medium cleaning, normal cleaning, heavy cleaning and overnight cleaning. In such embodiments, counting washing cycles may include counting washing cycles of a first type differently than washing cycles of a second type. For example, this counting operation may attribute a greater value to heavy duty wash cycles used for heavy pots and pans with caked-on food residues or remnants than to lighter duty wash cycles used for delicate and fragile dishware. In one particular embodiment, a greater value is attributed during the counting to wash cycles having a higher soap concentration than for those wash cycles with lower soap concentrations.

Accordingly, aspects of the invention include using heaters and thermocouples for tank fluid low level detection, for heater temperature high limit protection, and for monitoring tank water replacement. These particular aspects of the invention (as can all other aspects of the invention) can be used individually or in combination with any one or more of the other aspects of the present invention.

Various embodiments can also include remote cycle programmability in which the user can program and specify operational parameters for one or more wash cycles or schemes over a communication interface. In such embodiments, network communications capability may be provided via a communication interface, such as an infrared, wireless, and/or wired interface to interface with an external system (e.g., personal digital assistant, cellular phone, laptop computer, etc.). In such embodiments, a user may use the user interface to remotely specify one or more control or operational parameters for one or more wash cycles or schemes to thereby customize or tailor the operation of the kitchenware washing assembly for specific cleaning needs. For example, the user interface may allow the user to remotely specify the timing, duration, water temperature, temperature ranges, maximum water temperature, cleaning solution or soap concentration levels, pump operational parameters (e.g., speeds, frequencies, pulsations, etc.), cleaning solution changes, fills and drains, event logging, data reporting, maintenance reporting, alarming, etc.

According to another aspect of the invention, various embodiments include automatic drain and fill cycles. In one particular embodiment, this auto drain/auto fill feature can be actuated by a control input. This feature automatically opens a drain solenoid valve connected to the drain of the tank, which, in turn, may be connected to a sewer line. After the lapse of a predetermined period of time, the drain solenoid valve is automatically closed. A display can produce an indicator of the auto drain when in this mode or cycle. After completion of the auto drain cycle and the drain solenoid valve has closed, the auto fill cycle is automatically initiated by the opening of an incoming water supply solenoid valve and pressure regulator on the input waterline. After the lapse of a second predetermined period of time, the incoming water supply solenoid valve closes to turn off the flow of water into tank. This feature can be performed by a controller of a control system, and may be implemented in software, firmware, and/or hardware.

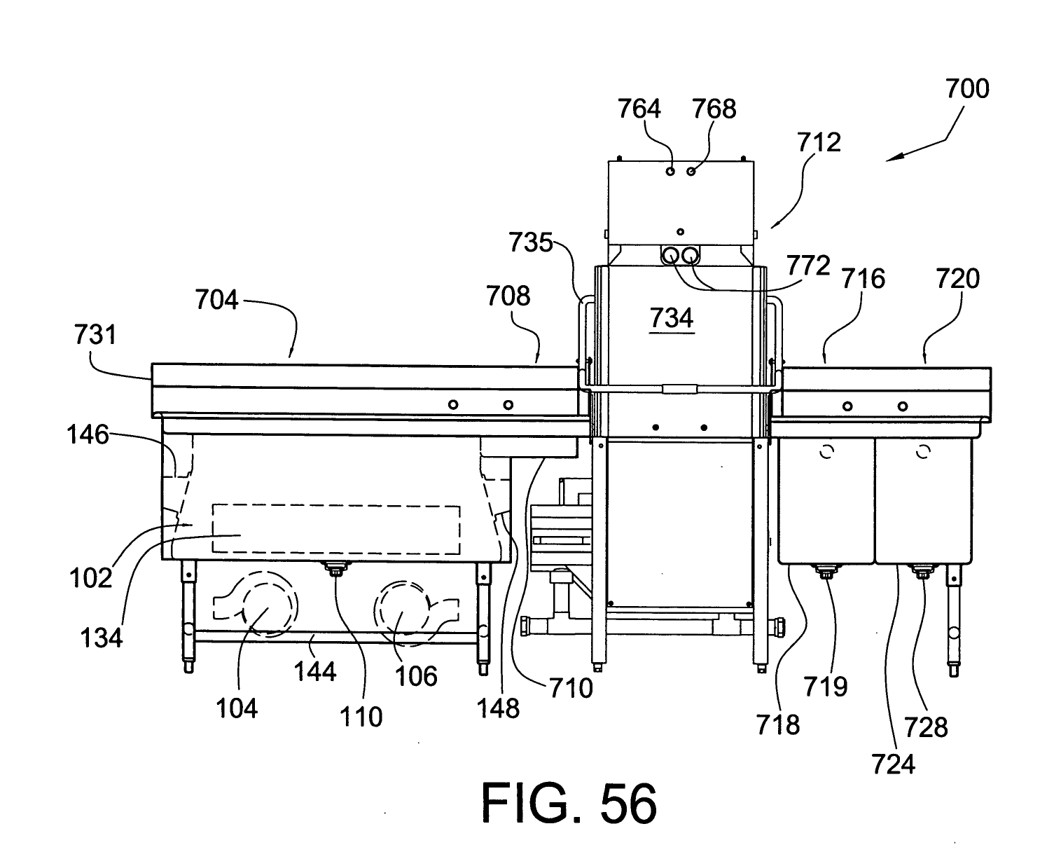

According to another aspect, the invention provides kitchenware washing systems that can include first and second kitchenware washing assemblies. In the particular illustrated embodiment shown in FIG. 56, a commercial kitchenware washing system 700 includes generally contiguous stations (shown from left-to-right) including a first kitchenware washing assembly 704, an initial scraping/pre-rinse station 708, a second kitchenware washing assembly 712, and “back-up” rinsing and sanitizing stations 716 and 720.

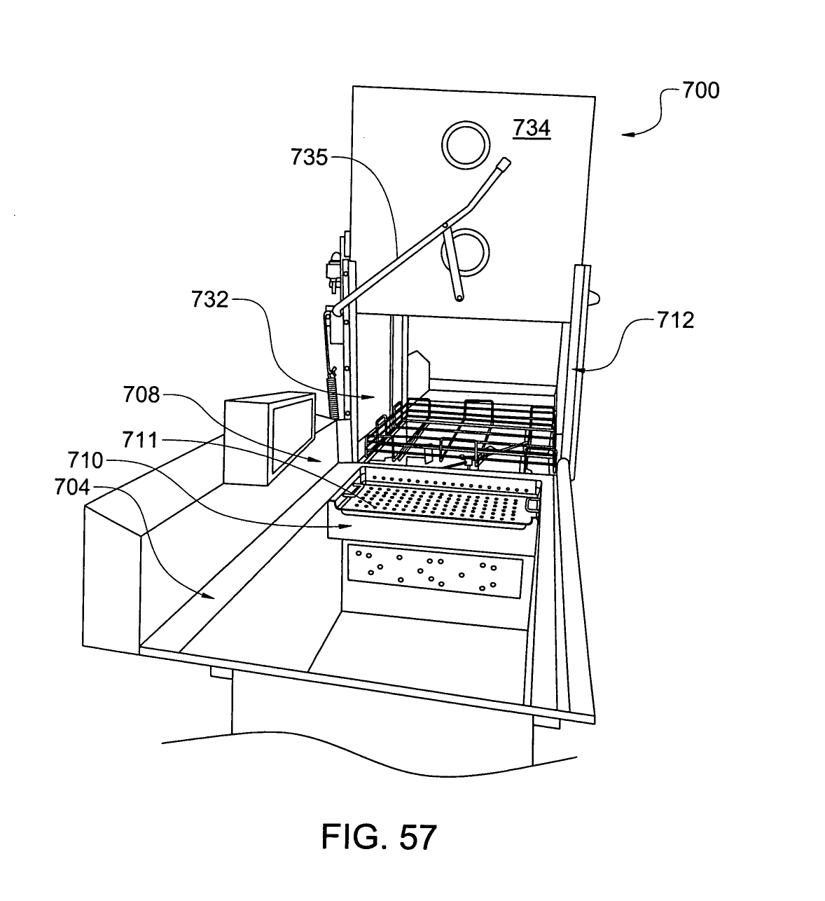

Continuing with this example, the first kitchenware washing assembly 704 may be operable for soaking and scrubbing heavy pots and pans. The initial scraping station 708 can include a sink 710, an overhead sprayer for removing bulk food items and residue that have stuck to the kitchenware, and a removable perforated cover or screen (e.g., 711 in FIG. 57) over the sink for catching the removed food items and residue. The second kitchenware washing assembly 712 can be operable as a washing station to wash the remaining food items or food residues from kitchenware that was not removed at the initial scraping/pre-rinse station 708. The rinsing station 716 can include a rinsing tank or sink 718 for rinsing soap or cleaning fluids from kitchenware. The sanitizing station 720 can include a tank or sink 724 for sanitizing cleaned kitchenware. The sinks at the rinsing and sanitizing stations 716 and 720 may be covered with removable perforated covers or screens, for example, to increase the usable work space of the system 700. The removable perforated covers can also prevent debris from entering the sink drains 719, 728 and clogging or partially clogging it. For example, the removable perforated covers may catch food items and residue clinging onto the rack of kitchenware after the rack has been moved out of the second kitchenware washing assembly 712 and positioned above the sinks 718 and 724 at the respective rinsing and sanitizing stations 716 and 720. The rinsing and sanitizing stations 716 and 720 can be used as “back-up” stations in a time of need, such as when either the first or second kitchenware washing assembly 704 and 712 is inoperable. In addition, a backsplash 731 can be provided that is preferably slightly higher than the tank walls of the first kitchenware washing assembly 704 by about a few inches.

In various embodiments of the present invention, the first kitchenware washing assembly 704 may include one or more of the features of a kitchenware washing assembly (e.g., 100, etc) described and shown herein such as tank 102, 102′, 402, pumps 104, 106, conduits 136, 138, 140, 142, intake cover 150, outlet covers 160, 160′, 162, control system 212, heater 216, 416, 516, 616, securing device 422, among other features and aspects shown and/or described herein. In one particular embodiment, the first kitchenware washing assembly 700 is substantially identical to the washing assembly 100 described and shown herein. Alternatively, other kitchenware washing assemblies are possible for the first kitchenware washing assembly.

In the particular illustrated embodiment of FIG. 56, the first kitchenware washing assembly 704 includes tank 102, two pumps 104 and 106 positioned and supported by a slidable shelf 144, intake chamber 134, and outlet chambers 146 and 148 having outlets or discharge openings 108, all of which substantially as described above. The tank 102 can and typically should include a drain 110 and valve system (not shown) to allow the tank 102 to be filled and emptied. The tank 102 will also typically include a faucet (not shown) to fill the tank 102.

While not shown in FIG. 56, an exemplary control system (e.g., 212, described in more detail below and shown in FIGS. 34 through 36) can be used for controlling one or more operations of the first kitchenware washing assembly 704. In general operation, the tank 102 is filled to operating level. One or both of the pumps 104 and/or 106 can be operating to pump cleaning fluid (e.g., water and a detergent or soap) from tank 102 through intake chamber 134 to outlets or discharge openings of the outlet chambers 146 and 148. The drain 110 and valve system should be in a closed position to maintain the cleaning fluid in the tank 102. In various embodiments, fluid within the tank 102 is circulated to create turbulence in the tank 102. The turbulence helps to clean kitchenware and loosen tough food residues or remnants that become caked-on kitchenware during the cooking or food preparation process.

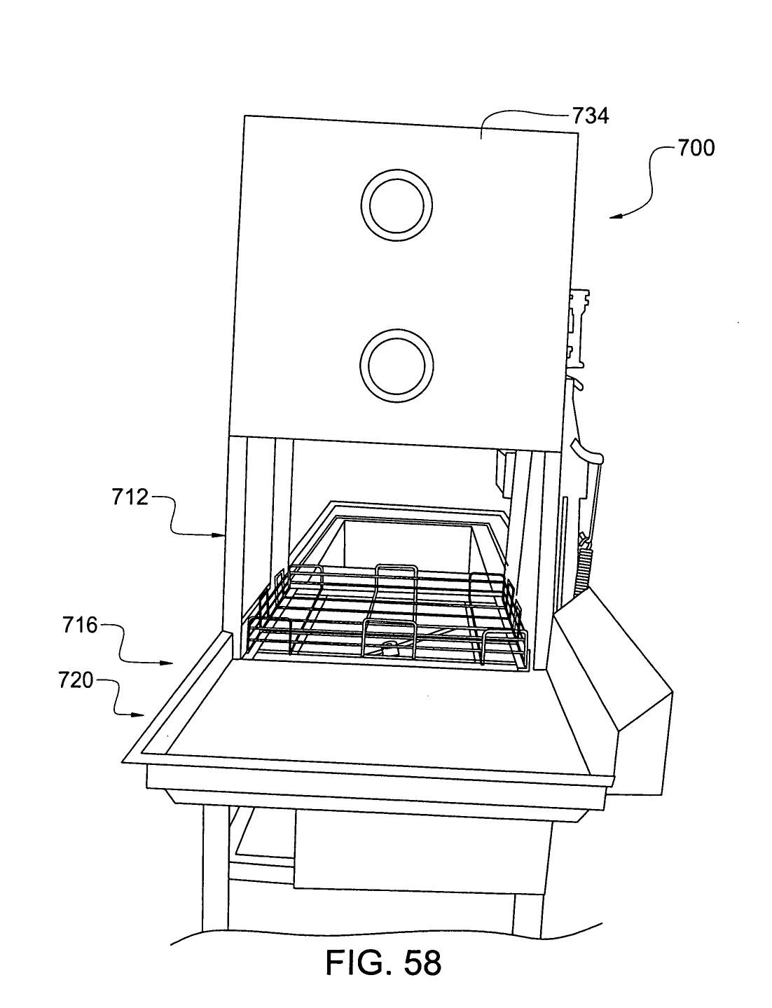

In various embodiments, the second kitchenware washing assembly 712 includes an enclosure 732 (FIG. 57) having at least one closable opening allowing kitchenware to be positioned through the opening into an interior of the enclosure. In the particular illustrated embodiment, the second kitchenware washing assembly includes a front opening, and two side openings as shown in FIG. 58. Slidable doors 734 with handles 735 (FIG. 57) are provided for opening and closing the closable openings. Alternatively, the second kitchenware washing assembly 712 can include more or less openings in different configurations (e.g., shapes, sizes, etc.) and/or different door types (e.g., completely removable doors, etc.).

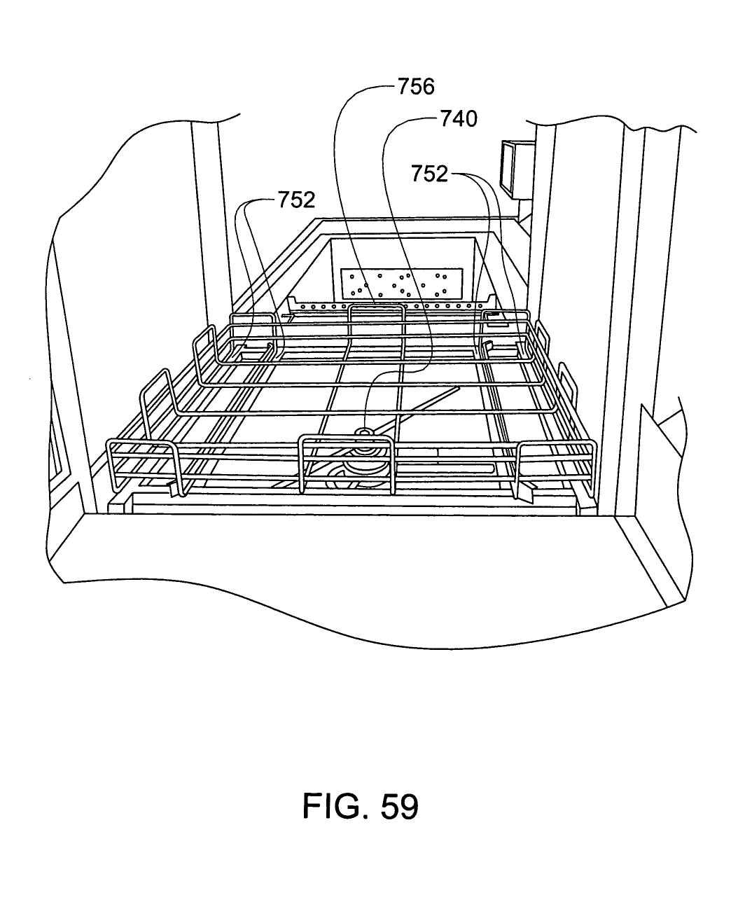

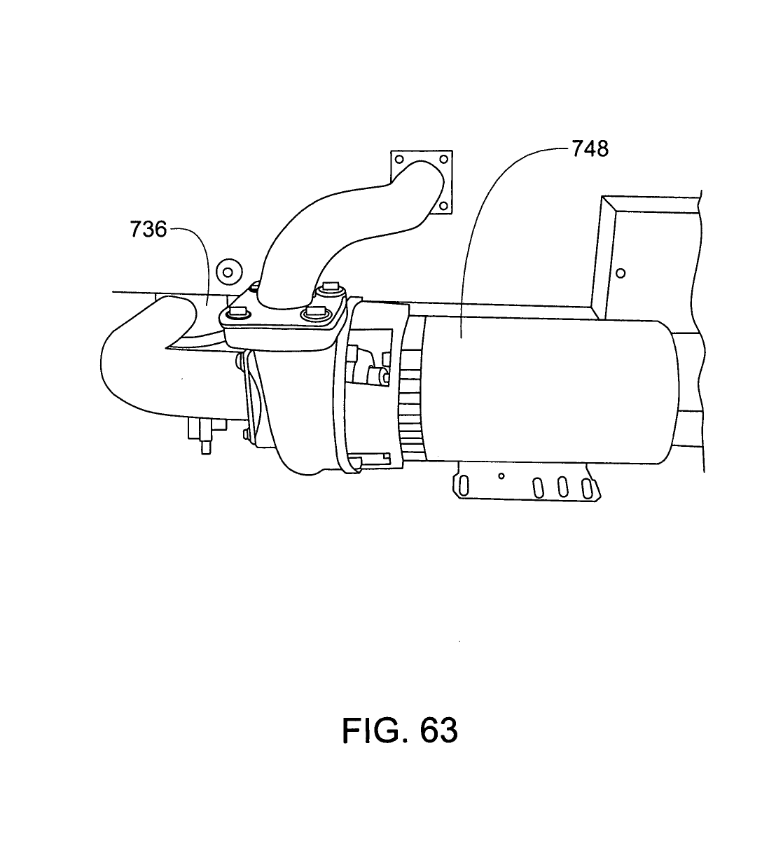

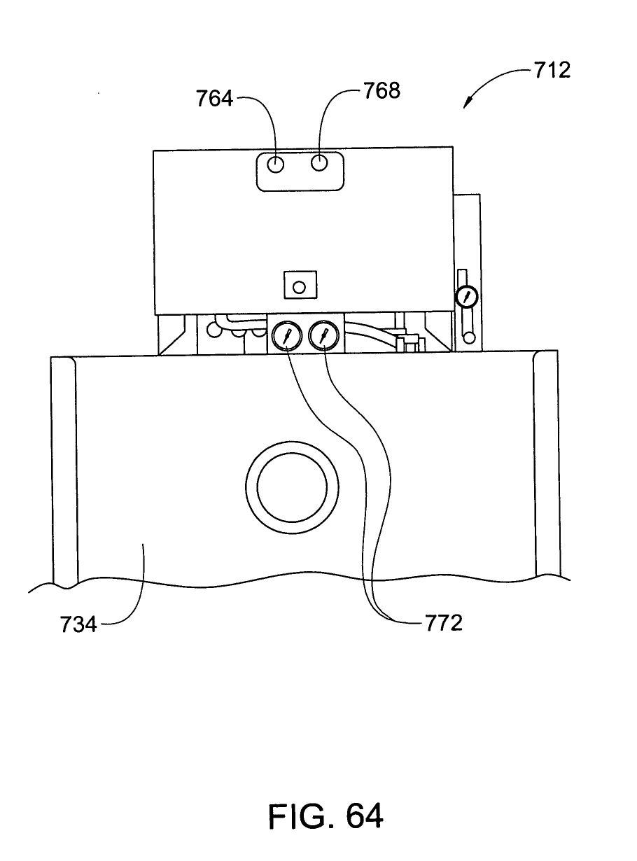

The second kitchenware washing assembly 712 also includes at least one inlet or drain 736 (FIG. 63) for receiving fluid from the interior of the enclosure 732. At least one sprayer or spray manifold 740 and 744 (FIGS. 59 through 61) is within the enclosure and coupled to at least one pump 748 (FIG. 63). The pump 748 is operable for pumping fluid from the inlet to the sprayer(s) for spraying fluid (e.g., water and cleaning solution, sanitizing solutions, water for rinsing, etc.) onto kitchenware within the interior of the enclosure.

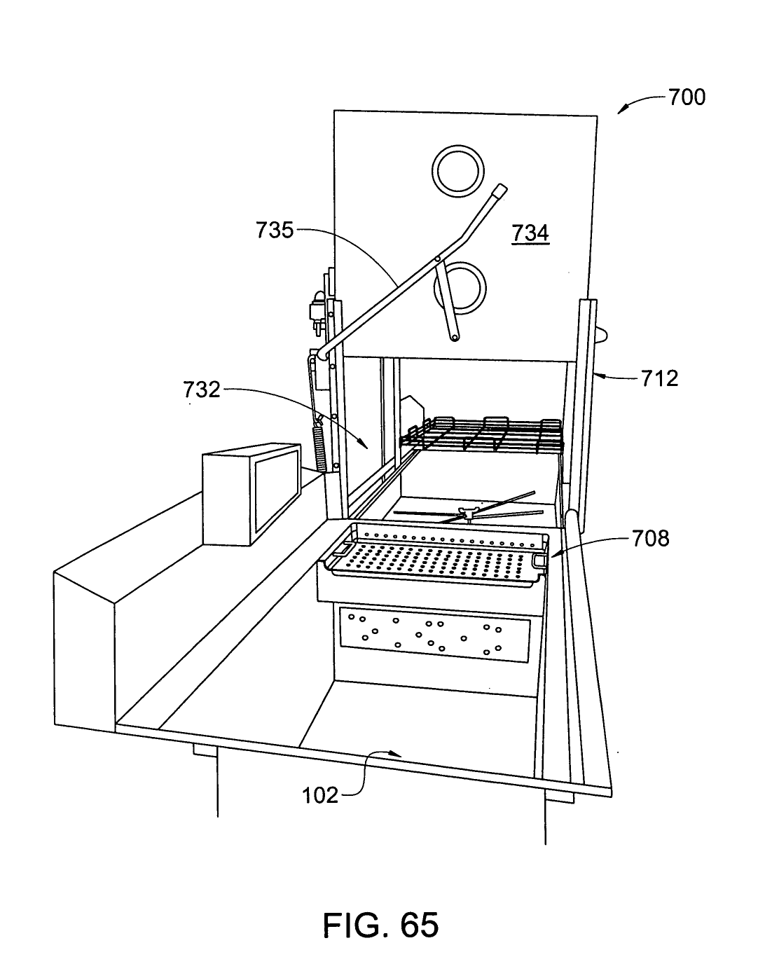

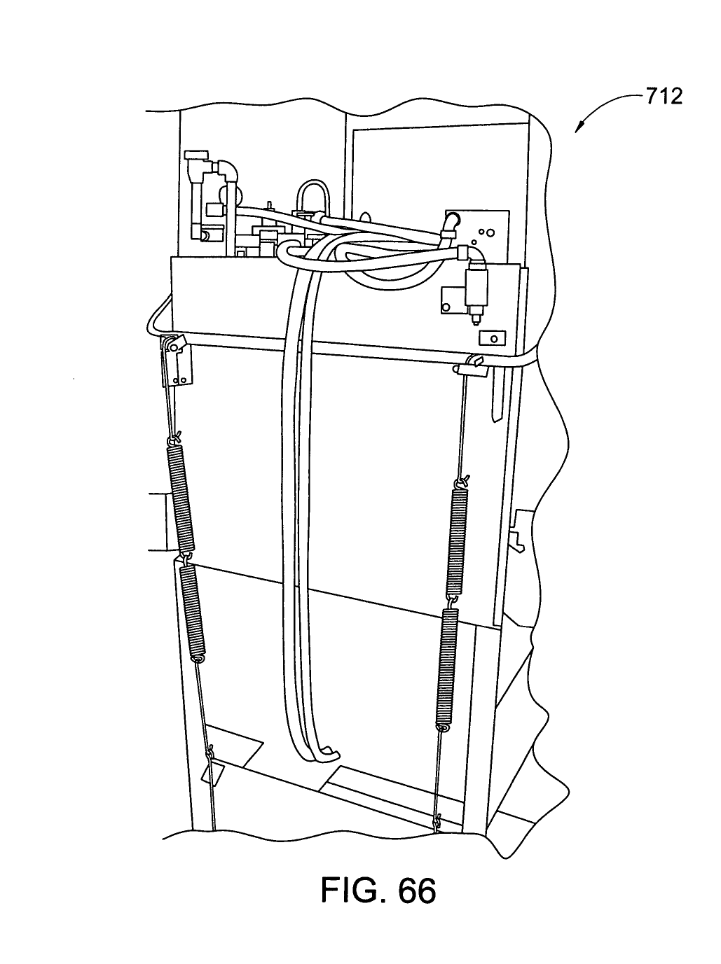

In various embodiments, the commercial kitchenware washing system 700 includes spaced apart rails or tracks 752 (FIGS. 59, 60, and 65) for supporting a rack or magazine 756 loaded with kitchenware (e.g., dishware, tableware, cups, glassware, etc.). The rails 752 can allow the rack 756 to be slidably advanced through the second kitchenware washing assembly 712 (e.g., as indicated by a comparison of FIG. 59 with FIG. 65). Alternatively, a commercial kitchenware washing system can include other means for conveying a rack loaded with kitchenware through the second kitchenware washing assembly, such as an automatic conveyor belt systems or differently configured (e.g., sized, shaped, arranged, etc.) tracks than that shown and described herein.

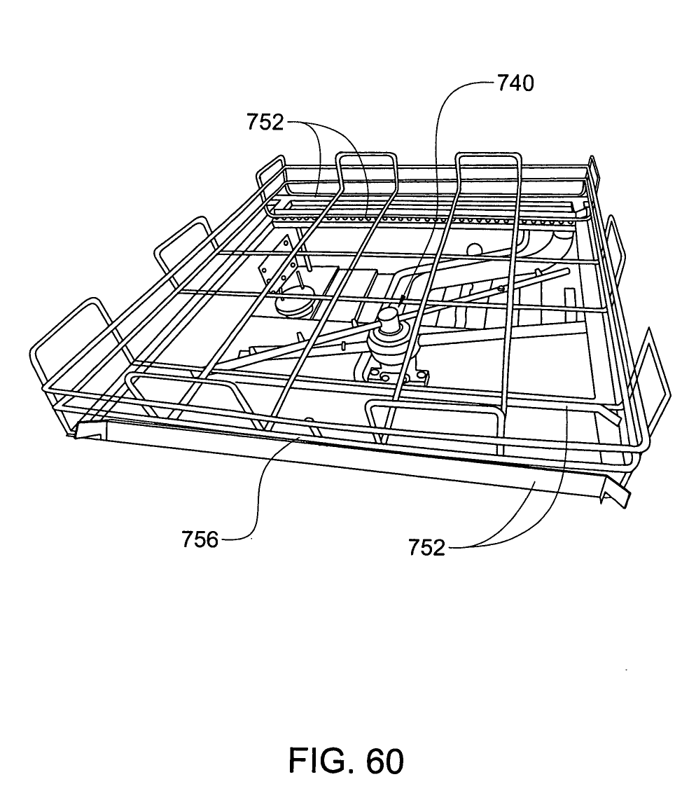

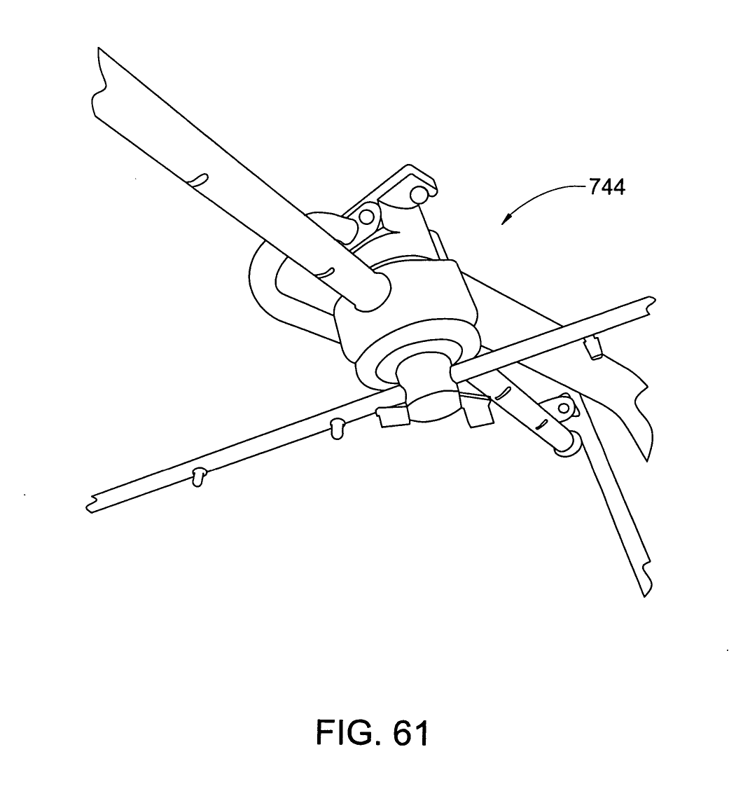

In the particular illustrated embodiment, the second kitchenware washing assembly includes a lower rotary spray arm 740 (FIGS. 59 and 60) and an upper rotary spray arm 744 (e.g., FIG. 61). The upper rotary spray arm 744 is supported from an upper surface 745 within the enclosure 732, while the lower rotary spray arm 740 is coupled to a lower surface within the enclosure 732. Accordingly, the upper rotary sprayer arm 744 can spray fluid generally downwardly onto kitchenware loaded in a rack 756, and the lower rotary sprayer arm 740 can spray fluid generally upwardly onto kitchenware loaded in a rack 756. While this particular embodiment includes upper and lower rotary sprayer arms each with a plurality of outlets, aspects of this invention are not so limited. For example, alternative embodiments of this invention include an enclosure with more or less than two sprayer arms, an enclosure having non-rotating stationary outlets on the enclosure walls, etc.

In various embodiments, the second kitchenware washing assembly 712 is configured such that at least one of its closable openings and the interior of the enclosure 732 (FIG. 65) are sufficiently sized to accommodate any size of kitchenware capable of being substantially positioned and washed within the tank 102 of the first kitchenware washing assembly 704. In such embodiments, relatively large heavy pots and pans that may be substantially submerged within the fluid in the tank 102 of the first kitchenware washing assembly 704 can also be positioned within the second kitchenware washing assembly's enclosure 732 through one or more of the closable openings. This allows the second kitchenware washing assembly 712 to operate as a “back-up” for washing or scrubbing heavy pots and pans in the event that the first kitchenware washing assembly 704 is inoperable.

In various embodiments, the second kitchenware washing assembly 712 is configured such that the open portion of the closable openings has a height from top-to-bottom about equal to or greater than the height from top-to-bottom of the tank 102. The open portions of the closable openings also have a width from front-to-back about equal to or greater than the depth of the tank 102 from front-to-back. The interior of the enclosure 732 has a length from left-to-right about equal to or greater than the length of the tank 102 from left-to-right.

By way of example only, dimensions will be provided for one particular embodiment of the system 700. In this exemplary embodiment, the second kitchenware washing assembly 712 can be configured such that its closable openings have a width from front-to-back of about thirty-one inches and a height from top-to-bottom of about twenty-four inches. The second kitchenware washing assembly 712 can be further configured such that the exterior or footprint of its enclosure has a width from front-to-back of about thirty-six inches, a height from top-to-bottom of about thirty-six inches, and a length from left-to-right of about thirty-six inches. In addition, the first and second kitchenware washing assemblies 704 and 712 and three stations 708, 716, 720 can be configured (e.g., positioned, arranged, sized, attached to one another (e.g., welded and/or bolted, etc.), combinations thereof, etc.) such that the overall length of the system's footprint (from left-to-right in FIG. 56) is about ten feet or less. The dimensions set forth in this paragraph (as are all dimensions herein) are mere examples and can be varied as understood by those skilled in the art. In addition, other embodiments can include a second kitchenware washing assembly having more or less than three closable openings and/or closable openings in different shapes, sizes, and configurations. Further, each closable opening does not need to have the same shape, size, and configuration.

The operation of the first kitchenware washing assembly 704 can occur before, substantially simultaneously with, and/or after the operation of the second kitchenware washing assembly 712. In one exemplary operation of the system, the first kitchenware washing assembly 704 may be used for soaking and/or scrubbing heavy pots and pans with caked-on food, while the second kitchenware washing system 712 is used for cleansing, sanitizing, and/or rinsing dishware. Advantageously, this multitasking can allow greater system throughput that significantly shortens the time otherwise needed for separately completing the operations performed by the first and second kitchenware washing assemblies 704 and 712 (e.g., reduction in time from thirty minutes to eight minutes, etc.).

One exemplary operational sequence will now be described for the system. First, the operator may use the overhead sprayer at the initial scraping/pre-rinse station 708 to remove bulk food items or residue stuck to kitchenware. The removed bulk food items or residue may fall on top of and be captured by the removable perforated cover or screen 711 positioned across a top of the sink 710. To help prevent the food items and residue removed or scraped from the kitchenware from falling into the tank of the first kitchenware washing assembly 704, various embodiments include a cover positioned over at least a portion of the opening at the top of the tank 102.

Continuing with this example, if the kitchenware includes heavy pots and pan with caked-on food, the operator may position the heavy pots and pans within the tank 102 of the first kitchenware washing assembly 704. The first kitchenware washing assembly 704 may then operate at a mild presoak turbulence level at a higher (uncomfortable to the touch) heat to loosen the caked-on food from the heavy pots and pans, followed by a more turbulent flow in the tank 102 to break away loosened food debris, followed by a final cycle at reduced temperature during which the operator can finish the cleaning process.

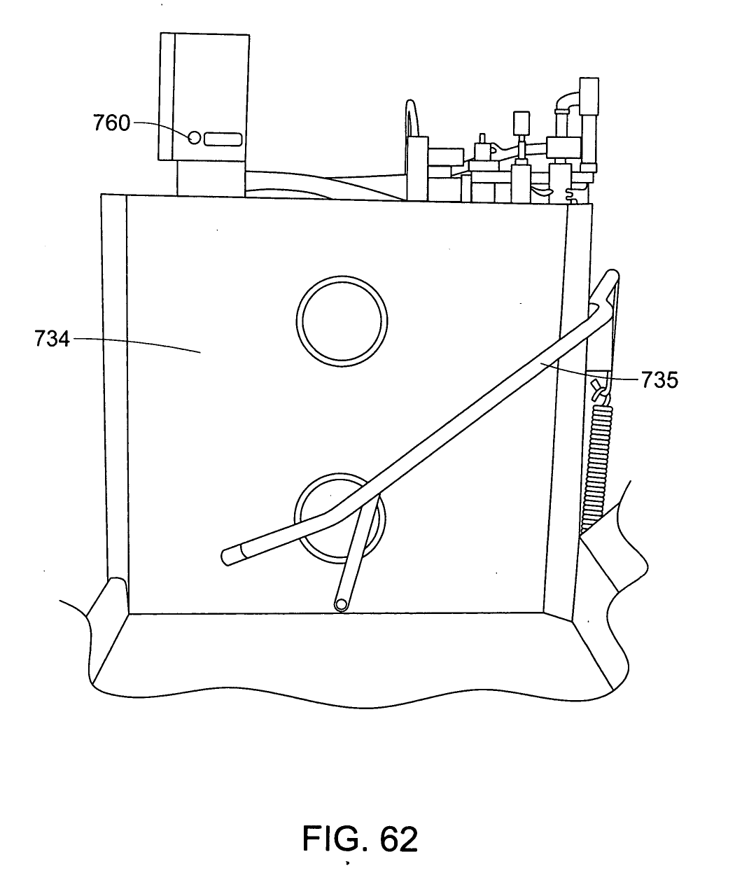

Assuming the kitchenware to be washed includes items such as dishware, glassware, etc., the operator may load the dirty kitchenware into a rack 756 supported generally above the sink 710 at initial scraping/pre-rinse station 708. The operator may then use an overhead sprayer to remove bulk food items or residue stuck to kitchenware. Next, the operator may slide the rack 756 with the kitchenware loaded therein along the rails 752 though the left side opening into the interior of the enclosure of the second kitchenware washing assembly 712, as shown in 57). The operator may then close the sliding doors 735 and activate (e.g., by pressing a “start” button 760 shown in FIG. 62, etc.) the second kitchenware washing assembly 712. During operation, light 764 or 768 (FIG. 56 and may illuminate to indicate to the operator the particular stage (e.g., wash, rinse, etc.) of the washing cycle for the second kitchenware washing assembly 712. In addition, gauges 772 can indicate to the operator the temperature of the fluid being sprayed onto the kitchenware by the sprayers 740 and 744 within the enclosure 732.

Upon completion of the washing cycle (e.g., which may take about sixty seconds, etc.), the operator may open the sliding doors 735 and slide the rack 756 along the rails 752 out of the enclosure 732 through the right side opening, as shown in FIG. 65. With the rack 756 positioned generally above the sinks 718 and 724 (FIG. 56) (and their perforated cover(s)), the operator may allow the kitchenware to air dry and/or unload the kitchenware from the rack 756.

In various embodiments, the first and second kitchenware washing assemblies are separately operable from one another. For example, the first and second kitchenware washing assemblies can each include its own independent control system, water supply system (e.g., conduits, drains, etc.), electrical power supply system (e.g., cords, etc.), pumps, heaters, etc. Accordingly, one of the first and second kitchenware washing assemblies may remain active while the other is idle or inoperable due to servicing, failure or malfunction. This set-up thus provides redundancy that allows for at least some use of the system even when one of the first and second kitchenware washing assemblies is inoperable and/or being serviced.

In various embodiments, the system also includes the “back-up” sinks that can function as sanitizing and rinsing stations in the event one of the first and second kitchenware washing assemblies is inoperable. Accordingly, the first, second, and/or third sinks can be configured to be separately operable from the first and second kitchenware washing assemblies. For example, each sink can include its own independent water supply system (e.g., conduits, drains, etc.) that is separate from the water supply system of the first and second kitchenware washing assemblies.

In various embodiments, the second kitchenware washing assembly includes at least one pump for pumping fluid from the inlet or drain of the enclosure to the sprayer(s) within the enclosure. Fluid conduits can be used for coupling the pump in fluid communication between the inlet or drain and the sprayer(s). Alternatively, however, more than one pump can be used and/or the pump(s) can be connected directly to the inlet or drain without any connecting fluid conduits.

In various embodiments, the pump is positioned relative to the inlet or drain from the enclosure and sprayer(s) in order to optimize (or at least reduce) the length of the conduits. For example, the pump can be positioned under the bottom of the enclosure such that the pump's inlet is generally aligned with the location at which the fluid conduit connects to the inlet or drain from the enclosure. This, in turn, reduces the conduit length needed to connect the pump to the inlet. The shorter conduit lengths can allow the second kitchenware washing assembly to operate more quietly because of less resistance (less wasted power) due to the shorter intake and discharge lengths. In addition, various embodiments allow for smoother less turbulent (and thus quieter) flow in the conduits due to smoother transitions (e.g., fewer sharp corners, fewer turns). Further, the shorter suction conduit reduces the chance of pump cavitation, which, in turn, also allows for quieter operation.

A wide range of materials can be used for the fluid conduits connecting the pump to the sprayer arms and inlet and the same material need not be used for each fluid conduit. Exemplary materials that can be used for the fluid conduits include rubber, plastic, stainless steel, and combinations thereof, among other suitable materials. In one particular embodiment, the fluid conduits are formed from two-inch or three-inch diameter rubber tubing such that the fluid conduits are relatively flexible. While the fluid conduits can have generally circular cross-sections, other suitable cross-sectional shapes can be used for the fluid conduits.

The fluid conduits can be coupled to the inlet and sprayer arms in various ways. In embodiments in which the fluid conduits are formed from relatively rigid pipes, such as stainless steel, the fluid conduits can be welded, bolted (e.g., by flange connection), threaded, bonded, etc. to the enclosure. In one example embodiment, the fluid conduits and the enclosure are formed from a weldable material like stainless steel. In this particular example, the fluid conduits are welded to a wall of the enclosure. In embodiments in which the fluid conduits are formed from generally flexible tubing or hoses, the fluid conduits can be connected to the inlet and sprayer arms by way of connector members or fittings, such as hose barbs or bibs.

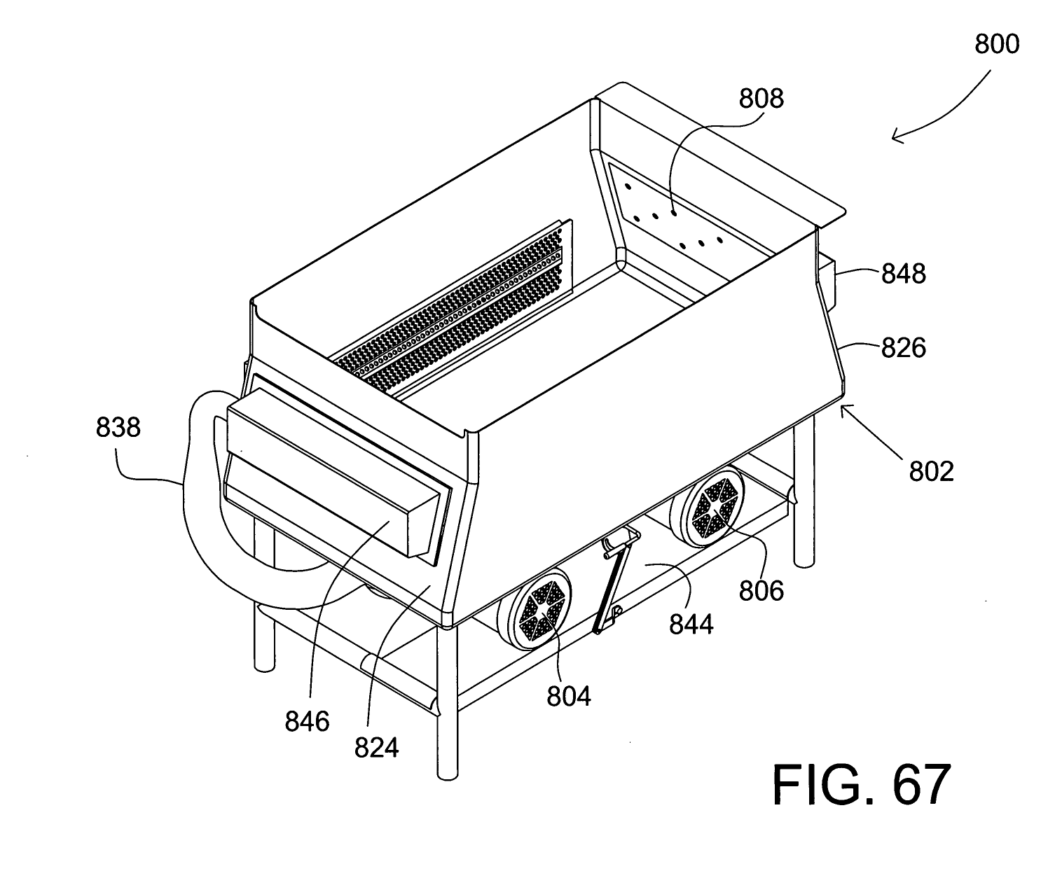

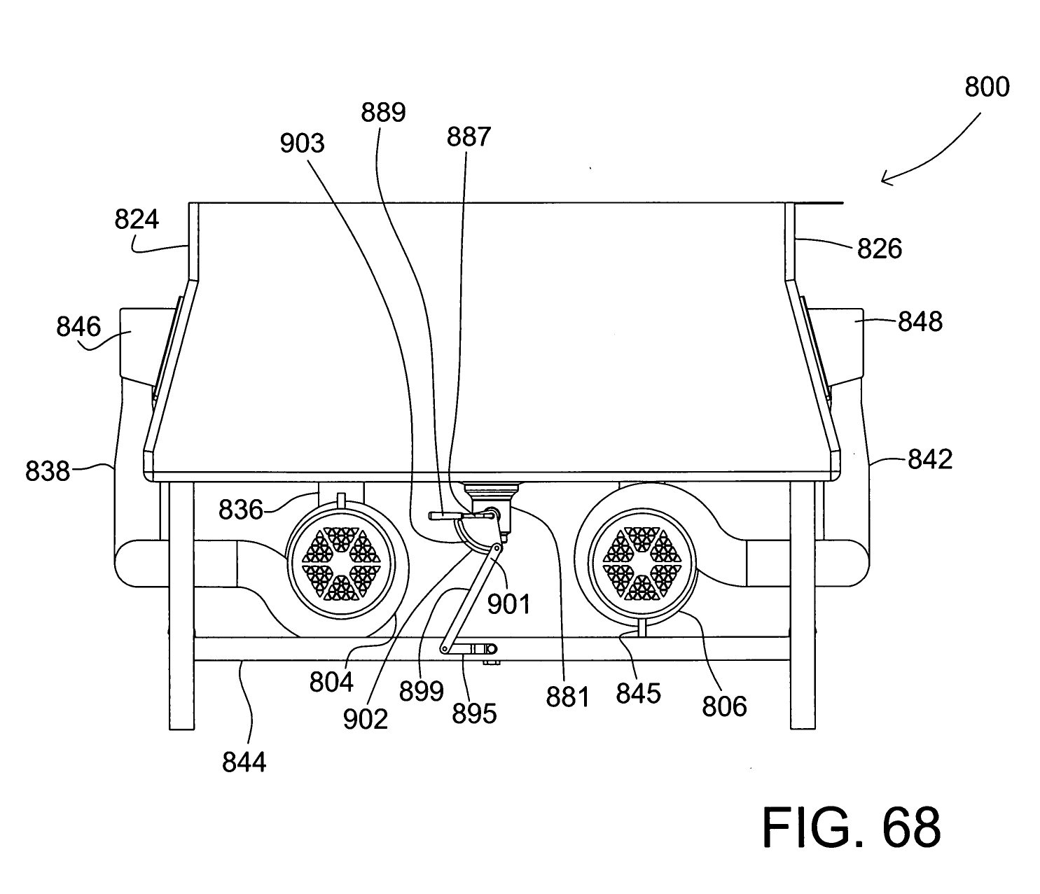

FIGS. 67 through 69 illustrate another exemplary embodiment of a kitchenware washing assembly 800. As shown, the washing assembly 800 includes a tank 802, two pumps 804 and 806 positioned and supported by a shelf 844, an intake chamber 834, and outlet chambers 846 and 848 having outlets or discharge openings 808.

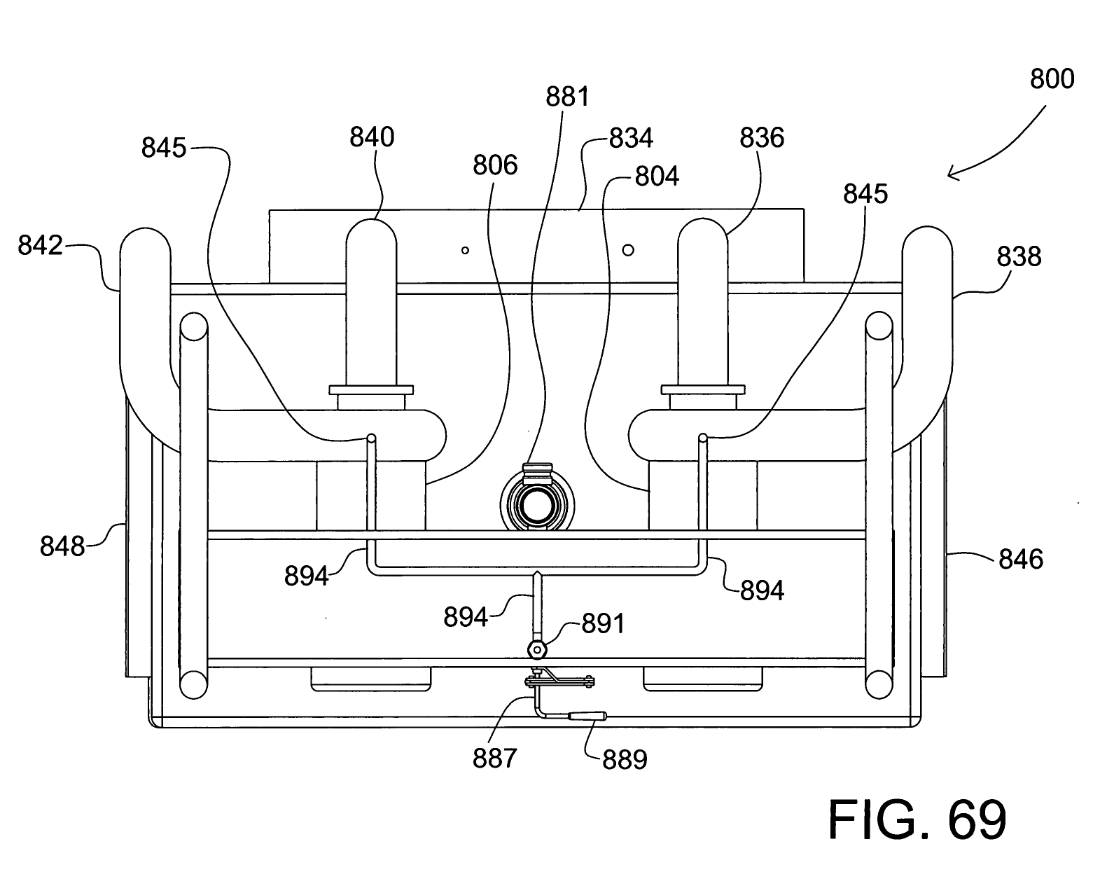

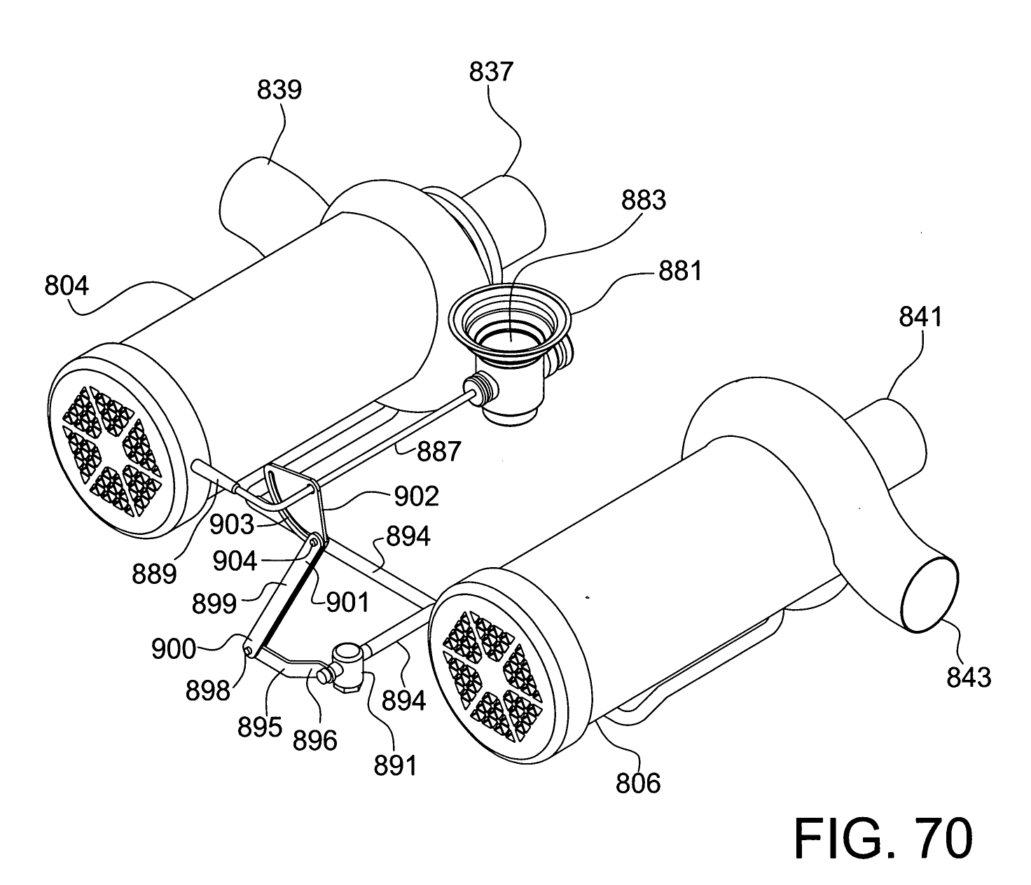

Fluid conduits are used for coupling each pump 804 and 806 in fluid communication between the intake chamber 834 and the outlet chambers 846, 848 on the respective tank sidewalls 824 and 826. As shown in FIGS. 69 and 70, fluid conduit 836 connects the inlet or suction port 837 of pump 804 to the intake chamber 834. Fluid conduit 838 connects the outlet or exhaust port 839 of the pump 804 to the outlet chamber 846. Fluid conduit 840 connects the inlet or suction port 841 of pump 806 to the intake chamber 834. Fluid conduit 842 connects the outlet or exhaust port 843 of pump 806 to the outlet chamber 848. Alternatively, however, either or both pumps 804 and 806 can be connected directly to the intake chamber 834 and/or outlet chamber 846, 848 without any connecting fluid conduits.

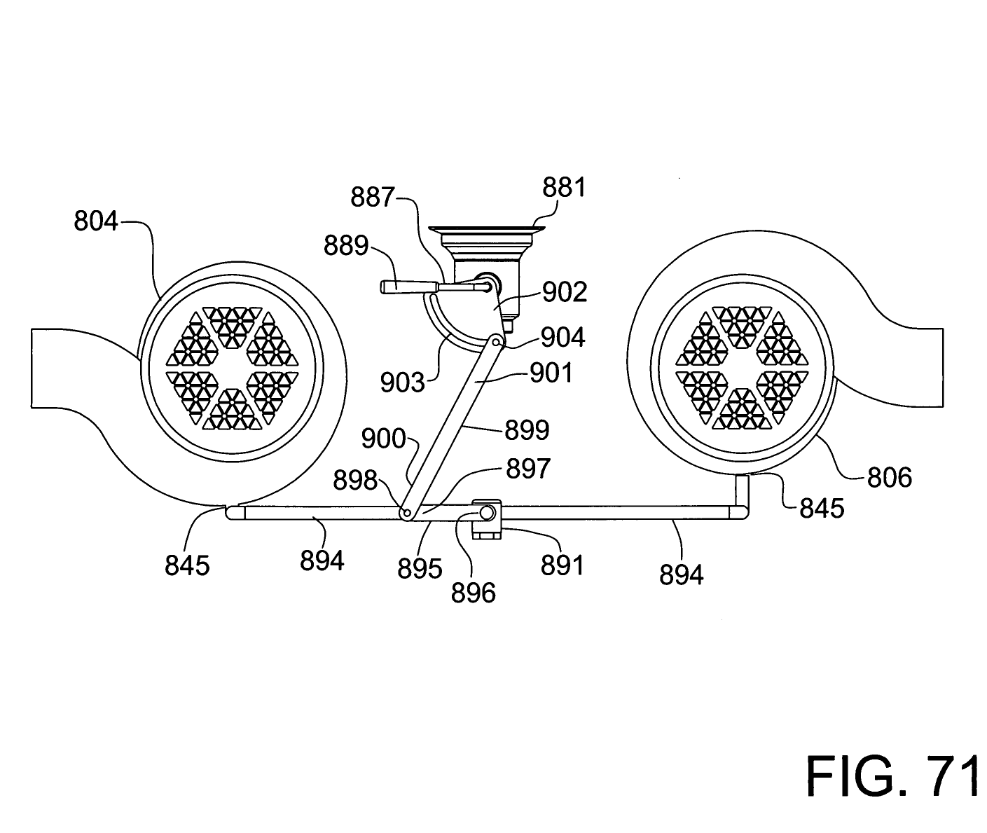

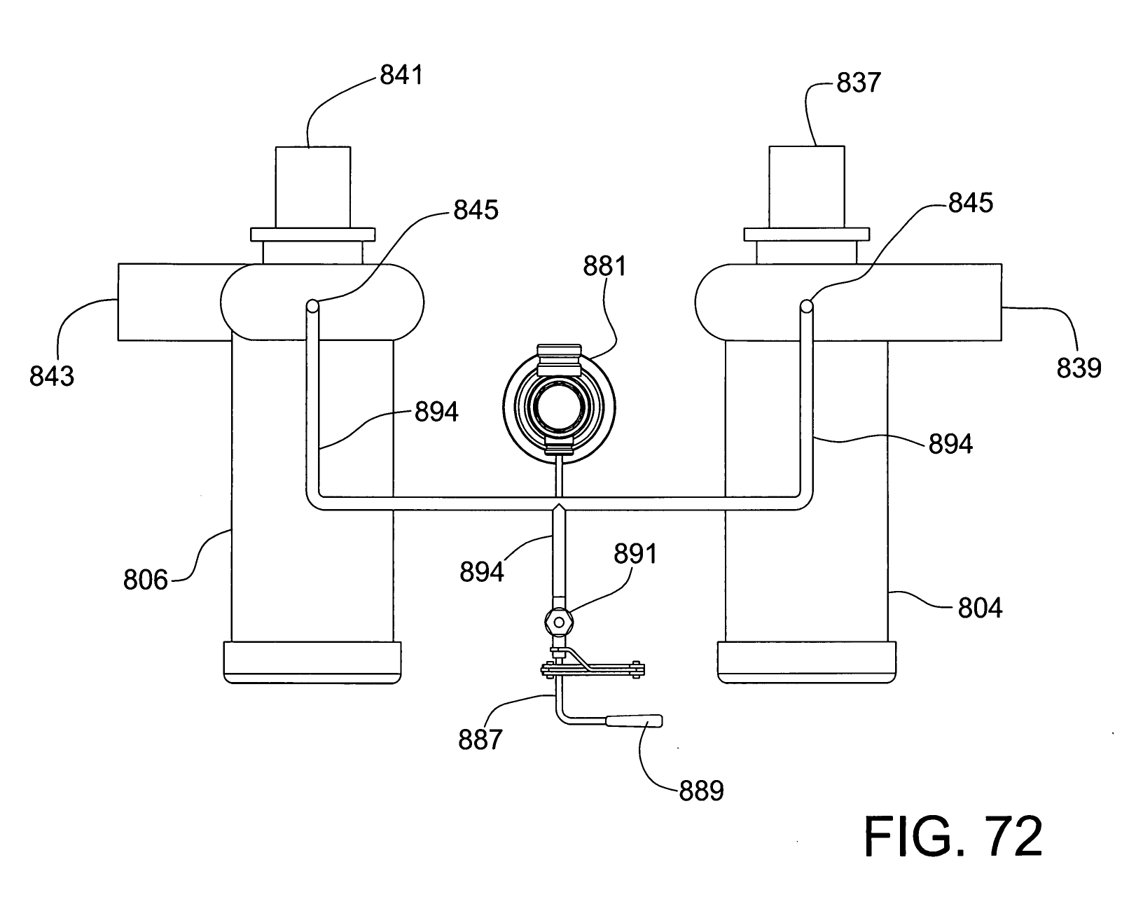

As shown in FIGS. 71 and 72, each pump 804 and 806 includes a drain 845 positioned at or near a low point in each pump. These drains 845 provide the ability to drain a substantial portion of the fluid from each pump 804 and 806 and the interconnecting conduits 836, 838, 840, 842. By way of example, the pump drains 845 can be configured to be controlled manually, automatically, or some combination thereof. Some embodiments are configured such that the pump drains 845 can be manually opened or closed with little effort by the operator, such as by one or more manual valves. Other embodiments are configured such that the pump drains 845 can be automatically opened or closed without any user intervention. In one such embodiment, the drains 845 are automatically opened by activating at least one solenoid coupled to at least one valve. Alternatively, other suitable means can be employed for opening and closing the drains.

In the particular embodiment shown in FIGS. 67 through 72, a single actuator is provided for manually opening and closing the pump drains 845 and the tank drain. More specifically, a valve 881 is connected to the tank drain. The valve 881 includes a stopper or closure member 883 for sealing the tank drain.

An elongate lever or rod 887 is coupled to the valve 881 for causing upward or downward movement of the stopper 883. For example, an operator can rotate the lever 887 in a first direction (e.g., clockwise or counterclockwise) to thereby move the stopper 883 (e.g., upward or downward) out of sealing engagement with the tank drain, thereby opening the tank drain and allowing fluid to drain from the tank 802. Conversely, rotation of the lever 887 in the opposite direction moves the stopper 883 in the opposite direction (e.g., upward or downward) into sealing engagement with the tank drain.

One particular embodiment is configured such that about one hundred eighty degree clockwise rotation of the lever 887 moves the stopper 883 downward for sealing the tank drain. In this particular example, the lever 887 can then be rotated counterclockwise about one hundred eighty degrees to move the stopper 883 upward out of sealing engagement with the tank drain thereby opening the tank drain.

The illustrated embodiment also includes a handle portion 889 at the end of the lever 887. The handle portion 889 can facilitate the operator in rotating the lever 887. Alternatively, other means can be employed for rotating the lever 887 and/or opening and closing the tank drain, including automated means such as solenoid-actuated valves.

With continued reference to FIGS. 70 and 71, the illustrated embodiment is configured such that the rotation of the lever 887 also opens or closes the pump drains 845 depending on the direction of rotation of the lever 887. Advantageously, this allows the operator to relatively easily manually open or close the tank drain and the pump drains 845 by rotating the level 887 in the appropriate direction.

A valve 891 is connected to the pump drains 845 by fluid passages or conduits 894. The valve 891 is coupled to the lever 887 by a linkage. The linkage generally includes a link 895 having an end portion 896 connected to the valve 891. A wide range of means can be employed for connecting the link 895 to the valve 891.

The other end portion 897 of the link 895 is pivotably connected by a pivot 898 to an end portion 900 of the link 899. Various means can be employed for pivotably connecting the links 895 and 899 to one another, such as rivets, pins, etc.

The link 899 further includes a second end portion 901, which is connected to a member 902. The link end portion 901 is slidingly engaged with a slot or opening 903 of the member 902. In this particular embodiment, a screw and nut assembly 904 (attached to the end portion 901 of the link 899) is received within the slot 903 of the member 902. Alternatively, other means (e.g., pins, rivets, bolts, etc.) can be employed for engaging the link 899 to the member 902.

The member 902 is coupled to the lever 887 for common rotation therewith. Accordingly, rotation of the lever 887 causes the member 902 to rotate in the same direction. A wide range of means can be employed for connecting the member 902 to the lever 887, such as welded, bolted (e.g., by flange connection), threaded, bonded, etc. In other embodiments, the member 902 can be unitarily or monolithically formed with the lever 887 such that the member 902 would not be separately attached to the lever 887.

As noted above, the valve 881 and tank drain can be opened or closed by rotation of the lever 887 of about one hundred eighty degrees. In this particular embodiment, however, less lever rotation is needed for opening or closing the valve 891 (and thus the pump drains 845). This is accommodated by providing the slot 903 in the member 902. The slot 903 allows for free travel or sliding of the screw and nut assembly 904 within the slot 903 during at least some of the lever rotation. During this free travel or sliding, the rotation of the lever 887 accordingly does not affect the operation (i.e., opening or closing) of the valve 891. After a certain amount of lever rotation, however, the screw and nut assembly 904 will contact or abut against one of the ends of the slot 903. At which point, continued rotation of the lever 887 will cause movement of the links 899 and 895 for opening or closing the valve 891 depending on the direction of lever rotation.

Alternatively, other means can be employed for opening and closing the pump drains 845, including automated means (e.g., solenoid-actuated valves, etc.). In addition, other embodiments can include separate actuators—one for opening and closing the pump drains, and another for opening and closing the tank drain. Still further embodiments include a separate actuator for opening and closing each pump's drain.

In another embodiment, a kitchenware washing assembly includes a tank for holding fluid for washing kitchenware. The assembly also includes at least one pump for agitating the fluid in the tank. The at least one pump and the tank are connected by at least one fluid passage. The at least one fluid passage is configured with a drain at about a low point of the fluid passage to allow drainage of the fluid from the at least one pump and the fluid passage. For example, FIGS. 69 through 71 illustrate the pumps 804 and 806 having drains 845 at about a low point of the pump scrolls. In other embodiments, one or more drains may additionally, or alternatively, be provided in one or more of the fluid passages or conduits 836, 838, 840, 842 (FIG. 69) connecting the pumps 804 and 806 to the tank 802.

Aspects, principles, and teachings of the present invention can be applied to a wide range of washing systems including existing washer systems for commercial or large-scale kitchens. Accordingly, aspects of the present invention should not be limited to implementation into any specific form/type of washing system.

In addition, aspects of the present invention should also not be limited to washing any particular type of items as various embodiments of the present invention provide washers that are capable of washing a variety of kitchenware, dishware, food service ware and equipment, pots, pans, food trays, grease filters, gratings, tableware, among other items. Indeed, embodiments of the present invention can also be used for meat thawing and for washing produce, fruits, vegetables, seafood, oysters, clamshells, crustaceans, non-kitchen items, non-food items, metal parts, plastic parts, etc. For example, a washing assembly of the present invention can be used for washing large quantities of potatoes that will be served at a restaurant. As another example, a washing assembly of the present invention can be used for washing plastic or metal parts in a manufacturing or industrial application.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present invention and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A kitchenware washing assembly comprising a tank for holding fluid for washing kitchenware, and at least one pump for agitating the fluid in the tank, wherein the at least one pump is configured with at least one drain at about a low point of the at least one pump to allow drainage of the fluid from the at least one pump.

2. The assembly of claim 1, wherein the at least one pump includes at least one outlet coupled in fluid communication with at least one outlet of the assembly for dispensing fluid into the tank.

3. The assembly of claim 1, wherein the at least one pump comprises two pumps.

4. The assembly of claim 3, further comprising at least one valve coupled to the at least one drain of the two pumps such that the at least one valve is operable for opening and closing the at least one drain of the two pumps.

5. The assembly of claim 3, wherein the tank includes at least one drain, and wherein the assembly further comprises an actuator configured for opening and closing both the at least one drain of the tank and the at least one drain of the two pumps.

6. The assembly of claim 1, wherein the tank includes at least one drain, and wherein the assembly further comprises an actuator configured for opening and closing both the at least one drain of the tank and the at least one drain of the pump.

7. The assembly of claim 1, wherein the at least one drain is configured to allow drainage of the fluid from the at least one pump solely via gravity.

8. The assembly of claim 1, wherein the at least one drain is configured to allow drainage of substantially all of the fluid from the at least one pump solely via gravity.

9. A kitchenware washing assembly comprising a tank for holding fluid for washing kitchenware, and at least one pump for agitating the fluid in the tank, wherein the at least one pump is configured with at least one drain to allow at least some fluid to drain from the at least one pump.

10. The assembly of claim 9, wherein the at least one drain is at about at about a low point of the at least one pump to allow drainage of substantially all of the fluid from the at least one pump solely via gravity.

11. The assembly of claim 9, wherein the at least one pump includes at least one outlet coupled in fluid communication with at least one outlet of the assembly for dispensing fluid into the tank.

12. A kitchenware washing assembly comprising a tank for holding fluid for washing kitchenware, and at least one pump for agitating the fluid in the tank, wherein the at least one pump and the tank are connected by at least one fluid passage, and wherein the at least one fluid passage is configured with at least one drain at about a low point of the at least one fluid passage to allow drainage of the fluid from the at least one pump and the at least one fluid passage.

13. In a kitchenware washing assembly having a tank for holding fluid for washing kitchenware, and at least one pump for agitating the fluid within the tank, the improvement comprising at least one drain at about a low point of the at least one pump to thereby allow drainage of the fluid from the at least one pump.

14. In a kitchenware washing assembly having a tank for holding fluid for washing kitchenware, at least one pump for agitating the fluid within the tank, and at least one fluid passage connecting the at least one pump and the tank, the improvement comprising at least one drain at about a low point of the at least one fluid passage to thereby allow drainage of the fluid from the at least one pump and the at least one fluid passage.

15. A method of draining fluid from at least one pump of a kitchenware washing assembly, the kitchenware washing assembly including a tank for holding fluid for washing kitchenware and at least one pump for agitating the fluid within the tank, the method comprising opening at least one drain at about a low of the at least one pump such that the fluid drains from the at least one pump through the open drain.

16. The method of claim 15, further comprising closing the at least one drain.

17. The method of claim 15, wherein opening at least one drain comprises opening at least one valve coupled to the at least one drain.

18. The method of claim 17, wherein opening at least one valve comprises manually opening the at least one valve.

19. The method of claim 17, wherein opening the at least one valve comprises automatically opening the at least one valve without manual intervention.

20. The method of claim 19, wherein automatically opening includes activating at least one solenoid coupled to the at least one valve.

21. The method of claim 15, wherein the tank includes at least one drain, and wherein the method includes substantially simultaneously opening both the at least one drain of the tank and the at least one drain of the at least one pump.

22. The method of claim 15, wherein the tank includes at least one drain, and wherein the method comprises opening the at least one drain of the tank and the at least one drain of the at least one pump with a single actuator.

23. The method of claim 22, further comprising closing the at least one drain of the tank and the at least one drain of the at least one pump with a single reverse actuation of the actuator.

24. The method of claim 15, wherein the at least one pump comprises two pumps, and wherein opening the at least one drain comprises opening at least one valve coupled to the at least one drain of the two pumps.

25. The method of claim 15, wherein the at least one pump comprises two pumps, and wherein opening the at least one drain comprises substantially simultaneously opening the at least one drain of each said pump.

26. The method of claim 15, further comprising:
monitoring washing cycles to detect an indicator that the fluid for washing kitchenware should be replaced;
after detecting the indicator that the fluid for washing kitchenware should be replaced, deactivating the at least one pump; and
opening the at least one drain.

27. The method of claim 15, further comprising:
counting a number of washing cycles since a replacement of the fluid for washing kitchenware;
comparing the counted number of washing cycles to a preset value;
if the counted number of washing cycles is equal to or exceeds the preset value, deactivating the at least one pump; and
opening the at least one drain.

28. The method of claim 27, further comprising allowing an operator to input the preset value.

29. A method of draining fluid from at least one pump of a kitchenware washing assembly, the kitchenware washing assembly including a tank for holding fluid for washing kitchenware, at least one pump for agitating the fluid within the tank, and at least one fluid passage connecting the at least one pump and the tank, the method comprising opening at least one drain at about a low of the at least one fluid passage such that the fluid drains from the at least one pump and the at least one fluid passage through the open drain.

30. A method of assembling a kitchenware washing assembly, the kitchenware washing assembly including a tank for holding fluid for washing kitchenware, at least one outlet for dispensing fluid into the tank, at least one inlet for receiving fluid from the tank, and at least one pump for pumping fluid from the at least one inlet to the at least one outlet, the method comprising positioning the at least one pump such that at least one drain thereof is at about a low point of the at least one pump, to thereby allow drainage of fluid for washing kitchenware from the at least one pump.

31. The method of claim 30, further comprising coupling the at least one drain to at least one valve such that the at least one valve is operable for opening and closing the at least one drain.

32. The method of claim 30, wherein the at least one pump comprises two pumps.

33. The method of claim 32, further comprising coupling the at least one drain of each said pump to the same valve such that the valve is operable for opening and closing the at least one drain of each said pump.

34. The method of claim 30, wherein the tank includes at least one drain, and wherein the method comprises coupling the at least one drain of the tank and the at least one drain of the at least one pump to the same actuator for opening and closing the drains.
